(19) United States
(12) Patent Application Publication
(10) Pub. No.: US 2026/0213932 A1
(43) Pub. Date: Jul. 23, 2026

(54) SEEDLESS RANDOMNESS EXTRACTORS FOR DEVICE-INDEPENDENT QUANTUM CRYPTOGRAPHY

(71) Applicants: Lluis Masanes, London (GB); Quantinuum Ltd, London (GB)

(72) Inventors: Cameron Foreman, Billericay (GB); Lluis Masanes, Cambridge (GB)

(21) Appl. No.: 19/566,870

(22) Filed: Mar. 13, 2026

Related U.S. Application Data
(63) Continuation of application No. PCT/US2024/046499, filed on Sep. 12, 2024.
(60) Provisional application No. 63/582,808, filed on Sep. 14, 2023.
(60) Provisional application No. 63/562,203, filed on Mar. 6, 2024.

(51) Int. Cl. H04L 9/08

(52) U.S. Cl. CPC H04L 9/0852; H04L 9/0869

(57) ABSTRACT

Systems and methods are for seedless generation of random bit strings are disclosed. A System generates a secret key from a raw key received from a quantum source of randomness using a seedless randomness extractor that generates the secret key by applying a deterministic function on the raw key to transform the partially random raw bits into a near uniformly random output random bit string without using a seed random bit string. The system determines a Bell value quantifying violation of a Bell inequality by the raw bits. A distance between the secret key and a uniform random distribution is limited by an upper bound at least partially dependent on the determined Bell value.

### INCORPORATION BY REFERENCE TO ANY PRIORITY APPLICATIONS

This application is a continuation of PCT Patent Application No. PCT/US2024/046499, filed on Sep. 12, 2024, entitled “SEEDLESS EXTRACTORS FOR DEVICE-INDEPENDENT QUANTUM CRYPTOGRAPHY” which claims benefit under 35 U.S.C. § 119(e) of U.S. Provisional Application No. 63/582808, entitled “SEEDLESS RANDOMNESS EXTRACTORS FOR DEVICE-INDEPENDENT QUANTUM CRYPTOGRAPHY”, filed on Sep. 14, 2023, and U.S. Provisional Application No. 63/562,203, entitled “SEEDLESS RANDOMNESS EXTRACTORS FOR DEVICE-INDEPENDENT QUANTUM CRYPTOGRAPHY”, filed on Mar. 6, 2024. Each of the above-referenced applications is hereby incorporated herein by reference in its entirety.

### BACKGROUND

### Field of Invention

The present disclosure relates to systems and methods for device-independent generation of secret keys comprising quantum certified random bit strings. More specifically, seedless randomness extractors for device independent generation of nearly perfect random bit strings.

### Description of the Related Art

Device-independent (DI) quantum cryptography is a highly secure cryptographic protocol that allows for the elimination of computational assumptions on the adversary and minimal trust in, or characterization of, the underlying protocol hardware. DI protocols use randomness extraction or privacy amplification, to produce a secret key by classically-processing an imperfect raw key generated by the outcomes of some devices. To produce the secret key, random extractors use random bits that are sufficiently statistically independent of the quantum hardware. This requirement can be difficult to achieve as it relies on availability of an initial randomness in order to generate more or better randomness.

### SUMMARY

In some aspects, the techniques described herein relate to a system for generating a random bit string, the system including: a non-transitory memory storing machine-readable instructions, and an electronic processor configured to execute the machine-readable instructions to: receive from a single source of randomness an input random bit string; determine a Bell value indicative of a magnitude of violation of a Bell inequality by at least a portion of bits in the input random bit string; and generate an output random bit string using the input random bit string based at least in part on the Bell value; wherein the output random bit string is generated by a deterministic output generation process.

In some aspects, the techniques described herein relate to a system for generating a random bit string, the system including: a non-transitory memory storing machine-readable instructions, and an electronic processor configured to execute the machine-readable instructions to: receive from a single source of randomness an input bit string; determine a Bell value indicative of a magnitude of violation of a Bell inequality by at least a portion of the bits in the input bit string; and generate the random bit string using an output generation process including a deterministic function and the input bit string, based at least in part on the Bell value; wherein an error quantifying difference between the random bit string and a perfect random distribution is limited by an upper bound dependent at least partly on the Bell value.

In some aspects, the techniques described herein relate to a method of generating a random bit string, the method including: By an electronic processor of a computing system: receiving from a single source of randomness an input bit string; determining a Bell value indicative of a magnitude of violation of a Bell inequality by at least a portion of bits in the input bit string; and generating the random bit string using an output generation process including a deterministic function and the input bit string, based at least in part on the Bell value; wherein an error quantifying difference between the random bit string and a perfect random distribution is limited by an upper bound dependent at least partly on the Bell value.

In some aspects, the techniques described herein relate to a system for generating a random bit string, the system including: a non-transitory memory storing machine-readable instructions, and an electronic processor configured to execute the machine-readable instructions to: receive, from a single source of randomness, a bit stream; select a plurality of test bits from the bit stream; determine a Bell value indicative of a magnitude of violation of a Bell inequality by at least a portion of the bit stream the plurality of test bits; and select a plurality of raw bits from the bit stream; generate the random bit string using an output generation process including a deterministic function and the plurality of raw bits, based at least in part on the Bell value.

In some aspects, the techniques described herein relate to a method of extracting a secret key from a raw bit string, the method including: by an electronic processor of a computing system: receiving the raw bit string; receiving a Bell value indicative of a magnitude of violation of a Bell inequality by at least a portion of bits in the raw bit string; and generating the secret key using an output generation process including a deterministic function and the raw bit string, based at least in part on the Bell value; and wherein an error quantifying difference between the secret key and a perfect random distribution is limited by an upper bound dependent at least partly on the Bell value.

### BRIEF DESCRIPTION OF THE DRAWINGS

Embodiments of the disclosure will be described, by way of example, in the disclosure with reference to the following diagrams, wherein:

FIG. 1A shows a depiction of a conventional process of device independent (DI) for generating a secret key based on seeded randomness extraction. Dashed line denotes quantum processes, solid line denotes classical process, and dash-dotted line denotes additional initial classical resources.

FIG. 1B is a schematic diagram of an example system that generates a secret key based on the process shown in FIG. 1A.

FIG. 1C schematically illustrates an example apparatus for generating certified random bit strings using two quantum systems.

FIG. 2A shows a depiction of a seedless process for DI for generating a secret key based on seedless randomness extraction according to some embodiments disclosed herein. Dashed line denotes quantum processes, and solid line denotes classical process.

FIG. 2B schematically illustrates a block diagram of an example system that generates a random bit string based on the process shown in FIG. 2A

FIG. 2C schematically illustrates a block diagram of another example system that generates a random bit string based on the process shown in FIG. 2A

FIGS. 3A-3D show plots depicting example variation of error (3A), extraction efficiency (3B), rate efficiency (3C), as a function of Bell value (BV), and the length of the random bit string as a function of error (3D).

FIG. 4 is a diagram representing an example setup representing a device for generating random bits evaluated using a Bell inequality

FIG. 5A is a flow diagram representing an example process for generating a secret key using a seedless extractor.

FIG. 5B is a flow diagram representing another example process for generating a secret key using a seedless extractor.

FIGS. 6A-6B show plots of estimated value and Independent and identically distributed (I.I.D) value of the error when extracting a single bit using XOR function for different values of an observed Bell inequality violation value, such as Clauser-Horne-Shimony-Holt (CHSH) value, when gamma=0.9 (5A) and when gamma=0.999 (5B).

FIG. 7 is a plot showing the minimum CHSH value for which the extraction length is non-zero plotted against an estimation probability, for an example seedless extractor implemented based on XOR function.

FIGS. 8A-8B are plots showing the maximum efficiency rate (8A) and maximum extraction rate (8B) plotted against for different values of CHSH, for an example m-bit seedless extractor based on a balanced function.

FIG. 9 is a block diagram illustrating an example random number generation system that uses the disclosed seedless randomness protocols to generate a secret key.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

### Introduction

Random bits have applications ranging from cryptography to gambling and scientific computing. However, traditional random number generators are based on classical physics, which is deterministic. Therefore, the output randomness cannot be trusted without further assumptions, since the apparent randomness is based on ignorance that may not be shared by an adversary. Random-seeming numbers generated by any sort of deterministic software are in principle vulnerable to hacking for this reason. Quantum mechanics is intrinsically probabilistic and therefore might be used to generate randomness. Leveraging quantum mechanics to generate a random number might allow for a type of security based on the uncertainty principle; for example, under the right conditions, an adversary might not be able to observe a quantum bit (qubit) without the qubit being immediately destroyed.

When considering a device that purportedly generates random output based on quantum mechanics, one might be able to trust that the output is random only if one trusts or assumes the quantum device or system is operating correctly. Once a random number has been generated by a system there is typically no easy way to certify that the random number has been generated by a quantum system. To determine whether a purportedly quantum system in fact leverages quantum phenomena to produce its output, a human operator typically would not only need to be an expert in the field but also need to visually inspect the internal structure, including mechanical apparatus, of the purportedly quantum system and perhaps even independently test the system.

While there exist commercialized quantum systems that produce purportedly random bits, to verify that such a device is working as intended would be a difficult task even for an expert with access to the device's internal workings. It would be preferable, then, if the device's output could be verified as genuine merely by considering the output, without any knowledge of the inner workings of the device. This property is known as device independence.

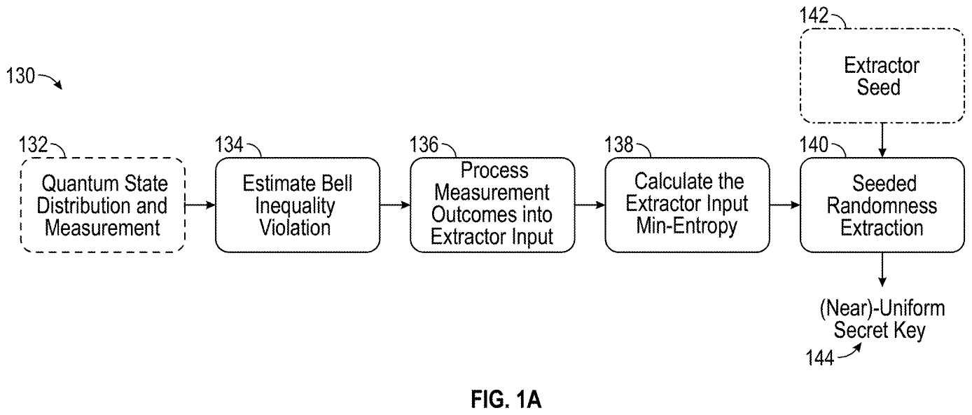

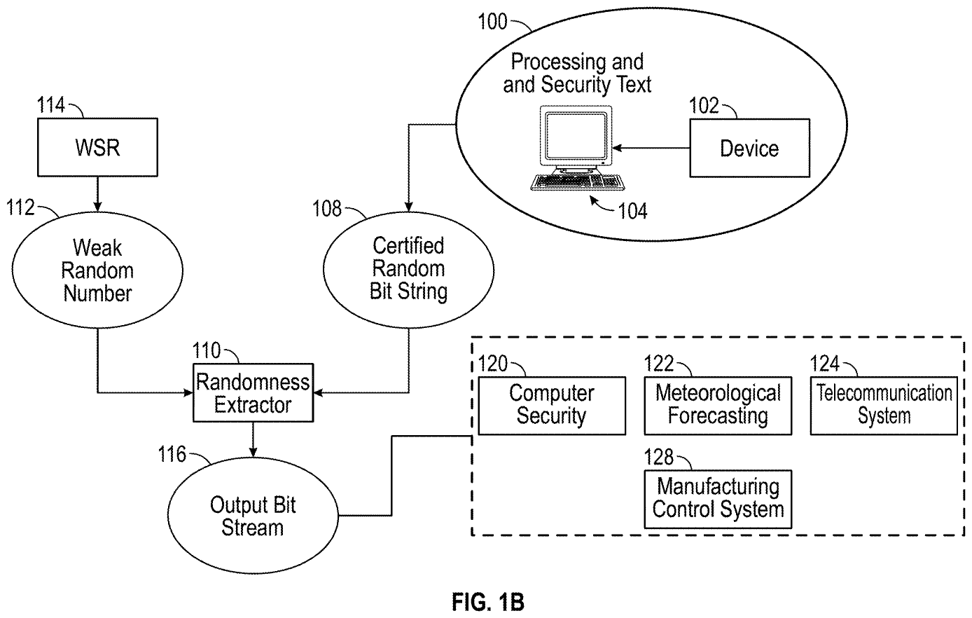

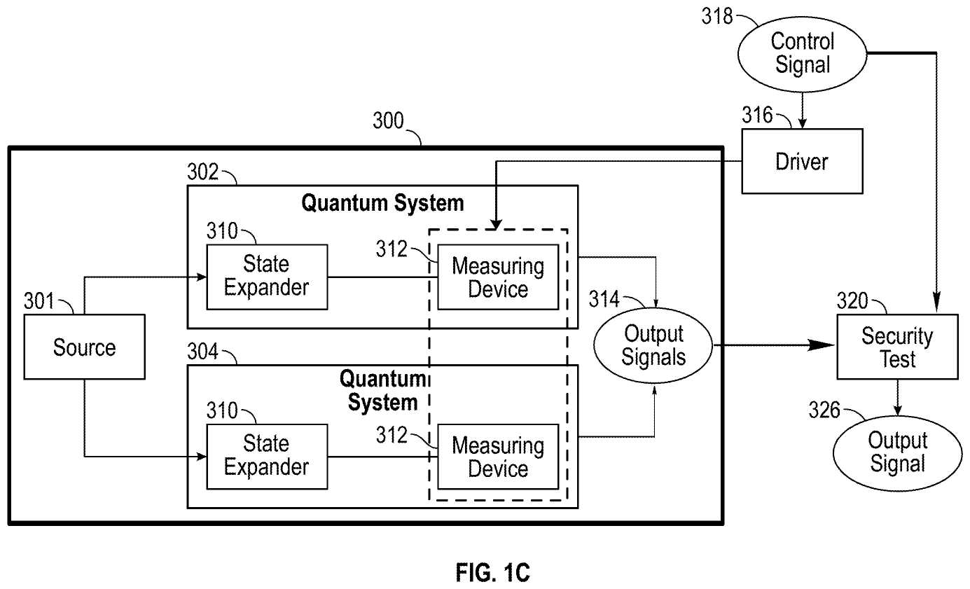

FIG. 1A shows a depiction of a process 130 for device independent (DI) generation of a secret key based on seeded randomness extraction using a seeded randomness extractor. Dashed line denote quantum processes, solid lines denotes classical process, and dash-dotted line denotes additional initial resources. In some embodiments, the process 130 may comprise the following steps:

First Step 132: Distributing and measuring quantum states generated by a quantum apparatus to generate random bits. In some cases, the quantum apparatus may comprise two or more quantum systems configured to prepare and measure quantum states. In some cases, the first step 132 may be performed by a first source of randomness (e.g., a quantum source of randomness).

Second Step 134: Estimate a Bell inequality violation by the random bits generated in the first step based on the measurement settings used to measure the quantum states. A violation of Bell inequality may indicate the quantum nature of the random bit generation process. In some examples, the Bell inequality may comprise Clauser-Horne-Shimony-Holt (CHSH) inequality. In some cases, violation of a Bell inequality by the random bits generated in the first step 132 may result in passing the random bits to the third step 136 independent of amount of violation.

Third Step 136: Process the measurement outcomes to generate an initial random bit string (also referred to as raw random bit string or raw key). In some cases, the initial random bit string may comprise the random bits generated in the first step 134.

Fourth Step 138: Calculate a first min-entropy or first min-entropy rate for the initial random bit string. In some cases, the first min-entropy rate may be used to evaluate of the randomness of the final secret key 144.

Fifth Step 140: receive the initial random bit string and a seed random bit string (also referred to as extractor seed) 142 and use the seed random bit string 142 to extract an output random bit string or secret key 144 from the initial random bit, where secret key 144 can have a second min-entropy or second min-entropy rate equal to or larger than those of the initial random bit string. In some embodiments, the seed random bit string 142 may be received from a second source of randomness different from the first source of the randomness used in the first Step 132. In some embodiments, the seed random bit string 142 may have a min-entropy rate of 1, or close to 1. In some embodiments, the seed random bit string 142 may comprise a publicly accessible random bit string.

In various implementations, the seeded randomness extraction 140 may comprise using probabilistic functions to extract the secret key 144 from the initial random bit string. As such seedless randomness extraction can be a probabilistic process. In some embodiments, determination of the first min-entropy or first min-entropy rate for the initial random bit string provided to a seeded randomness extractor that performs the seeded randomness extraction 140, may be used during the extraction process. In some embodiments, seeded randomness extraction 140 may comprise multiple processing steps (e.g., performed sequentially) where at least one of the processing steps includes usage of a probabilistic function and at least one or the processing steps uses the extractor seed 142 provided by randomness generator different form the first source of randomness that generates the random bits provided to the second step 134.

In some examples, the second min-entropy rate can be closer to 1 compared to the first min-entropy rate. In some examples, the secret key 144 (output random bit string) may comprise a uniform or a near-uniform distribution. In some embodiments, the secret key 144 may be generated by a seeded randomness extractor using a seeded randomness protocol. In some embodiments, the seeded randomness protocol may generate the secret key 144 using a probabilistic function.

In some embodiments, the first min-entropy calculated for the initial random bit string may be used to reject the initial random bit string (e.g., when the min-entropy is less than a threshold value) or accept the initial random bit string and pass it to the seeded randomness extractor to be used, along with the extractor seed 142, to generate the secret key 144. In some embodiments, the first min-entropy calculated for the initial random bit string may be provided to the seeded extractor, along with the initial random bit string, to the seeded extractor, and the seeded extractor may generate the secret key 144, based at least in part on use the min-entropy.

In some cases, the Bell-inequality violation estimated at second step 134 may be used to bound the min-entropy and to certify the security of the output random bit string 144.

In some embodiments, the extractor seed 142 used by the seeded randomness extraction process 130 may have at least some randomness or a non-zero min-entropy and may be statistically completely or partially independent of the initial random bit string.

In some embodiments, the seeded randomness extraction processes described above with respect to FIG. 1A, a violation of Bell inequality may be used for generating the initial random bits, and the min-entropy determined for the random bits that have violated the Bell inequality may be used for seeded randomness extraction and quantifying the randomness of the secret key 144.

FIG. 1B is a schematic diagram of an example system for generating a output random bit string 116 (e.g., a certified secret key) using the process 130 described above with respect to FIG. 1A. In some cases, the system may comprise an apparatus 100 that generates a certified random bit string 108. In some cases, the apparatus 100 may comprise a device 102 that generates measurement signals (e.g., random bits) associated with random events and a computing device (e.g., a classical computer) 104 that receives the measurement signal, determines a Bell inequality based on the signals and measurement information (e.g., measurement bases) received from the device 102, an in response to violation of the Bell inequality, outputs a certified random bit string 108. In some cases, the computing system 104 may determine a min-entropy or min-entropy rate for the certified random bit string 108. The system further includes a seeded randomness extractor 110 that received the certified random bit string 108 and a weak random number 112 (e.g., a weal random bit string) from a weak source of randomness (WSR) 114 and generates an output random bit string 116 (e.g., a secret key). Additionally, in some cases, the seeded randomness extractor 110 may receive the determined min-entropy or min-entropy rate for the certified random bit string 108, from the apparatus 100. The output random bit string 116 may be used in a variety of downstream applications 120, 122, 124, 128 that rely on the secrecy and certification of the secret key for their secure operation. In some embodiments, WSR 114, can be a classical apparatus (e.g., a classical computing system) for computing a pseudo-random bit string. In some embodiments, the apparatus 100 may include another weak source of randomness (not shown) used for the measurement and certification step.

In some embodiments, a weak source of randomness (WSR) refers to a source of randomness where the randomness is not certifiable as the result of, or being based on the presence of, quantum effects. The term “weak” does not itself connote that the source of randomness is somehow unsuitable or insufficient to meet industry standards of randomness. In some implementations, a weak source of randomness can be at least partly nondeterministic or even completely nondeterministic. Weak sources of randomness thus include sources that output noncertifiable nondeterministic random numbers. Weak sources of randomness are sometimes referred to simply as sources of randomness.

FIG. 1C schematically illustrates an embodiment of apparatus 100 comprising a quantum apparatus 300 as device 102 of FIG. 1B. In some embodiments, quantum apparatus 300 may comprise two quantum systems 302, 304 where the individual ones of the two quantum systems 302, 304 may comprise a state expander 310 and a measuring device 312. A source 301 of quantum states may generate certain physical entities (e.g., an electromagnetic field such optical or radio frequency field, a particle, an oscillation mode, and the like) having certain quantum states and provides them to each of the state expanders 310. its. In some cases, the state expanders 310 prepares or transforms the quantum states into a specified quantum state as the physical entity travels through the state expanders 310. The measuring devices 312 each may contain one or more detectors configured to generate signals (e.g., electric signals) upon receiving the qubits transmitted by the state expanders 310. In some cases, a measurement setting (e.g., a measurement basis for a quantum measurement) of the measuring devices 312 may be configured by a control signal 318 via a driver 316. In some examples, the driver 316 may control the configuration or the measurement setting of the detectors in the measuring devices 312 based on the control signal 318 to change measurement bases used for measuring the qubits. In some cases, the fields or particles may travel from the state expanders 310 into the measuring devices 312 via a plurality of possible paths. In some cases, the travel time can be approximately the same for all paths. In some cases, measurements can be taken at different detectors at substantially the same time. The device 102 may generate output signals 314 (e.g., random bits) based on the measurements of the detectors. In some cases, the device 102 may generate output signals 314 based on the coincidence measurements indicating the detection of two particles or two field quanta by two detectors substantially at the same time. In some cases, the output signals 314 can be in the form of random bit strings with one bit per detector and where the bit is 1 to represent a detection event and 0 to represent no detection event. The output signals 314 may be provided to computing system 104 which carries out a security test 320. In some cases, to perform the security test, the computing system 104 may receive the control signal 318 and perform the security test 320 based at least in part on the control signal. Security test 320 may comprise determining whether the output signals 314 violate a Bell inequality. In some cases, a random bit string passed the security test 320 when it violates a Bell inequality. In some cases, the random bits that passe the security test 320 are output as output signal 326. In some cases, the output signal 326 generated by the computing system 104 may comprise the output signal 314. In some cases, if security test 320 is passed then a second security test may be optionally carried out, e.g., by the computing system 104, to check whether the quantum systems 302, 304 are non-signaling (do not influence one another). In some cases, the second security test may be passed when the individual quantum systems 302, 304 are non-signaling or approximately non-signaling. In some implementations, the second security test may comprise making repeated measurements with the measuring devices 312 and determining whether the measurement results are correlated between the quantum systems 302, 304.

In various implementations, device-independent (DI) quantum cryptography may provide information-theoretic security with minimal trust in, or characterization of, the underlying hardware (e.g., device 102 in apparatus 100). This is achieved by exploiting the capacity of quantum mechanics for violating Bell inequalities. Some of the applications of DI quantum cryptography include secret key distribution, randomness expansion and randomness amplification. Some of the embodiments disclosed here can be relevant to many of these applications but may have more impact on randomness amplification. In some cases, DI may allow for secure cryptography in extremely paranoid settings.

A challenge for the existing DI protocols is associated with various initial resources used to generate the output random bit string 144, which can be difficult to justify in such settings. As described above a step in a DI protocol is that of randomness extraction or privacy amplification, which produces an output random bit string having a near perfect randomness (e.g., a perfect secret key) by classically-processing an initial random bit string having an imperfect randomness (e.g., a raw key generated by the outcomes of the devices at the first step 132). In existing systems and methods, this step consumes additional random bits (seed random bits or strings) that are sufficiently statistically independent of the quantum hardware (e.g., device 102 or apparatus 300 therein). For example, the randomness extraction (or privacy amplification) performed at step five 140 of the process 130 uses a seed random bit string of additional random bits that have non-vanishing min-entropy and are sufficiently statistically independent of any bits generated during the process 130. As shown in FIG. 1B the seed random bit string may be generated by a device (e.g., WSR 114) separate from the device 102. In some cases, the randomness and related statistical properties (e.g., min-entropy or min-entropy rate) of the seed random bit string 142 may directly affect the randomness, generation rate, and/or the length of the output bit string 144. As such despite its high security guarantees, DI quantum cryptography faces some practical challenges with respect to additional random bits (e.g., seed 142) generated from classical processing systems that are independent of the quantum hardware. In particular, given the difficulty of certifying the security or privacy of the classical systems, in practice it can be very hard to justify the dependence of the properties of the output bit string 144 on the seed random bit string 142 provided by a classical system. In some cases, using a seeded extraction process may lead to a circularity in randomness sourcing and generation, whereby a user needs access to randomness in order to generate more randomness. In some examples, such initial classically generated randomness may be used for both the estimation of Bell violation and for the seed in the randomness extraction process (also known as privacy amplification).

Some of the proposed methods and systems described below may comprise computationally efficient protocols for randomness extraction without using a seed random bit string or seed random number, while being secure against computationally unbounded quantum adversaries. In some cases, a level or amount of violation of a Bell inequality, herein referred to as Bell value (BV) by raw data (raw random bits) provided to the randomness extraction protocols described below may be used as the randomness extractor promise and for determining properties of the output random bit string (in contrast to the existing process 130 where min-entropy is used as the randomness extractor promise). In some cases, a level or amount of violation of a Bell inequality by data (random bits) generated by a source that generates the raw data provided to a randomness extraction protocol described below, may be used as the randomness extractor promise and for determining properties of the output random bit string (e.g., a secret key). For example, in various implementations of the seedless extraction protocols described below, an error quantifying a difference between the output random bit string (e.g., a secret key) extracted or generated by the seedless randomness extractor and a perfect random distribution (e.g., an ideal key) can be limited by an upper bound dependent on the Bell value.

Some of the proposed methods and systems described below may use a seedless randomness extractor configured to extract a secret key from a raw key without using a seed random string and without receiving a random bit string from a device different from the device that generates the raw key.

Random Bit String Generation with Seedless Extractor

The embodiments described below are not limited to implementations which solve any or all of the disadvantages of known technology for amplifying, generating or certifying randomness. For example, different embodiments may address different disadvantages or challenges relating to amplifying, generating, or certifying randomness.

The disclosed systems and methods provide examples for seedless randomness extraction processes that can be implemented based on realistically and efficiently implementable classical processing systems using deterministic functions to extract random numbers from a partially random bit string (e.g., a raw key) using a deterministic process. In some implementations, the raw key (input random bits) may be generated using a quantum apparatus (e.g., comprising one or more quantum systems) and evaluated by determining a Bell value quantifying violation of a Bell inequality by the raw key or other random bits generated by the quantum apparatus during generation of the raw key. In some implementations, the seedless randomness extraction processes may be a single-sourced process, in the sense that additional random bits generated independently from the quantum apparatus may not be used in the extraction process. For example, the seedless randomness extractor may not use additional random bits, random bit strings, or random numbers generated by a source (e.g., classical source), different from the source that generates the raw key, to generate the secret key using the raw key.

In some embodiments, seedless randomness extraction may comprise a process for transforming a partially random bit string (the raw key) provided as extractor input into a nearly uniform and secret random bit string generated as extractor output (the final key or secret key). In some embodiments, nearly uniform random bit string generated by the seedless extractor may be characterized by an extractor error (E). In some cases, the secret random bit string generated by a seedless extractor may have a smooth min-entropy rate 1, with smoothing parameter (E). In some examples, a mathematical model used for extracting the nearly uniform random bit string may consider that an adversary is computationally unbounded but constrained by the laws of quantum mechanics. In some examples, an adversary may have a classical processor or a quantum processor with unlimited computational power and processing time. In various implementations, the secret key (random bits) generated and/or extracted using the seedless randomness extraction protocols, methods, and systems below can be secure against an adversary having unbounded computational power. In some cases, the adversary can be a quantum adversary. In some cases, the adversary can be a quantum adversary can be a classical adversary.

In some embodiments, the disclosed methods can transform a raw random bit string having a lower level of randomness (possibly correlated with the hardware and the adversary) into a secret random bit string having nearly prefect or potentially perfect private randomness, e.g., or a random number that is uniformly distributed conditioned on any information an adversary might have. In some cases, the secret random bit string can be closer to uniformly distributed key (or perfectly random bit string) compared to the raw random bit string by an amount that depend on a Bell value measured for the quantum apparatus or device that generates the raw key.

The proposed methods, use the full power of Bell violation without passing it through the min-entropy bottleneck. The inventors have discovered that Bell violation may imply a certain level of independence between measurement rounds used to generate the raw key (initial random bit string), e.g., due to entanglement monogamy. In some embodiments, the disclosed seedless extraction protocols may provide security against both quantum and classical adversaries.

In some embodiments, the proposed protocols and algorithms may allow for seedless randomness extraction using two quantum systems. These algorithms may use efficiently computable seedless extractor functions and explicit seedless extractors having low computational cost. In some cases, some of these extractor functions (e.g., linear extractor functions) can be identified based on a link between linear error-correcting codes and seedless randomness extraction/privacy amplification. In some cases, the disclosed randomness extraction methods may allow estimating an error of a random bit string generated by the disclosed seedless extraction processes in a practical scenario, e.g., based on an estimated Bell value associated with an underlying hardware.

In the following detailed description, various non-limiting examples of a randomness amplifying process and various embodiments of real-world systems that implement examples of the process are described. These examples and embodiments are intended to illustrate, but not to limit, the scope of the disclosure.

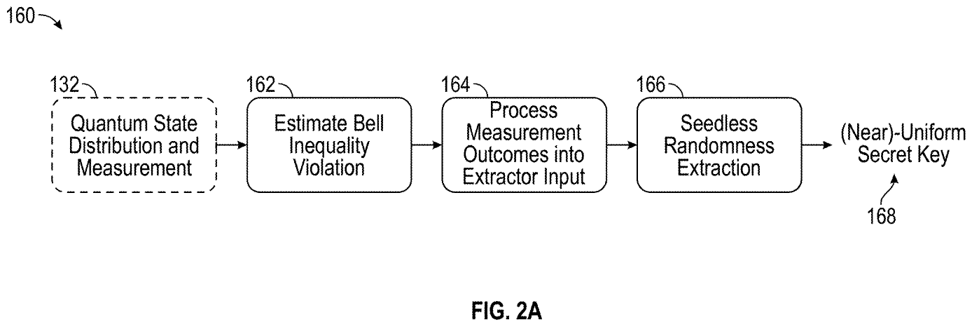

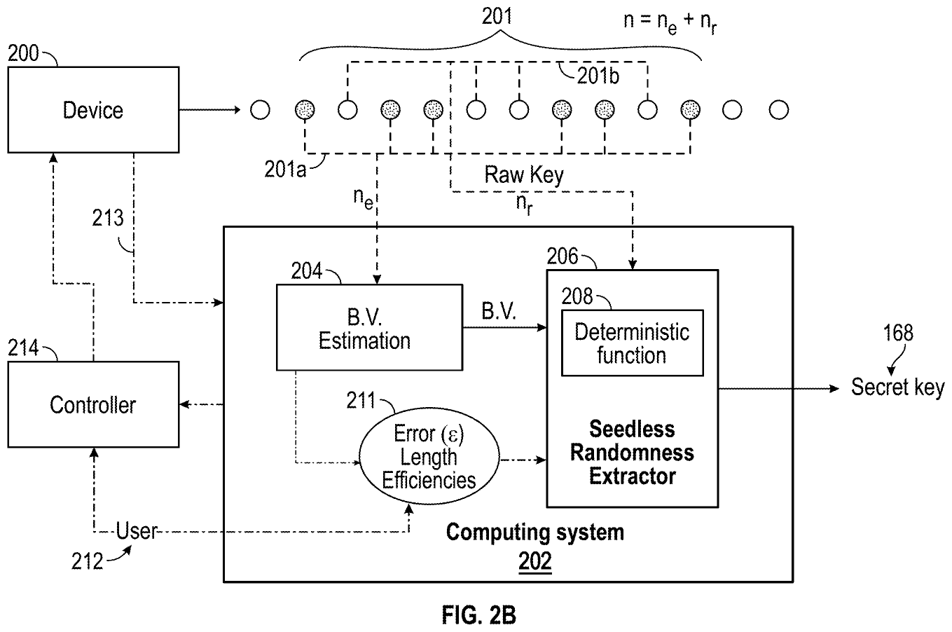

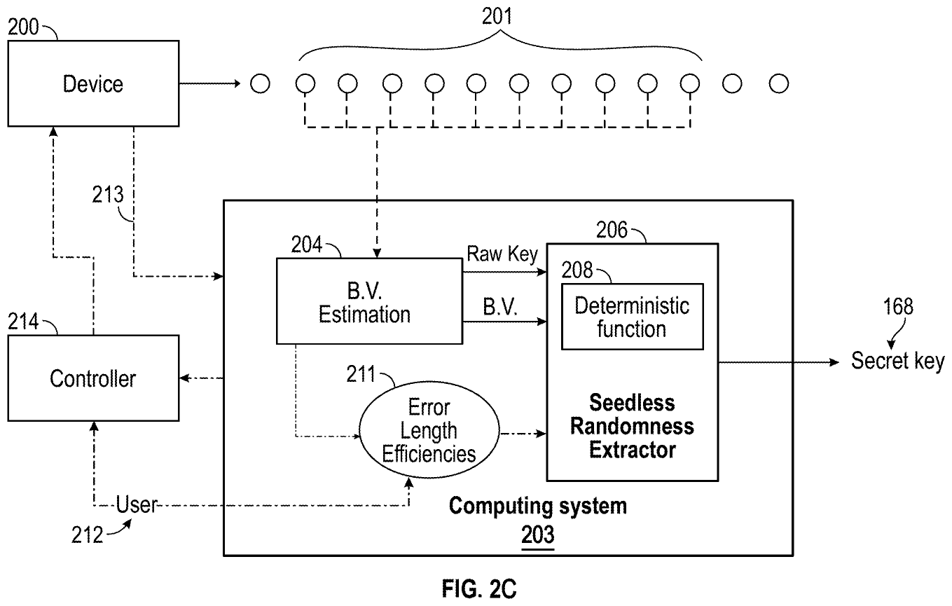

FIG. 2A shows a depiction of a seedless process 160 for DI for generating a secret key based on seedless randomness extraction according to some embodiments disclosed herein. Dashed line denotes quantum processes, and solid line classical process. In some embodiments, the process 160 may comprise the following steps:

First Step 132: Distributing and measuring quantum states generated by a quantum apparatus (e.g., quantum apparatus 300) to generate random bits.

Second Step 162: Process at least a portion of the measurement outcomes to estimate a Bell inequality violation and determine a Bell value quantifying the Bell inequality violation or indicative of an amount or level of Bell inequality violation. In some cases, the Bell inequality may comprise Clauser-Horne-Shimony-Holt (CHSH) inequality. In some cases, Bell inequality violation and the Bell value may be determined based on shifted operator associated with Clauser-Horne-Shimony-Holt (CHSH) inequality. In some cases, the Bell value may be compared to a threshold value and in response to determining that the Bell value is larger than the threshold value the measurement outcomes may be passed to the third step 164.

Third Step 164: Process at least a portion of the measurement outcomes to generate an initial random bit string also referred to as raw random bit string or raw key.

Fourth step 166: use the raw key and the Bell value to generate an output random bit string, also referred to as secret key 168, using a seedless randomness extractor, where the secret key 168 has a randomness closer to a perfectly random (uniformly distributed) bit string compared to the raw key. In some cases, the seedless randomness extractor may use a deterministic function to generate the secret key 168. In some examples, the secret key 168 may be generated by applying the deterministic function on the raw key. In some cases, the Bell value (BV) determined at the second step 162 may be used to select the deterministic function, determine a length of the secret key 168, or determine an error of the secret key 168 indicative of difference between the secret key 168 and a perfectly random bit string (also referred to as an ideal secret key). In some implementations, the length of the secret key can be longer than a threshold length (e.g., provided by a user). In some implementations the secret key 168 may have an error smaller than a threshold error (e.g., provided by a user).

In some embodiments, the fourth Step 166 may comprise a deterministic process. In some embodiments, the fourth Step 166 may comprise a single processing step comprising applying a deterministic function on the raw key. In some embodiments, an error quantifying difference between the secret key 168 generated by the process 160 wherein and a perfect random distribution may be limited by an upper bound dependent at least partly on the Bell value.

In some embodiments, the cryptographic protocol disclosed herein may be universally composable, or the criteria satisfied by the secret key 168 is a universally composable security criteria. In some cases, the secret key 168 generated using the seedless extractor can be indistinguishable from an ideal secret key, or indistinguishable from an ideal secret key from the perspective of a malicious eavesdropper, the eavesdropper may be statistically independent from or non-signaling or uncorrelated with the quantum or classical system used in the seedless extraction protocol. In some cases, the eavesdropper may have unlimited quantum or classical computational resources, such as computation power or time. In some cases, a cryptographic task that requires an ideal, uniformly distributed, or perfectly random secret key as a resource may also be secure when fed with the real secret key generated using the seedless extractor.

As described above, some of the approaches disclosed herein comprise designing extractors which exploit the promise of Bell violation, which may eliminate the need for randomization sourced from a seed and may enable generation of the secret key deterministically from the raw key. In some cases, full power of Bell inequality (e.g., Clauser-Horne-Shimony-Holt inequality) violations alone may be used to identify a class of distributions that can be both deterministically extracted from and generated by a realizable experimental process. In some cases, the seedless random extraction may apply to raw key with a non-zero, a small, a partial, a significant, or a maximum violation of the Bell inequality.

The Inventors have discovered seedless extractor functions (including some explicit seedless extractors) with low computational cost. In some cases, the seedless randomness extractor based on these seedless extractor functions may be implemented within a reasonable time using commercially available classical computers. In some cases, the computational complexity of the extraction process performed by a seedless extractor, in terms of its dependence on the input raw key length nᵣ, may scale slower or proportional to O(nᵣ), O(nᵣ×log nᵣ).

As described above a family of such efficiently computable seedless extractor functions may be found using a mathematical link between linear error-correcting codes and seedless randomness extraction/privacy amplification. In some case, error of the seedless extraction processes of random bit strings with any degree of violation of a Bell-inequality, e.g., associated with the underlying hardware, may be estimated and used to show the validity of seedless extraction for a given set of constraints (e.g., user defined constraints). In some cases, the measurement processes generating the different bits of the extractor input can be independent of each other (though they could be arbitrarily correlated); for example, in in some implementations, the measurement devices may have no memory, where each protocol round is executed on a separate non-communicating system. In some cases, the measurement processes generating the different bits of the extractor input may be at least partially correlated.

In some embodiments, the seedless random extractor process (e.g., the first step 132) may comprise a two-party DI setup considered and may use a universally composable security criteria. In some embodiments, a seedless extractor may be implemented using explicit efficiently implementable constructions, for example, the method may be implemented on real hardware today.

In some cases, randomness extraction in DI quantum cryptography can be achieved using a deterministic algorithm (compared to a seeded probabilistic algorithm that receives additional statistical variability using the randomness from a seed), while preserving security against computationally unbounded quantum or classical adversaries. In some cases, a seedless random extractor, when receiving an input including bit string as the raw key, may uniquely, repeatably, or deterministically generate an output bit sting with amplified randomness. In some cases, at step 166, the seedless extractor may derive or generate the secret key 168 by selecting from a family of classical deterministic functions, e.g., based at least in part on properties of the raw key, the bell value, or one or more output criteria (for example, length of the secret key 168). In some cases, an output criterion may comprise a property of the secret key 168 or a characteristic of the secret key generation process (e.g., a characteristic of the randomness extraction step 166). In some cases, an output criterion may comprise a length of the secret key 168, and error quantifying a difference between the randomness of the secret key 168 and a perfectly random distribution (e.g., an ideal key) an efficiency associated with the generation of the secret key 168. In some examples, the efficiency may comprise an efficiency rate quantifying a usage of a source of randomness used at the first step 132 for generating the secret key 168.

The mechanism of the mathematical framework behind the various embodiments disclosed may be understood by understanding that the violation of Bell inequalities of the input bit sting not only guarantees a lowered bound on the overall min-entropy of the output, but also certain statistical independence among the raw key, which, in some cases, may be derived from outcomes of multiple rounds of quantum measurements. In some cases, self-testing may be performed to show that maximal violation of the Bell inequality (e.g., CHSH inequality) implies a measured bipartite state is essentially pure, indicating no correlation between rounds of quantum measurements.

In some implementations, the disclosed seedless randomness extraction or privacy amplification methods can be performed using deterministic (i.e. non-random) functions, and with low computational cost that may be on the order of nᵣ or nᵣ×log(nᵣ) based on the repetition and primitive narrow-sense BCH error correcting codes (where nᵣ is the number of bits in the raw key from which the secret key 168 is derived). In some cases, in addition to computational efficiency, the proposed methods may be secure against computationally unbounded quantum adversaries, whilst completely eliminating the requirement for a seed random bit string for performing randomness extraction. In other words, the performance of a seedless extractor and the characteristics of the resulting random bit strings (secret keys) may be better or similar to those of the seeded extractors without using a seed random number. In some cases, the efficiency rate (i.e., length of the secret key divided by the uses of the quantum systems) can be lower than that of some seeded schemes. However, the efficiency rate can be improved by increasing the number of input bits.

As mentioned above, the inventors have discovered that violation of a Bell inequality and the corresponding Bell value may indicate certain statistical independence between the outcomes of different rounds of the measurements performed to generate the raw key. For example, when the Clauser-Horne-Shimony-Holt (CHSH) inequality is maximally violated, the measured quantum state is expected to be pure, which implies a lack of correlation between measurement rounds. Some of the methods described below may take advantage of the statistical independence between the outcomes of different rounds to provide a new paradigm for DI quantum cryptography. In some cases, at the first step 132 of process 160, two quantum devices or systems may be repeatedly used to generate Bell-violating outcomes. Some of the methods and corresponding theorems described below may assume that two quantum systems have no internal memory. However, the results may also apply to quantum systems that have memory and thereby some implementations of the disclosed methods may produce secret keys and security proofs not requiring the memoryless assumption. In some cases, in a step before the extraction step 166 (e.g., first and/or second steps 132, 162) the process 160, may use random numbers to choose the measurement settings in a measurement round. However, such random numbers are not used in the fourth step 166 (they are not provided to the seedless randomness extractor) and thereby they may not contribute to the randomness of the secret key. In some cases, the randomness of the raw key used for seedless randomness extraction may satisfy weaker statistical conditions compared to a raw key used for seeded randomness extraction. In other words, the initial randomness required for a Bell test must satisfy weaker statistical conditions than that for both a Bell test and seeded extraction.

In some cases, the secret key generated by a seedless randomness extractor may be universally composable, uniformly distributed, perfectly random, nearly-uniformly distributed, near-perfectly random, or indistinguishable from an ideal secret key by a tolerance or error E. In some examples, the error of a secret key generated by the seedless randomness protocol may be smaller than or equal to an upper bound dependent on the Bell value calculated for the secret key. In some cases, the error of the secret key may be defined based on a first quantum state from which the raw key is generated and a second quantum state from which an ideal secret key may be extracted (e.g., the error can be equal or proportional to a trace norm of the difference between the first and second quantum states).

FIG. 2B schematically illustrates an example random number generation system implemented based on a seedless random extractor and using a process that may comprise one or more features described above with respect to process 160. In some embodiments, a device 200 may be configured to generate a plurality of random bits 201 and provide the plurality of random bits 201 to a computing system 202 for generating a secret key 168.

The computing system 202 may be configured to receive the plurality of the random bits 201 from device 200 and generate the secret key 168 by processing the plurality of the random bits 201 using the seedless randomness extractor 206. In some cases, the computing system 202 may receive inputs from a user 212 or another computing device. In some such cases, these inputs may include a threshold value limiting a characteristic of the secret key 168 or a process performed by the randomness extractor 206. In some examples, the secret key 168 can be closer to a perfectly random distribution than the input bit string. In some embodiments, the process used to generate the secret key 168 or the secret key 168 can be secure against an adversary having unbounded computational power. In some embodiments, the adversary can be a quantum adversary or a classical adversary.

In some cases, computing system 202 may control the device 200 using a controller 214. In some cases, computing system 202 may receive data associated with a measurement setting from device 200.

In some cases, device 200 may comprise one or more features described above with respect to the device 102 and/or the quantum apparatus 300; for example, device 200 may comprise two or more quantum systems and two or more measurement devices each receiving and measuring the quantum states prepared by the quantum systems at a given measurement base. In some cases, the measurement base of a measurement device or another setting of the device 200 may be provided to the device 200 by the computing system 220 or the user 212 via the controller 214.

In some embodiments, computing system 202 may use a controller 214 to control a parameter of device 200. In some such embodiments, computing system 202 may control a parameter of the device 200 based on a previous Bell value determined before a current Bell value. In some examples, the parameter may comprise a measurement basis used by device 200 (e.g., by a quantum system of device 200).

In various implementations, the device 200 and the quantum system therein may comprise a system that can prepare and measure quantum states (e.g., entangled quantum states) in a set of measurement bases and generate outputs that may be tested against a Bell inequality. In some cases, the quantum systems of device 200 may comprise any quantum mechanical setup that can be represented by the mathematical framework described below. For example, device 200 may comprise a photonic system, a set of trapped ions, or the like. In some cases, the device quantum systems of device 200 may comprise a set of predetermined observables and measurement devices configured to measure the predetermined observables using a set of measurement bases. For example, the device 200 may comprise a photonic system including two optical systems that are configured to generate photons having a quantum state, and two photodetectors that are configured to measure photons received from different ones of the two optical systems along two orthogonal polarization axes (two different measurement bases). In some embodiments, the measurement bases (e.g., the polarization axis along which photons are detected) may be selected and/or controlled by the computing system 202 or by a user 212 via the controller 214.

In some cases, the computing system 202 may receive a source configuration signal 213 indicative of a parameter or setting of the 200. In some embodiments, a source configuration signal 213 may indicate a measurement basis used by the device 200 to generate a bit received by the computing system 202. For example, a source configuration signal 213 may indicate measurement bases used by the quantum systems of the device 200 to generate bits received by the computing system 202.

In some embodiments, the computing system 202 may select a first portion of the plurality of random bits 201, herein referred to as a plurality of test bits 201a, for Bell value estimation 204 and select a second portion of the plurality of random bits 201, herein referred to as a plurality of initial bits 201b, as initial random bits or a raw key for generating the secret key 168 by the seedless extractor 206. In some cases, the plurality of random bits 201 may include n bits, the plurality of test bits 201a may include nₑ bits and the plurality of initial bits 201b may include nᵣ bits, where n=nₑ+nᵣ bits. In some implementations the randomness extractor 206 may use a deterministic function 208 and the plurality of initial bits 201b to generate the secret key 168 based at least in part on the Bell value (BV) determined using the plurality of test bits 201a. In some embodiments, the deterministic function may comprise: an XOR function, a linear function, or a generator of an error-correction code. In some examples, the error-correction code can be linear. In some examples, the error-correction code can be linear. In some examples, the error-correction code may comprise the Bose-Chaudhuri-Hocquenghem (BCH) code, the repetition code, or other error correction codes.

In some implementations, computing system 202 may select a test bit and/or an initial bit 201b based at least in part on a source configuration signal 213 received from device 200. In some implementations, computing system 202 may provide a control signal to the device 200 to set a measurement basis and select a test bit and/or an initial bit 201b based at least in part on a control signal received from device 200.

In some embodiments, the measurement basis for the test bits 201a and the initial bits 201b can be randomly selected. In some examples, one or more blocks of bits having fixed lengths may be generated based on a fixed measurement basis for a given block and the fixed measurement basis may randomly change for different blocks of bits. In some examples, one or more blocks of bits having different lengths (e.g., randomly selected lengths) may be generated based on a fixed measurement basis for a given block and the fixed measurement basis may randomly change for different blocks of bits.

In some embodiments, during a calibration period the device 200 may can be characterized to identify measurement bases for different quantum systems of the device 200 and the identified measurement bases may be used as fixed measurement bases for generation of test bits 201a and initial bits 201b.

In some examples, the seedless randomness extractor 206 may further generate the secret key 168 based on one or more secret key parameters 211 that combined with BV constrain the generation of the secret key 168 using the plurality of initial bits 201b. In some examples, the one or more secret key parameter 211 may comprise a length of the secret key 168 (e.g., number of bits in the secret key 168), an extraction efficiency (Rₑₓₜ) of the secret key 168, a generation rate (R_{eff}) efficiency of the secret key 168, or an error (ε) indicative of a level of randomness of the secret key 168 (e.g., its randomness with respect to a perfectly random key or an ideal key). In some embodiments, a secret key parameter can be a threshold or target value provided by a user or stored in a memory of the computing device to be used as a limiting parameter to constrain the generation of secret key 168. For example, the plurality of selected initial random bits 201 may be accepted or rejected based at least in part on a limiting parameter. As another example, the number of bits nᵣ in the plurality of initial random bits may be determined based at least in part on a limiting parameter. In some embodiments, a secret key parameter 211 can be an output criterion stored in a memory of the computing system 202 and/or provided by a user via a user interface of the computing system 202.

In some cases, generation rate efficiency (R_{eff}) of the secret key 168, may be defined by Equation (121) below and may quantify a ratio between the length or the secret key 168 and the total number (n) of plurality of the random bits 201 used to generate the secret key 168 (that can be proportional to a number of rounds the device 200 is used to generate the secret key). In other words, generation rate efficiency (R_{eff}) may quantify efficiency of secret random bit string generation with respect to the usage of the device 200 (or quantum measurement resources).

In some cases, extraction efficiency (Rₑₓₜ) of the secret key 168, may be defined by Equation (122) below and may quantify a ratio between the length or the secret key 168 and the number of bits (nᵣ) in the of plurality of the initial random bits 201b used by the seedless extractor 206 to generate the secret key 168). In other words, extraction efficiency (Rₑₓₜ) may quantify efficiency of the seedless extractor 206.

In some embodiments, the computing system may determine a secret key parameter 211 for random bit string extracted the seedless extractor 206, based at least in part on the BV. In some such embodiments, the computing system 202 may compare the determined secret key parameter with a threshold value and accept or reject the random bit string as secret key to be output by the computing system 220. In some embodiments, in response to rejecting a random bit string extracted by the seedless extractor, the computing system 202 may adjust a parameter of the device 200, a number of test bits, o a number of initial bits used for extracting the next random bit string.

In various embodiments, the deterministic function may include a function, e.g., identified or selected based on an error-correction code (e.g., a linear error-correction code). For example, the deterministic function may comprise the generator of an error-correction code. For example, the deterministic function may comprise the generator function of the repetition code or the generator function of the Bose-Chaudhuri-Hocquenghem. In some embodiments, the deterministic function may include an XOR function. In some embodiments, the deterministic function may include a balanced function having properties described below.

In some embodiments, the computing system 202 may select the deterministic function 208 from a plurality of deterministic functions stored in a memory of the computing system 202. In some examples, computing system 202 may select the deterministic function 208 based at least in part on calculated BV, and/or a secret key parameter stored in the memory of the computing system 202. In some cases, the computing system 202 may select the deterministic function 208 for generating secret key 168 based at least in part on a previous BV value and/or a secret key parameter determined for previously generated secret key (e.g., the last secret key generated). In some examples, user 212 may select the deterministic function for a secret key generation period. However, the embodiments are not so limited an in various implementations of a seedless randomness extractor, the computing system 202 may select the deterministic function based on other factors

As described above, the error of a secret key generated by the seedless randomness extractor 206 may be determined based on quantum states in the device 200 from which the plurality of random bits 201 are generated an ideal quantum state from which an ideal secret key may be extracted. An example of such error may be represented by the left-hand side of the inequality in (15) below. In some cases, the secret key 168 may be considered nearly perfect, nearly uniformly distributed, or nearly random if the error determined for the secret key 168 is small or if its distinguishability from an ideal random state is small. In some cases, the secret key 168 may have a min-entropy rate, a min-entropy, or a smooth min-entropy closer to value associated with a uniformly distributed key (perfectly random key). In some cases, the secret key 168 may have a min-entropy rate of 1. In some cases, the error associated with a secret key 168 can be smaller than 2⁻³², smaller than 2⁻¹²⁸, or smaller than 2⁻²⁵⁶.

In some cases, a smoothing parameter of the smooth min-entropy may be estimated or bounded using the error. In some cases, the error c may be predetermined, automatically selected by the extractor, or provided by the user. A bound on the error c may be estimated using the various inequalities provided (e.g., inequality 85 below). In some cases, there may be a relationship between the error, the length of the secret key, and BV. In some cases, the relation may be characterized by the various inequalities described below.

FIG. 2C schematically illustrates another example random number generation system implemented based on a seedless random extractor and using a process that may comprise one or more features described above with respect to process 160. In some embodiments, the random number generation system shown in FIG. 2C may comprise one or more features described above with respect to the random number generation system shown in FIG. 2B.

In some embodiments, the random number generation system shown in FIG. 2C may include a computing system 203 configured to receive a plurality of random bits 201 generated by the device 200 and calculate a Bell value (BV) indicative of a magnitude of violation of a Bell inequality (e.g., CHSH inequality) for the plurality of random bits 201. In some examples, the computing system 203 may calculate the Bell value using configuration signals 213 received from the device 200 indicative of the measurement bases used for generating the plurality of random bits 201. In some embodiments, upon determining that the calculated BV satisfies a threshold condition (e.g., it is large than a threshold value), the computing system may provide the corresponding BV and the plurality of random bits 201 (as a raw key) to the seedless randomness extractor 206 that generates the secret key 168 using the plurality of random bits 201 and based on the BV. As such, in the embodiment shown in FIG. 2C, the process of generating the secret key may not involve selection of estimation and generation rounds (or selecting test bits and initial bits). In other words, all bits received from the device 200 are used both for BV evaluation and secret key generation.

In some embodiments, computing system 202, 203 may comprise a memory storing machine-readable instructions, and a processor configured to execute the machine-readable instructions to implement a seedless randomness extractor 206. In some cases, the seedless randomness extractor 206 may comprise one or more features described above with respect to the seedless extraction randomness step 166 and the seedless randomness protocols, functions, and methods described below. In some embodiments, the processor may be further configured to execute the machine-readable instructions to determine a Bell value for a plurality of bit strings received by computing system 202, estimate an error for the secret key 168, determine length of the secret key 168, or determine an efficiency for generation and/or extraction of secret key 168.

Advantageously, in contrast to the seeded randomness extraction protocols that may be used in the seeded randomness extraction step 140 of the process 130, the disclosed seedless randomness extraction protocols implemented in the fourth Step 166 of the process 160 and the seedless randomness extractor 206, may allow extraction of the secret key 168 from a raw key using a deterministic process. In some embodiments, the deterministic process may comprise using a deterministic function. In some such embodiments, the seedless randomness extractor 206 can extract the secret key 168 from the raw key (e.g., a random bit sting received from the device 200) using a single step of applying the deterministic function on the raw key without using a seed random number. Unlike the seedless randomness extractor 206, a seeded extractor may use probabilistic functions and in some cases, a multi-step process that includes receiving and using a seed random number. In various embodiments, the seeded randomness extraction process may use the Bell value for the raw key (or a Bell value associated with the generation of the raw key) to generate the secret key 168 having a desired level of randomness without estimating a min-entropy or min-entropy rate for the raw key.

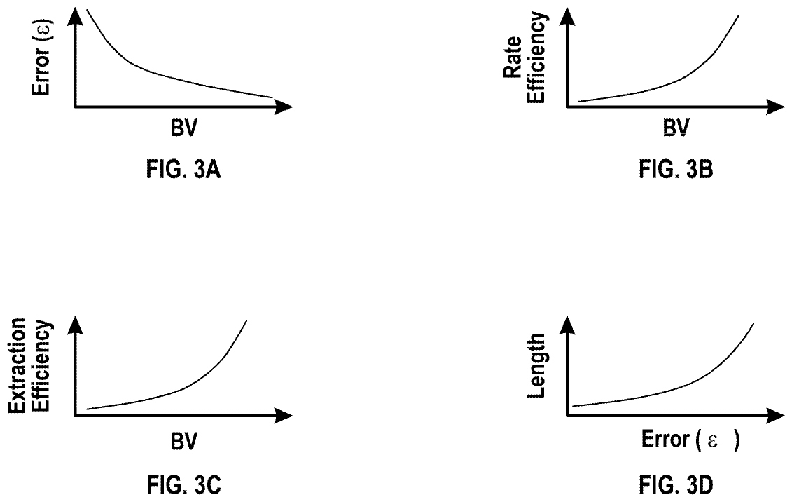

FIGS. 3A-3D show plots depicting example variation of error (3A), extraction efficiency (3B), rate efficiency (3C), as a function of Bell value (BV), and the length of the random bit string as a function of error (3D). As shown in FIG. 3A, error of a secret key may decrease as BV associated with the secret key increases. In other words, a larger BV determined from the plurality of test bits 201a may result in a smaller error for the secret key derived based on the plurality of initial bits 201b used to extract the secret key. As shown in FIGS. 3B-3C, extraction and rate efficiencies of a secret key may increase as BV associated with the secret key increases. As shown in FIG. 3D, length of a secret key may increase as an acceptable error (e.g., threshold error, εₜₕ) increases.

In some cases, Bell value estimation 204 may comprise determining expectation value of a product of shifted Bell-inequality operators. In some cases, the product may be taken over a plurality of rounds, or over the length of the input raw key. In some cases, the Bell-inequality violation or Bell value may be estimated using quantum measurements corresponding to or result in the generation of the raw key. In some cases, the Bell-inequality violation or Bell value may be estimated using rounds of quantum measurement statistically independent or partially correlated to the generation of the raw key but may nevertheless from the same quantum device or system that generate the raw key. In some cases, the Bell-inequality violation or Bell value may be a property of the underlying quantum hardware and may be time-varying depending on the external, internal, or user defined variation of the quantum hardware.

In some embodiments, the device 200 may comprise a two-party DI setup that allows a cryptographic protocol to be performed on uncharacterized, and untrusted devices, potentially even provided by an adversary. In some cases, the hardware used in device 200 may be considered a black box and the security of the measurement outcomes (the plurality of random bits 201) may be determined based on input and output statistics, where inputs may comprise measurement setting provided to the device 200. In some examples, the input and output statistics may be determined based on a Bell inequality (e.g., CHSH inequality), where violation of the Bell inequality indicate experimental hardware has produced non-local correlations and thus, the outcomes are exploited by quantum (or more precisely non-classical). As a result, violation of Bell inequality by a first portion of the bits generated by the device 200 (and the corresponding measurement settings) may be used as a certification of security of the first portion of the bits. In some cases, the violation of Bell inequality by a first portion of the bits may also indicate the security of a second portion of the bits (different from the first portion). In some cases, the first and second portions of the bits may be interleave din time domain.

In some embodiments, the device 200 and the measurement preformed therein may be viewed as a game (a non-local game), whereby a measurement or an interaction with a quantum system of the device 200 (also referred to user queries, where user preforms the measurements), comprises inputs to the device 200 and outputs received from the device 200, and outcome of the measurement (e.g., whether the game is won or lost) are determined based on the input-output combinations. An example criterion for evaluating the outcomes of the measurements is CHSH inequality that is a Bell inequality.

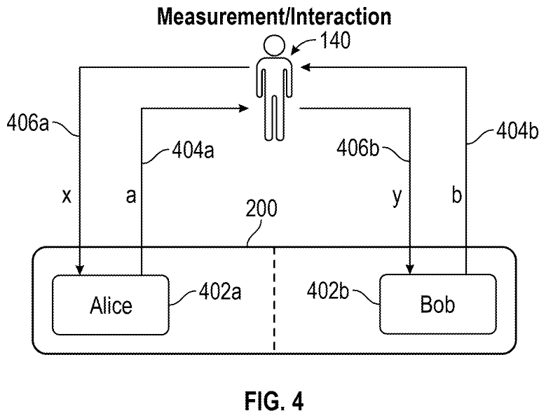

FIG. 4 is a diagram representing an example setup representing a device 200 for generating random bits evaluated using a Bell inequality such as Clauser-Horne-Shimony-Holt (CHSH) inequality. In this case, device 200 may include two devices 402a, 402b, each comprising a quantum system and a measurement system), that are labeled as Alice and Bob. The first device 402a may receive a first input 406a (x) and generate a first output 404a (a) based at least in part on the first input 406a. The second device 402b may receive a second input 406b (y) and generate a second output 404b (b) based at least in part on the second input 406b, where the inputs x, y∈{0, 1} and output a, b∈{0, 1}. Then, the testing or evaluation process may determine whether the outcomes (input-output combinations) violate the CHSH inequality given by:

$$s = {\sum }_{a , b , x , y} {( - 1 )}^{a + b + xy} P ( a , b \vert x , y ) \leq 2. \qquad ( 1 )$$

In some embodiments: testing may be carried out within a secure laboratory from which information can be prevented from leaking, the two quantum systems (each within a different one of the two devices), may not communicate with each other once the testing begins, the input information (e.g., measurement setting) can be provided to each device without being overheard and without transferring information between devices, the devices and adversary may operate according to and limited by quantum theory, and/or a source of private random numbers and a trusted device for classical information processing may be used to perform the measurements.

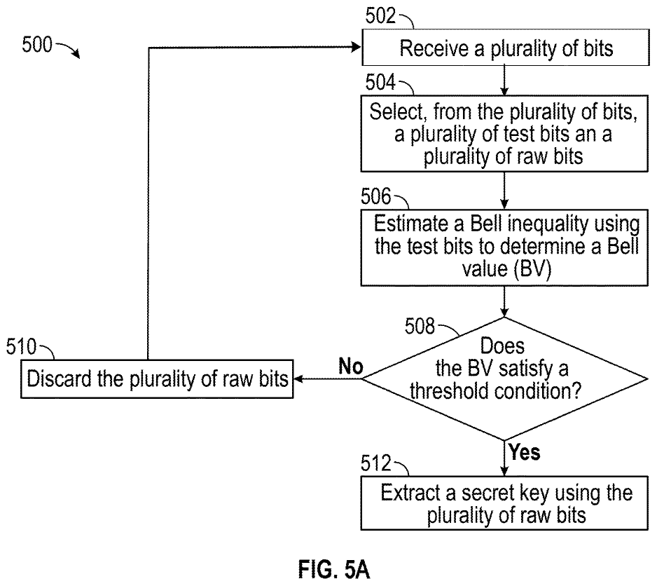

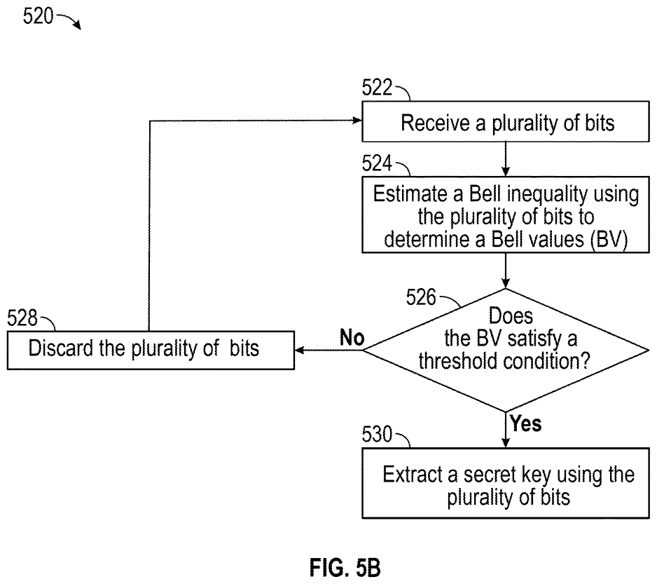

FIG. 5A is a flow diagram illustrating an example process 500 performed by a processor of computing system 200.

The process 500 begins at block 502 where through interactions with the first and second devices 402a, 402b of the device 200, a series of measurements are performed to generate the plurality of random bits 201.

at block 502, a plurality of test bits and a plurality of raw bits (initial bits) may be selected. In various implementations, the test bits and a plurality of raw bits may be selected randomly, based on source configuration signal 213, or based on control signals provided to the device 200.

In some cases, selecting the plurality of test bits and the plurality of raw bits (initial bits) may comprise selecting testing or estimation rounds. In some cases, an interaction may be selected to be a testing (or estimation round) or a raw key generation round (also referred to as generation, or spot-checking round). In some cases, selecting the testing or generation round may comprise a random selection based on an output received from a biased random number generator. In some cases, in the generation rounds, the inputs may be set to the fixed values x=0 for the first device 402a and y=0 for the second device 402b. In some cases, in the testing rounds, the inputs (e.g., the measurement bases) may be generated at random from the alphabets x, y∈{0, 1}. In some cases, a complete set of measurements may be performed during a measurement period, where the complete set of measurements comprises the inputs and outputs of nᵣ generation rounds and nₑ testing rounds.

In some cases, the estimation and the generation rounds may be intermingled or intercalated among each other at regular or irregular time intervals, such that the real-time or instantaneous properties of the one or more quantum systems associated with the generation rounds may be more accurately reflected by the estimation rounds and vice versa. In some cases, an estimation round may be recycled to be used as a generation round, or vice versa, to improve efficiency. In some cases, an estimation and a generation round may be the same round.

In some cases, the probability or proportion of estimation round among all rounds may be from 2% to 5%, from 5% to 10%, from 10% to 50%, from 50% to 70%, from 70% to 90%, or from 90% to 95%, or any other ranges formed by these values. In some cases, the generation rounds may be associated with measuring predetermined observables in at least one of the devices 402a, 402b. In some cases, the predetermined observable may be the same or different in devices 402a, 402b. In some cases, the predetermined observable may also be provided by the user, provided in real-time, or be determined using a random source. In some cases, the predetermined observable may be a quantum observable or may be associated with a quantum number. In some cases, the predetermined observable may be measured using optics and may be related to the polarization or chirality of an EM wave, a light wave, or one or more photons. In some cases, the predetermined observable may coincide or differ between one or more quantum systems.

A set of observable values may be predetermined or provided to the quantum systems in order to determine if the round is to be an estimation round or a generation round. For example, in some cases, a round may be considered as a generation round if the corresponding measurements basis (e.g., indicated by the source configuration signal 213) matches with specified basis selected for the generation round and round may considered as an estimation (or testing round) otherwise. For example, when optical devices are used, a round may be a generation round if the polarizations of one or more optical quantum systems of a quantum apparatus (e.g., the quantum apparatus within the device 200 in FIG. 2B) are measured along a first polarization axis and may be an estimation (or testing) round if the polarizations are not all measured along the first axis. In some cases, the raw key may be generated from the measurement result performed along the first polarization axis from the one or more quantum systems, or only one of the quantum systems, depending on direction of the polarization axis.

In some cases, a length of the input raw key, an error tolerance, or a computational efficiency may be predetermined or provided to the system including the seedless extractor. In some cases, estimation rounds may be generated by using one or more quantum devices or systems to provide estimation on Bell inequality violation, shift Bell violation value, CHSH violation value, or shifted CHSH violation value. Bell inequality violation, shift Bell violation value, CHSH violation value, or shifted CHSH violation value may be used to indicate the randomness, quantum correlation, or unpredictability of the measurement results. The estimation rounds may be same as or different from the rounds where bits for the raw key are generated (generation rounds). In some cases, the one or more quantum systems may be memoryless, and the estimation rounds may be statistically independent from each other or from the generation rounds. In some cases, the one or more quantum systems may retain certain memory between round of measurements, where the estimation rounds or the generation rounds may be partially corrected among themselves or with each other. In some cases, a number or a probability pe of the estimation rounds generated or a ratio between the number or probability of the estimation and the generation rounds may be predetermined or provided to the system.

In some cases, a Bell value or a shifted Bell value associated with the raw key may be estimated in the estimation round. in some cases, some or all of the observables of some or all of the one or more quantum systems may be measured in the estimation round. In some cases, a Bell value or a shifted Bell value obtained from the estimation round may characterize or be used to estimate a Bell violation, a shifted Bell value, an entropy, a min-entropy rate, or a randomness of the raw key obtained from the generation rounds. For example, for binary 2-input, 2-output set up discussed under section heading Seedless extractors: Results Part 2, the quantity zₗ=aₗ+bₗ+xₗyₗ mod 2 may be used to estimate a Bell value associated with the raw key by using, for example the relation defined in Equation 1.

In some implementations, completion of n rounds may comprise, completion of nᵣ generation rounds and nₑ testing rounds, where nᵣ and nₑ are provided to the device that generates the ransom bits by a computing system that executes a seedless randomness extraction protocol. In some cases, the ratio nₑ/n may be substantially equal to the probability pₑ provided to the system.

In some examples, interactions with the first and second devices 402a, 402b may follow a spot-checking protocol (e.g., the spot-checking protocols described below).

At block 506 the input-output combinations generated at block 502 and selected at block 504 may be used to calculate statistics (e.g., a Bell value, BV) based on Bell inequality using the input-outputs of nₑ estimation rounds. For example, computing system 202 may calculates P(a,b|x,y) and uses it to calculate the a CHSH value “s” from Equation (1). This information may be used to infer properties about the nᵣ generation rounds, e.g., a lower bound on the expected CHSH value from the generation rounds, or a bound on the expectation of a product of shifted CHSH operators of the generation rounds (as described below). Based on the calculated statistics a decision is made whether to continue or abort the protocol.

At decision block 508, if the Bell value (BV) determined at block 504 is less than a threshold BV value, the process may proceed to block 510 where the outcomes of the block 502 are discarded and the process proceeds back to block 502 to perform a new set of measurement during a subsequent measurement period. If at decision block 506, if the Bell value (BV) determined at block 504 is more than a threshold BV value, the process proceeds to block 512.

At block 512, computing system 202 may use the seedless randomness extractor to extract a secret key from the nᵣ raw bits. In some cases, the secret key can be shorter than a raw key formed by the raw bits. In contrast to keys extracted by a seeded randomness extractor and a promise on the conditional min-entropy, that can be conditioned on an adversary's information of the nᵣ raw key outputs, the secret key can be uniformly random and secret, even to the adversary.

FIG. 5B is a flow diagram illustrating another example process 520 performed by a processor of computing system 200.

The process 520 begins at block 522 where a through interactions with the first and second devices 402a, 402b of the device 200, a series of measurements are performed to generate the plurality of random bits 201.

At block 524 the input-output combinations generated at block 522 may be used to calculate statistics (e.g., a Bell value, BV) based on Bell inequality. For example, computing system 203 may calculate P(a,b|x,y) and use it to calculate a CHSH value “s” (a Bell value) from Equation (1). This information may be used to infer a lower bound on the expected CHSH value, or a bound on the expectation of a product of shifted CHSH operators of the plurality of random bits 201. Based on the calculated statistics a decision is made whether to continue or abort the protocol.

At decision block 526, if the Bell value (BV) determined at block 524 is less than a threshold BV value, the process may proceed to block 528 where the outcomes of the block 522 are discarded and the process proceeds back to block 522 to perform a new set of measurement during a subsequent measurement period. If at decision block 526, it is determined that the Bell value (BV) determined at block 524 is more than a threshold BV value, the process proceeds to block 530.

At block 530, computing system 203 may use the seedless randomness extractor to extract a secret key from the nᵣ raw bits. In some cases, the secret key can be shorter than a raw key formed by the raw bits.

In some embodiments, a predetermine or user defined output secret key length, error tolerance of the final secret key, a computation efficiency, or a extraction rate may be passed on to a seedless extractor to determine the function used by the extractor to obtain the final secret key. In some cases, the extractor may determine, select, or adjust one or more of the output secret key length, error tolerance of the final secret key, computation efficiency, extraction rate, and the function used based on various properties of the input, which may comprise a bit string raw key and a Bell value associated with the raw key. In some cases, the extractor may reject the input raw bit if one or more of the criteria discussed herein is not met.

In some embodiments, the seedless extractor 206 does not receive a seed random bit string. In some embodiments, the seedless extractor 206 may not receive any random bit string other than the raw bits of initial random bits received from device 200. In some cases, the min-entropy or the min-entropy rate of the raw key may not need to be calculated in order to generate the output secret key. The inventors have discovered, in some cases, a Bell violation associated with the raw key may related to an entropy of the raw key, and may offer more statistical information or be used to derive stronger bounds (for example, on the error) of the output than min-entropy does. In some cases, the source of randomness consumed by the seedless extractor may not be bounded by a min-entropy to generate a perfect or nearly perfect secret key. In some cases, a system comprising the seedless extractor may not need any initial randomness that has minimal statistical requirements, for example, the system may not need initial randomness stronger than those of a Santha-Vazirani source to generate perfect or nearly perfect random secret keys.

In some embodiments, the seedless extractor may be a deterministic randomness extractor. For example, in some cases, the seedless extractor may comprise a deterministic function, or a group or a library of deterministic functions to derive the final secret key from the raw key. In some cases, a function from the group or library of deterministic functions may be selected by the extractor based on an upstream input or an user input to derive the final secret key.

In some embodiments, the length of the output secret key generated using some of the disclosed seedless extractors may be shorter or equal to the length of the input raw key. This is in contrast to some of the existing probabilistic seeded extractors, where the length of the output key is larger than that of the input raw key. However, a secret key generated by the disclosed seedless extractors, e.g., for the same input raw key, may have a smaller error or can be closer to a perfectly random key.

In some cases, the seedless extractor may use the same extraction function during several random number generation periods. In some cases, the seedless extractor may select, change, or modify the extraction function automatically, in response to a user input (for example, output length, an efficiency, or an error tolerance), or in response to a variation in the input (for example, an input related to change in a Bell value, raw key length, or number or proportion of estimation or generation rounds.) In some cases, the extraction function maybe a concatenated or a piece-wise function, where more than one deterministic function may be used for different parameter regimes in order to optimize the properties over a wider parameter regime. In the following, some examples of the functions the seedless extractor may use to derive the final secret key from the raw key are presented.

### Example Seedless Extractor Based on XOR

In some embodiments, the function the seedless extractor uses to derive the final secret key from the raw key may comprise a linear or a Boolean function on the bit strings of the input raw key. For example, the function may comprise an exclusive XOR function acting on some or all of the bit strings of the saw key. In some cases, the bit strings of the input raw key or the final secret key may be binary, and may be selected from the group {0,1}. In some cases, the function may perform a sum over some or all the binary bits in the raw key, and one bit the secret key may be generated by taking a modulo 2 of this sum. In some cases, only one bit of the final key may be generated using an XOR function regardless of the length of the input raw key. In some cases, the function may be represented by Equation (86).

In some cases, the extractor may perform a decision on whether to accept or reject a particular input raw key based on the information on the Bell value or the quantum correlation associated with the raw key. For example, the extractor may determine that a Bell violation associated with raw kay is not sufficient according to predetermined or user-provided criteria, for example, the error tolerance of the final key. In some cases, this decision may be performed based on Equation (110), where m=1 corresponds to accepting the raw key and generating a secret key with a length of 1, and where m=0 corresponds to rejecting the raw key by generating a secret key with a length of 0.

In some cases, seedless extraction performed using a Boolean or an XOR function may be performed in a linear number of computational steps, where the computation power or time required may vary linearly with respect to the length of the input raw key. For example, seedless extraction performed using a Boolean or an XOR function on an input raw key with length nᵣ may be performed in time of order O(nᵣ) or smaller.

In some cases, an error or a tolerance of the final key extracted using a Boolean or an XOR function may be estimated based on or in relation to the Bells values associated with the raw key, the measurement results of the estimation rounds associated with the raw key, the length of the input raw key, the number or the probability of the estimation round, or the length of the output secret key. For example, the error may be estimated using inequality (113) below. In some cases, the error of the final key extracted using a Boolean or an XOR function may reduce as the proportion of estimation rounds, or the total number of rounds increases. In some cases, the final key extracted using a Boolean or an XOR function may be exponentially small in nᵣ or smaller. In some cases, the error may be <<1, and the secret key indistinguishable from an ideal or uniformly distributed secret key. In some cases, the error may be smaller than 2⁻³², smaller than 2⁻¹²⁸, or smaller than 2⁻²⁵⁶ Example seedless extractor based on a balanced function

In some cases, a seedless extractor may generate more than one bit of secret key from a raw key. In some cases, a group of deterministic functions called the balanced function may be used to generate a secret key of a predefined or user provided length m from a raw key of length nᵣ. For example, in some cases, such balanced functions may satisfy the relations in Lemma 10.

The length of the secret key generated using a balanced function may be determined based on or in relation to the Bell values associated with the raw key, the measurement results of the estimation rounds associated with the raw key, the length of the input raw key, the number or the probability of the estimation round, or the error of the output secret key. For example, the length of the secret key generated may be determined using inequality (118).

In some cases, a balanced function may also be a linear function. In some cases a seedless extraction performed using a balanced function may be performed in a linear number of computational steps, where the computation power or time required may vary linearly with respect to the length of the input raw key. For example, seedless extraction performed using a balanced function on an input raw key with length nᵣ may be performed in time of order O(nᵣ) or smaller.

In some cases, seedless extraction performed using a balanced function may be performed in a near linear number of computational steps, where the computation power or time required may vary nearly linearly with respect to the length of the input raw key. For example, seedless extraction performed using a balanced function on an input raw key with length nᵣ may be performed in time of order O (nᵣ log nᵣ) or smaller. In some cases, a balanced function may be computationally hard to implement.

In some cases, an efficiency rate (e.g., number of output bits per generation round) of the seedless extraction performed using a balanced function may be estimated based on or in relation to the Bells values associated with the raw key, the measurement results of the estimation rounds associated with the raw key, the length of the input raw key, the number or the proportion of the estimation round, the length of the output secret key, or the error tolerance of the output key. For example, the efficiency rate may be estimated using Equation (121).

In some cases, an extraction rate (e.g., number of output bits per extractor input bit or per raw key bit) of the seedless extraction performed using a balanced function may be estimated based on or in relation to the Bells values associated with the raw key, the measurement results of the estimation rounds associated with the raw key, the length of the input raw key, the number or the proportion of the estimation round, the length of the output secret key, or the error tolerance of the output key. For example, the efficiency rate may be estimated using Equation (122). In some cases, the balanced function based seedless extractor may perform optimally, where the extraction approaches 1, for example, when the total number of rounds is large, the proportion of the estimation rounds is large, or when a Bell value or a CHSH violation value is high.

In some cases, an error or a tolerance of the final key extracted using a balanced function may be estimated based on or in relation to the Bells values associated with the raw key, the measurement results of the estimation rounds associated with the raw key, the length of the input raw key, the number or the probability of the estimation round, or the length of the output secret key. For example, an upper bound for the error may be estimated using inequality (101). In some cases, the error of the final key extracted using a balanced function may reduce as the Bell violation or CHSH violation increase. In some cases, the length of the final key extracted using a balanced function may increase as the Bell violation or CHSH violation increase. In some cases, the error may be <<1, and the secret key indistinguishable from an ideal or uniformly distributed secret key.

### Computationally-Efficient Seedless Extractors

In some cases, the function used by the seedless extractor to generate a secret key may comprise a matrix, for example, an m×nᵣ matrix, where m is the length of the output secret key and nᵣ is the length of the input raw key. In some cases, the non-zero entries of the matrix may comprise elements or numbers from a Z₂ group. In some cases, the matrix-based function may further comprise modulo 2 operation, for example, after the action of the matrix on the raw key. For example, the seedless extractor may be a matrix-like function satisfying Equation (92).

In some cases, a matrix of the matrix-based extractor function may have a high Hamming weight (as described below). In some cases, the error of the output secret key may decrease as the Hamming weight of the matrix increases. In some cases, a matrix of the matrix-based extractor function may have a minimum Hamming weight and may bare certain resemblance to matrices used in linear error correction codes.

In some cases, a seedless extraction performed using the matrix-based function may be performed in a linear number of computational steps, where the computation power or time required may vary linearly with respect to the length of the input raw key. For example, in some implementations, seedless extraction performed using a balanced function on an input raw key with length nᵣ may be performed in time of order O(m×nᵣ) or smaller.

In various implementations other deterministic functions may be used by the seedless extractor 206 to extract the secret key 168 from the plurality of initial random bits 201b (the raw key). Additional deterministic functions, the criteria for selecting the deterministic function 208, and relation between some of the deterministic functions and error correction codes, are discussed below with further details and based on a series of proven mathematical theorems and lemmas.

In various implementations, to determine BV and select initial bits for randomness extraction, the disclosed seedless randomness extractors may:
Use all rounds of random bit generation by a device (e.g., device 200) for both testing and generation (i.e. use random measurement bases at every round)
Use time blocks rounds having fixed duration and using random measurement bases.
Characterise the device (e.g., the quantum apparatus or device 200) before executing the protocol. For example, test the device 200 before usage, then generate output using fixed measurement bases and assume the behaviour of device remains unchanged.
Use blocks of bits with random lengths, incrementing through the measurement basis settings.

### Device-Independent Seedless Extractors: Results Part-1

In this section several example constructions for seedless extractors are presented, including seedless extractors that may provide optimal rate, optimal error, and/or can be computationally efficient. A proof for a mathematical link between the seedless extraction and error correction is provided. This proof may serve as the foundation for some of the constructions and related results. Further a proof-of-principle technique is provided for estimating the error of the disclosed seedless extractor functions, and to show that, in some embodiments, the estimated error can be made small.

### Notation and Mathematical Framework

With reference to FIG. 4, in some embodiments, the process for generating a raw key a=(a₁, . . . , aₙ_{ᵣ}) may consist of nᵣ rounds labelled by i∈{1, . . . , nᵣ}. In some cases, in round i Alice (e.g., a first quantum system) performs a measurement labeled by xᵢ with a positive operator valued measure (POVM) {Aᵢ(aᵢ|xᵢ)}ₐ_{ᵢ} acting on the Hilbert space [symbol] ᵢ and obtains the outcome aᵢ. Analogously, in round i Bob (e.g., a second quantum system) performs the measurement labelled by yᵢ with POVM {Bᵢ(bᵢ∥xᵢ)}_{b}_{ᵢ} acting on the Hilbert space [symbol] ᵢ and obtains the outcome bᵢ.

Here the notation

$$𝒜 = {⊗}_{i = 1}^{{n}_{r}} {𝒜}_{i} and ℬ = {⊗}_{i = 1}^{{n}_{r}} {ℬ}_{i}$$

is used where the action of Aᵢ(a|x) on [symbol] ⊗ [symbol] can be non-trivial on the factor A, only, and it may act as the identity L in the rest of factors of [symbol] ⊗ [symbol] . In other words, in some cases, it may be assumed that there is no-signaling between Alice and Bob (e.g., the corresponding devices are non-signaling) and the corresponding devices are memoryless. In implementations, Alice and Bob and the corresponding devices may have an internal memory.

In some cases, the nᵣ-round state for Alice and Bob can be pAJ and, after applying the sequence of measurements x=(x₁, . . . , xₙ_{ᵣ}) and y=(y₁, . . . , yₙ_{ᵣ}), it produces the outcomes a=(a₁, . . . , aₙ_{ᵣ}) and b=(b₁, . . . , bₙ_{ᵣ}) with probability:

$$P ( a , b \vert x , y ) = tr ( {ρ}_{𝒜ℬ} {\prod }_{i = 1}^{{n}_{\text{?}}} {A}_{i} ( {a}_{i} \vert {x}_{i} ) {B}_{i} ( {b}_{i} \vert {y}_{i} ) ) , \qquad ( 2 )$$

$$\text{?} \text{indicates text missing or illegible when filed}$$

In some cases, there may be no loss of generality when the operators Aᵢ(aᵢ|xᵢ) and Bᵢ(bᵢ|yᵢ) are assumed to be projectors.

In some aspects, the disclosed methods and proofs may introduce a seedless extraction in a simple setting. As such, inputs and outputs may be considered to be binary where aᵢ, bᵢ, xᵢ, yᵢ∈{0, 1}, and the raw key may consist of Alice's outcomes a=(aᵢ, . . . , aₙ_{ᵣ}). In some embodiments, the inputs and outputs may have arbitrary alphabets and the raw key can include both Alice and Bob's outcomes (a, b). In the binary case it can be convenient to introduce the Hermitian operators:

$${A}_{{x}_{i}} = {A}_{i} ( 0 \vert {x}_{i} ) - {A}_{i} ( 1 \vert {x}_{i} ) , \qquad ( 3 )$$

$${B}_{{y}_{i}} = {B}_{i} ( 0 \vert {y}_{i} ) - {B}_{i} ( 1 \vert {y}_{i} ) , \qquad ( 4 )$$

for all i, xᵢ, yᵢ. These operators have eigenvalues ±1 and allow to write

$${A}_{i} ( {a}_{i} \vert {x}_{i} ) = \frac{1}{2} ( {𝕀}_{i} + {( - 1 )}^{{a}_{\text{?}}} {A}_{{x}_{i}} ) . \qquad ( 5 )$$

$$\text{?} \text{indicates text missing or illegible when filed}$$

The CHSH inequality (1) for round i can be written as:

$$tr [ {ρ}_{{𝒜}_{i} {ℬ}_{1}} ( {A}_{{0}_{i}} {B}_{{0}_{i}} + {A}_{{0}_{i}} {B}_{{1}_{\text{?}}} + {A}_{{1}_{i}} {B}_{{0}_{i}} - {A}_{{1}_{\text{?}}} {B}_{{1}_{\text{?}}} ) ] \leq 2. \qquad ( 6 )$$

$$\text{?} \text{indicates text missing or illegible when filed}$$

In some embodiments, the violation of this inequality by a state [symbol] may impose the following constraint: the stronger the violation is, the closer tr[ [symbol] P(aᵢ|xᵢ)] is to the uniform distribution. Or, equivalently, the closer is tr( [symbol] A₀_{ᵢ}) to zero. This upper bound may captured (e.g., optimally captured) by theorem 1 below. A proof of theorem 1 may be found in “Secure device-independent quantum key distribution with causally independent measurement devices.”, by Lluis Masanes, Stefano Pironio, and Antonio Acιn, published on 15 Mar. 2011 in Nature Communications, 2(1):238 herein referred to as “Masanes”.

Theorem 1. For any s∈(2,2\sqrt{2}) define the coefficients

$${μ}_{\text{?}} = 2 {( 2 - \frac{{s}^{2}}{4} )}^{- 1 / 2} , {ν}_{\text{?}} = \frac{s}{4} {( 2 - \frac{{s}^{2}}{4} )}^{- 1 / 2} . \qquad ( 7 )$$

$$\text{?} \text{indicates text missing or illegible when filed}$$

Then, for any Hermitian operators A₀_{ᵢ}, A₁ acting on [symbol] ᵢ and B₀_{ᵢ}, B₁ acting on [symbol] ᵢ, all with eigenvalues ±1, the semi-definite inequality:

$${A}_{{x}_{i}} \leq {μ}_{\text{?}} {𝕀}_{i} - {ν}_{\text{?}} ( {A}_{{0}_{i}} {B}_{{0}_{i}} + {A}_{{0}_{i}} {B}_{{1}_{\text{?}}} + {A}_{{1}_{\text{?}}} {B}_{{0}_{i}} - {A}_{{1}_{i}} {B}_{{1}_{\text{?}}} ) , \qquad ( 8 )$$

$$\text{?} \text{indicates text missing or illegible when filed}$$

may hold for all xᵢ and s∈(2,2\sqrt{2}).

The above may suggest defining a shifted version of the CHSH Bell operator (for round i) as:

$${S}_{i} = {μ}_{s} {𝕀}_{i} - {ν}_{\text{?}} ( {A}_{{0}_{i}} {B}_{{0}_{i}} + {A}_{{0}_{\text{?}}} {B}_{{1}_{\text{?}}} + {A}_{{1}_{i}} {B}_{{0}_{i}} - {A}_{{1}_{i}} {B}_{{1}_{\text{?}}} ) , \qquad ( 9 )$$

$$\text{?} \text{indicates text missing or illegible when filed}$$

which implicitly depends on the parameter s and satisfies

$$tr ( {ρ}_{{𝒜}_{\text{?}} {ℬ}_{\text{?}}} {S}_{i} ) = {\sum }_{{a}_{i} , {b}_{i} , {x}_{i} , {y}_{i}} P ( {a}_{i} , {b}_{i} \vert {x}_{i} , {y}_{i} ) ( \frac{{μ}_{s}}{4} - {{ν}_{s} ( - 1 )}^{{a}_{\text{?}} + {b}_{\text{?}} + {x}_{i} {y}_{i}} ) . \qquad ( 10 )$$

$$\text{?} \text{indicates text missing or illegible when filed}$$

Also, using the definition in (9), the semi-definite inequality can be written as:

$${\prod }_{i = 1}^{{n}_{r}} {A}_{{x}_{i}} \leq {\prod }_{i = 1}^{{n}_{\text{?}}} {S}_{i} , \qquad ( 11 )$$

$$\text{?} \text{indicates text missing or illegible when filed}$$

for all (x₁, . . . , xₙ_{ᵣ}). A poof of (11) is provided in Masanes.

### Universally-Composable Security

The Hilbert space of an adversary (e.g., named Eve) may be denoted by ε. The global state shared between Alice, Bob and Eve may be expressed as [symbol] , and the reduced state of Alice and Eve as [symbol] , etc. The raw key a=(a₁, . . . , aₙ_{ᵣ}) can be generated by performing the sequence of measurements {Aᵢ(aᵢ|0)}ₐ_{ᵢ} for all rounds i=1, . . . , nᵣ on the state [symbol] . Then, the secret key k=(k₁, . . . , kₘ) is produced by applying a (non-random) function g: {0, 1}ⁿ^{ᵣ}→{0, 1}^{m} to the raw data k=g(a). In the following sections the function g is characterized and various examples of the function g are provided.

Although the secret key k is a classical system it is convenient to associate to it a Hilbert space [symbol] = [symbol] ²^{^{m}} and an orthonormal basis |k [symbol] ∈ [symbol] representing its values. After Alice measures all her systems [symbol] ᵢ and generates the secret key [symbol] , the joint state of systems [symbol] , ε is:

$${ρ}_{𝒦ℰ} = {\sum }_{k ∈ {\{ 0 , 1 \}}^{\text{?}}} {\sum }_{a ∈ {\{ 0 , 1 \}}^{\text{?}}} \vert k 〉 〈 k {\vert}_{𝒦} {δ}_{g ( a )}^{k} {tr}_{𝒜} [ {ρ}_{𝒜ℰ} {\prod }_{i = 1}^{{n}_{r}} {A}_{i} ( {a}_{i} \vert 0 ) ] . \qquad ( 12 )$$

$$\text{?} \text{indicates text missing or illegible when filed}$$

In some cases, Alice and Bob may produce a state [symbol] that is indistinguishable from an ideal secret key uκρκ, where the uniform state (sometimes called maximally mixed) may be defined as:

$${u}_{𝒦} = {2}^{- m} {\sum }_{k ∈ {\{ 0 , 1 \}}^{\text{?}}} \vert k 〉 〈 k {\vert}_{𝒦} . \qquad ( 13 )$$

$$\text{?} \text{indicates text missing or illegible when filed}$$

This indistinguishability can be formalized as a bound on the trace norm ∥ [symbol] − [symbol] ρε∥, which may be referred to as the extractor error. In some cases, the trace norm of an operator Mmay be defined as ∥M∥=tr\sqrt{M^{\}M}. Such a bound may imply that any cryptographic task which uses an ideal secret key [symbol] , as input can be also secure when it is fed with the secret key [symbol] (e.g., because otherwise this task may provide a means to distinguish the two states). As such, in some cases, the disclosed key generation protocol can be composed with another, or in some cases, any other cryptographic protocol, or it can be universally composable.
Seedless Extractors with Optimal Rate

In this section, a proof is provided for the existence of seedless extractors g with good key rates (e.g., when key length is close to the entropy of the input) for all noise regimes. In some cases, this proof can be based on randomized methods, so it may provide an explicit construction, and the resulting extractors are likely to be computationally hard to implement. In the following sections these problems are addressed by presenting seedless extractors with simple constructions which can be implemented with O(nᵣ), O(nᵣ log(nᵣ)) and

$$O ( {n}_{r}^{2} )$$

algorithms. The advantage of the extractors analyzed in this section is that they are expected to provide optimal asymptotic key rates for all noise regimes. This expectation is based on the fact that random codes are asymptotically optimal in many information-theoretic applications. The following theorem is proven in “Seedless Extraction with Randomized Functions” below.

Theorem 2 (Existence of seedless extractors) For each value of nᵣ, m there exists a function g: {0, 1}ⁿ^{ᵣ}→{0, 1}^{m} satisfying:

$$\vert \{ a : g ( a ) = k \} \vert = {2}^{{n}_{r} - m} \qquad ( 14 )$$

for all k and the following statement. After measuring the nᵣ-round state [symbol] with the observables {Aᵢ(aᵢ∥0)}ₐ_{ᵢ} for all i=1, . . . nᵣ and applying the function k=g(a) to the outcomes a=(a₁, . . . , aₙ_{ᵣ}), the resulting state [symbol] written in (12) fulfills

$$‖ {ρ}_{𝒦ℰ} - {u}_{𝒦} {ρ}_{ℰ} ‖ \leq \sqrt{{2}^{m - {n}_{r} + 1}} ( t {r}_{𝒜ℬ} [ {ρ}_{𝒜ℬ} {\prod }_{i = 1}^{{n}_{\text{?}}} ( {𝕀}_{i} + {S}_{i} ) ] - 1 ) . \qquad ( 15 )$$

$$\text{?} \text{indicates text missing or illegible when filed}$$

When the CHSH violation (the Bell value) is large, the expectation of Sᵢ is small, and the right-hand side of (15) may provide a useful upper bound to the distance.

### Computationally-Efficient Seedless Extractors

In this section seedless extractors of the form g: {0,1}ⁿ^{ᵣ}→{0,1}^{m} are defined by an m×nᵣ matrix G with entries in [symbol] ₂ so that:

$$k = g ( a ) = Ga mod 2. \qquad ( 16 )$$

Note that the action of the matrix G on the vector a is defined modulo 2. Also, it is important to stress that a linear function k=Ga can be computed in O(mnᵣ) time, at most, which is less computationally demanding than the extractors g considered in the previous section.

In what follows a useful relationship between linear seedless extractors, e.g., defined by (16), and the generator functions of linear (classical) error-correcting codes, a result that can be independently interesting¹. This is followed by the analysis of two explicit linear extractors, one of which provides optimal error for extracting a single bit and another which gives optimal rates (in principle) in the low noise regime (e.g., close to maximal violation of a Bell inequality). These two codes can be used as ingredients to construct a concatenated code in all regimes. ¹ This result follows, and may contribute to, a line of research directed to finding relations between the tasks of privacy amplification and error-correction.

Lemma 3 (Linear seedless extractors). For a m×nᵣ matrix G with entries in [symbol] ₂ an indicator function can be defined as:

$${I}_{G} ( r ) = \{ \begin{matrix}0 & if r ∉ span G \\ 1 & if r ∈ span G\end{matrix} , \qquad ( 17 )$$

where

$$r ∈ {ℤ}_{2}^{{n}_{r}}$$

and span

$$G ⊆ {ℤ}_{2}^{{n}_{r}}$$

is subspace spanned by the rows of G. After measuring the nᵣ-round state [symbol] with the observables {Aᵢ(aᵢ|0)}ₐ_{ᵢ} for all i=1, . . . , nᵣ and applying the linear function Ga=k to the outcomes a=(a₁, . . . , aₙ_{ᵣ}), the resulting state [symbol] written in (12) may satisfy.

$$‖ {ρ}_{𝒦ℰ} - {u}_{𝒦} {ρ}_{ℰ} ‖ \leq {\sum }_{r \neq 0} {I}_{G} ( r ) {tr}_{𝒜ℬ} [ {ρ}_{𝒜ℬ} {\prod }_{i} {S}_{i}^{{r}_{i}} ] . \qquad ( 18 )$$

To understand the significance of this lemma, the Hamming weight w(r) of a vector

$$r ∈ {ℤ}_{2}^{{n}_{r}}$$

may be defined as the number of 1's in r, and consider the product case [symbol] =⊗ᵢ [symbol] . Then, in some cases, a sufficient Bell violation [symbol] [ [symbol] Sᵢ]≤1 may imply that the terms

$${ tr}_{𝒜ℬ} [ {ρ}_{𝒜ℬ} {\prod }_{i} {S}_{i}^{{r}_{i}} ]$$

in (18) decrease as w(r) increases. Therefore, it can be desirable that all elements of span G, with the exception of the zero vector 0, have high Hamming weight. This property may be naturally exhibited by error-correcting codes, where all generated codewords (that are not the zero vector) may have a minimum Hamming weight². Each such code may be defined by a generator matrix G, and its distance d, such that

$$d \leq {min}_{r ∈ span G : r \neq 0} w ( r ) . \qquad ( 19 )$$

Hence, all terms in the summation of (18) with w(r)<d may vanish. ² In some cases, error-correcting codes may guarantee something stronger, in the sense that any pair of generated codewords can have a minimum Hamming distance.

Proof. Starting by substituting (5) in state defined by (12) and expanding the product Πᵢ( [symbol] ᵢ+(−1)^{a}^{ᵢ}A₀_{ᵢ}) into 2ⁿ^{ᵣ} terms labelled by the vectors r∈{0,1}ⁿ^{ᵣ},

$${ρ}_{𝒦ℰ} = {\sum }_{k , a} \vert k 〉 〈 k {\vert}_{𝒦} {δ}_{Ga}^{k} {tr}_{𝒜} [ {ρ}_{𝒜ℰ} {\prod }_{i} \frac{1}{2} ( {𝕀}_{i} + {( - 1 )}^{{a}_{i}} {A}_{{0}_{i}} ) ] \qquad ( 20 )$$

$$= {\sum }_{k , a} \vert k 〉 〈 k {\vert}_{𝒦} {δ}_{Ga}^{k} {tr}_{𝒜} [ {ρ}_{𝒜ℰ} {2}^{- {n}_{i}} {\sum }_{r} {\prod }_{i} {( - 1 )}^{{a}_{i} {r}_{i}} {( {A}_{{0}_{i}} )}^{{r}_{i}} ] , \qquad ( 21 )$$

the identities (Aₐ_{ᵢ})⁰= [symbol] ᵢ and (Aₐ_{ᵢ})¹=Aₐ_{ᵢ} have been used for full-rank operators. Next, since G has full rank, there may exist at least one vector aₖ∈{0, 1}ⁿ^{ᵣ} such that for all k=(k₁, . . . kₙ)∈{0, 1}^{m}, k=Gₐ_{ₖ}. This allows us to write the Kronecker delta as

$${δ}_{Ga}^{k} = {\prod }_{j = 1}^{m} [ {G}_{j} \cdot a - {k}_{j} + 1 mod 2 ] \qquad ( 22 )$$

$$= {\prod }_{j = 1}^{m} [ {G}_{j} \cdot ( a - {a}_{k} ) + 1 mod 2 ] , \qquad ( 23 )$$

where Gⱼ denotes the jth row of G, and perform the summation

$${2}^{- {n}_{r}} {\sum }_{a} {{δ}_{Ga}^{k} ( - 1 )}^{a \cdot r} = {2}^{- {n}_{r}} {\sum }_{a} {( - 1 )}^{a \cdot r} {\prod }_{j = 1}^{m} [ {G}_{j} \cdot ( a - {a}_{k} ) + 1 mod 2 ] \qquad ( 24 )$$

$$= {2}^{- {n}_{r}} {\sum }_{a - {a}_{k} ∈ ker G} {( - 1 )}^{a \cdot r} , \qquad ( 25 )$$

$$= {2}^{- {n}_{r}} {( - 1 )}^{{a}_{k} \cdot r} {\sum }_{v ∈ ker G} {( - 1 )}^{a \cdot r} \qquad ( 26 )$$

$$= \{ \begin{matrix}{2}^{- m} {( - 1 )}^{{a}_{k} \cdot r} & if r \cdot v = 0 ∀ v ∈ ker G \\ 0 & otherwise\end{matrix} \qquad ( 27 )$$

where the last equality can use the fact that Σ_{veker G}(−1)^{v·r}=2ⁿ^{ᵣ}^{-m} for all r and v∈ker G such that r·v=0 and 0 otherwise. The set of all r such that r·v=0 for any v∈ker G is the subspace of

$${ℤ}_{2}^{{n}_{r}}$$

spanned by the rows of G, known as the row-space of G which is denoted span G. Substituting (27) in (21), and using the indicator function I_{G} defined in (17) may give:

$${ρ}_{𝒦ℰ} = {\sum }_{k} {2}^{- m} \vert k 〉 〈 k {\vert}_{𝒦} ( {ρ}_{ℰ} + {tr}_{𝒜} [ {ρ}_{𝒜ℰ} {\sum }_{r \neq 0} {( - 1 )}^{{a}_{k} \cdot r} {I}_{G} ( r ) {\prod }_{i} {A}_{{0}_{i}}^{{r}_{i}} ) ] ) , \qquad ( 28 )$$

which then can be used in the trace norm to obtain:

$$‖ {ρ}_{𝒦ℰ} - {u}_{𝒦} {ρ}_{ℰ} ‖ = {\sum }_{k} {2}^{- m} ‖ {tr}_{𝒜} [ {ρ}_{𝒜ℰ} {\sum }_{r \neq 0} {( - 1 )}^{{a}_{k} \cdot r} {I}_{G} ( r ) {\prod }_{i} {A}_{{0}_{i}}^{{r}_{i}} ] ‖ \qquad ( 29 )$$

$$\leq ‖ {tr}_{𝒜} [ {ρ}_{𝒜ℰ} {\sum }_{r \neq 0} {I}_{G} ( r ) {\prod }_{i} {A}_{{0}_{i}}^{{r}_{i}} ] ‖ \qquad ( 30 )$$

$$= ‖ {tr}_{𝒜ℬ} [ {ρ}_{𝒜ℬℰ} {\sum }_{r \neq 0} {I}_{G} ( r ) {\prod }_{i} {A}_{{0}_{i}}^{{r}_{i}} ] ‖ \qquad ( 31 )$$

$$\leq ‖ {tr}_{𝒜ℬ} [ {ρ}_{𝒜ℬℰ} {\sum }_{r \neq 0} {I}_{G} ( r ) {\prod }_{i} {S}_{i}^{{r}_{i}} ] ‖ , \qquad ( 32 )$$

where the last inequality follows from (11) and uses the identities (Sᵢ)⁰= [symbol] ᵢ, and (Sᵢ)¹=Sᵢ, since Si is full rank. The operator:

$${S}_{i}^{{r}_{i}} = {\sum }_{{a}_{i} , {b}_{i} , {x}_{i} , {y}_{i}} {A}_{i} ( {a}_{i} \vert {x}_{i} ) {B}_{i} ( {b}_{i} \vert {y}_{i} ) \frac{1}{4} {( \frac{{μ}_{s}}{4} - {{v}_{s} ( - 1 )}^{{a}_{i} + {b}_{i} + {x}_{i} , {y}_{i}} )}^{{r}_{i}} \qquad ( 33 )$$

can be positive semi-definite, which implies that

$${tr}_{𝒜ℬ} [ {ρ}_{𝒜ℬℰ} {\prod }_{i} {S}_{i}^{{r}_{i}} ]$$

can be positive too, therefore:

$$‖ {tr}_{𝒜ℬ} [ {ρ}_{𝒜ℬℰ} {\prod }_{i} {S}_{i}^{{r}_{i}} ] ‖ = {tr}_{ℰ} {tr}_{𝒜ℬ} [ {ρ}_{𝒜ℬℰ} {\prod }_{i} {S}_{i}^{{r}_{i}} ] = tr [ {ρ}_{𝒜ℬ} {\prod }_{i} {S}_{i}^{{r}_{i}} ] . \qquad ( 34 )$$

Next, applying the triangular inequality and substituting the above provides:

$$\begin{matrix}‖ {tr}_{𝒜ℬ} [ {ρ}_{𝒜ℬε} {\sum }_{r \neq 0} {I}_{G} ( r ) {\prod }_{i} {S}_{i}^{{r}_{i}} ] ‖ \leq {\sum }_{r \neq 0} {I}_{G} ( r ) ‖ {tr}_{𝒜ℬ} [ {ρ}_{𝒜ℬε} {\prod }_{i} {S}_{i}^{{r}_{i}} ] ‖ & ( 35 ) \\ = {\sum }_{r \neq 0} {I}_{G} ( r ) {tr}_{𝒜ℬ} [ {ρ}_{𝒜ℬ} {\prod }_{i} {S}_{i}^{{r}_{i}} ] , & ( 36 )\end{matrix}$$

concluding the proof.
Specific construction-1: XOR Function

An example explicit seedless extractor can be the XOR function:

$$g ( a ) = {\sum }_{i = 1}^{{n}_{r}} {a}_{i} mod 2 , \qquad ( 37 )$$

which can be computed in linear time (O(nᵣ)) and can produce a single bit of key k∈{0, 1}. The associated 1×nᵣ matrix is:

$$G = [ \begin{matrix}1 & 1 & … & 1\end{matrix} \text{} ] , \qquad ( 38 )$$

which may correspond to the generator matrix of the repetition code. It can be seen that span G={0, 1}, hence the code distance can be d=nᵣ.

Theorem 4 (nᵣ-XOR). In some embodiments, after measuring the n-round state [symbol] with the observables {Aᵢ(aᵢ|0)}ₐi for all i=1, . . . , nᵣ and applying the XOR function of (38) to the outcome

$$k = {\sum }_{i = 1}^{{n}_{r}} {a}_{1}$$

mod 2, the resulting state [symbol] written in (12) may satisfy:

$$‖ {ρ}_{κε} - {u}_{κ} {ρ}_{ε} ‖ \leq tr [ {ρ}_{𝒜ℬ} {\prod }_{i = 1}^{{n}_{r}} {S}_{i} ] . \qquad ( 39 )$$

Proof. The proof for Theorem 4 follows quickly from Lemma 3. Noting that span G={0, 1}, the indicator function I(r) in (17) becomes:

$$I ( r ) = \{ \text{} \begin{matrix}1 & if r ∈ \{ 0 , 1 \} \\ 0 & otherwise .\end{matrix} \text{} \qquad ( 40 )$$

This together with (18) implies (39).

### Specific Construction-2: BCH Codes

Another example family of explicit seedless extractors may generate a key of m bits, where the value of m depends on nᵣ, c, and the estimated Bell violation (S). These extractors are also based on binary linear codes and can be computed with almost linear complexity (O(nᵣ log(nᵣ))). In some cases, the so-called primitive narrow-sense Bose Chaudhuri Hocquenghem (BCH) codes may be used, which are parameterized by the two integers l, t fixing the sizes of the input nᵣ, output m and code distance d. In some cases, some or all these parameters may satisfy the relationships nᵣ=2^{l}−1, m≥nᵣ−lt, and d≥2t+1.

The generator matrix G of the primitive narrow-sense BCH codes is constructed from cyclic shifts of the coefficients c₀, c₁, . . . , c₂t∈ [symbol] ₂. An example derivation of the coefficients c₀, c₁, . . . , c₂t is provided for the family of BCH codes with length nᵣ=15, and for different d's, in “Linear Functions as Seedless Extractors” below. The m×nᵣ generator matrix is,

$$G = [ \begin{matrix}{c}_{0} & {c}_{1} & … & {c}_{2 t} & & & & \\ & {c}_{0} & {c}_{1} & … & {c}_{2 t} & & & \\ & & {c}_{0} & {c}_{1} & … & {c}_{2 t} & & \\ & & & ⋱ & ⋱ & ⋱ & ⋱ & \\ & & & & {c}_{0} & {c}_{1} & … & {c}_{2 t}\end{matrix} \text{} ] \qquad ( 41 )$$

where blank entries are 0's. It is important to mention that the map k=Ga can be computed with near-linear computational complexity, using techniques such as those in, making it efficiently computable and able to run for large input lengths (e.g., larger than 10⁶, larger than 10⁷, larger than 10⁶, larger than 10⁷, larger than 10⁸, larger than 10⁹, larger than 10¹⁰). Using the properties of the above generator matrix leads to the following theorem.

Theorem 5 (Primitive narrow-sense BCH codes) Let G be an m×nᵣ matrix as defined in (41) with corresponding code distance d. After measuring the nᵣ-round state pas with the observables {Aᵢ(aᵢ|0)}ₐ_{ᵢ} for all i=1, . . . , nᵣ and applying the matrix G to the outcomes [symbol] k=Ga, the resulting state pκε written in (12) satisfies

$$‖ {ρ}_{κε} - {u}_{κ} {ρ}_{ε} ‖ \leq {\sum }_{r : w ( r ) \geq d} {tr}_{𝒜ℬ} [ {ρ}_{𝒜ℬ} {\prod }_{i = 1} {S}_{i}^{{r}_{i}} ] , \qquad ( 42 )$$

where w(⋅) is the Hamming weight.

Proof. Let G be the generator matrix of the primitive narrow-sense BCH codes as defined in (41). Starting by recalling Lemma (3):

$$‖ {ρ}_{κε} - {u}_{κ} {ρ}_{ε} ‖ \leq {\sum }_{r \neq 0} {I}_{G} ( r ) {tr}_{𝒜ℬ} [ {ρ}_{𝒜ℬ} {\prod }_{i} {S}_{i}^{{r}_{i}} ] . \qquad ( 43 )$$

where I_{G}(⋅) is the indicator function in (17). Define a different indicator function

$$\tilde{I} ( r ) = \{ \text{} \begin{matrix}0 & if 0 < w ( r ) < d \\ 1 & otherwise ,\end{matrix} \qquad ( 44 )$$

where w(⋅) is the Hamming weight. For all r∈span G such that r≠0, w(r)≥d by definition of the primitive narrow-sense BCH codes, which means that:

$$\tilde{I} ( r ) \geq {I}_{G} ( r ) \qquad ( 45 )$$

for any

$$r ∈ {ℤ}_{2}^{{n}_{r}} .$$

Using (45) to upper bound (43) implies (42).

Note, (42) is not a tight bound. It can be improved by using (43) directly and summing over only the elements in span G. This can be done numerically, however, the number of elements in span G is exponential in m, or by evaluating the relevant coefficients of the Tutte polynomial which, in general, is considered to be difficult.

### Estimation Round

In order to bound the error of our seedless extractors, the product of shifted CHSH operators may be estimated. Since this is a different quantity from previous DI protocols, the concern is that this estimation may lead to results where the extractor error ϵ>>1 always. In this section, a proof of principle method is provided that proves this is not the case. Our method for estimation uses the properties of symmetric distributions and it is likely that this can be improved substantially, as it may not assume the structure of quantum mechanics.

Considering the general setup described in with respect to FIG. 4, with ne estimation rounds and nᵣ raw key generation rounds and it is convenient to express the experiment as having N=nᵣ+nₑ rounds where nₑ=γN and nᵣ=(1−γ)N for some γ∈(0, 1). Define the random variable wᵢ=(−1)^{a}^{ᵢ}^{+b}^{ᵢ}^{+x}^{ᵢ}^{y}^{ᵢ}, which represents ‘winning’ (when wᵢ=1) or ‘losing’ (wᵢ=−1) the CHSH game for round i=1, . . . , N and w=(w₁, . . . , w_{N}) is the N-round string of these random variables. Let q be the relative frequency of wᵢ=−1 (i.e. losing) for i=1, . . . , N where

$$q = \frac{1}{N} {\sum }_{i = 1}^{N} \frac{1 - {w}_{i}}{2} . \qquad ( 46 )$$

Let wₑ denote the outcomes wᵢ of the rounds used for the estimation, and wᵣ the ones used for the generation of raw key. Then w=(wₑ, wᵣ), where wₑ has length γN and wᵣ has length (1−γ)N. Let qₑ be the relative frequency of wₑ and qᵣ that of wᵣ, which satisfy the constraint

$$( 1 - γ ) {q}_{r} + γ {q}_{e} = q . \qquad ( 47 )$$

At this point, a theorem for estimation may be provided.

Theorem 6. Let h be defined as the binary entropy function and consider an N round experiment, as described above (e.g., with respect to FIG. 4, with nₑ=γN estimation rounds and nᵣ=(1−γ)N generation rounds for γ∈(0, 1). Let ϵₑ be a user-defined maximum estimation error and qₑ, qᵣ be the relative frequency of winning the CHSH game in the estimation and generation rounds, respectively, then, for μₛ, vₛ defined in Theorem 1,

$${tr}_{𝒜ℬ} ( {ρ}_{𝒜ℬ} {\prod }_{i = 1}^{( 1 - γ ) N} {S}_{i} ) \leq poly ( N ) {min}_{\text{?}} {max}_{{q}_{r}} {2}^{N [ 2 - 2 γ + {α}_{1} + ( 1 - γ ) {α}_{2} ]} , \qquad ( 48 )$$

$$where$$

$${α}_{1} = γ h ( {q}_{e} ) + ( 1 - γ ) h ( {q}_{r} ) - h ( ( 1 - γ ) {q}_{r} + γ {q}_{e} ) \qquad ( 49 )$$

$${α}_{2} = {q}_{r} {log}_{2} ( \frac{{μ}_{s}}{4} + {v}_{s} ) + ( 1 - {q}_{r} ) {log}_{2} ( \frac{{μ}_{s}}{4} + {v}_{s} ) \qquad ( 50 )$$

$$\text{?} \text{indicates text missing or illegible when filed}$$

Moreover, Theorem 6 is sufficient to calculate the extractor errors for all seedless extractors presented in this work. Recall that the extractor error ϵ is always of the form

$$ϵ \leq {\sum }_{r ∈ R} {tr}_{𝒜ℬ} [ {ρ}_{𝒜ℬ} {\prod }_{i} {S}_{i}^{{r}_{i}} ] \qquad ( 51 )$$

for some set of vectors R⊆{0, 1}ⁿ^{ᵣ}. In order to estimate each term in the summation, the of shifted CHSH operators may be estimated when γN=nₑ and (1−γ)N=w(r) for all w(r)=1, . . . , nᵣ. This can be done by introducing y′, N′ and solving the linear Equation (1−γ′)N′=w(r) and γ′N′=nₑ for γ′,N′, then using γ′,N′ to evaluate the expression in Theorem 6. It is quick to see that when w(r)=nᵣ, as is the only case for the XOR function, γ′=γ and N′=N.

Proof. First, the (1−γN) round expectation of shifted CHSH operators (left hand side of (48) may be expanded into its individual probability terms, using the string of CHSH winning/losing random variables wᵣ=(w1, . . . , wₙ_{ᵣ}) defined at the start of this section

$$\begin{matrix}{tr}_{𝒜ℬ} [ {ρ}_{𝒜ℬ} {\prod }_{i}^{( 1 - γ ) N} {S}_{i} ] = {\sum }_{a , b , x , y} P ( a , b \vert x , y ) {\prod }_{i}^{( 1 - γ ) N} ( \frac{{μ}_{s}}{4} - {{v}_{s} ( - 1 )}^{{a}_{i} + {b}_{i} + {x}_{i} {y}_{i}} ) & ( 52 ) \\ = {\sum }_{a , b , x , y} P ( a , b \vert x , y ) {\prod }_{i}^{( 1 - γ ) N} ( \frac{{μ}_{s}}{4} - {v}_{s} {w}_{i} ) . & ( 53 )\end{matrix}$$

Next, since P(w) is symmetric (i.e., P(w₁, . . . , w_{N})=P(w_{σ(1)}, . . . , w_{σ(N)}) for any permutation σ: {1, . . . , N}→{1, . . . , N}), it can be written as a mixture of distributions of frequencies P(q) via the relation

$$P ( w ) = {\sum }_{q} P ( q ) U ( w \vert q ) , \qquad ( 54 )$$

where U(w|q) is the uniform distribution over strings w with frequency q. This allows us to write (53) as

$${\sum }_{{q}_{r}} P ( {q}_{r} \vert {q}_{e} ) {\prod }_{i} 4 {( \frac{{μ}_{s}}{4} + {v}_{s} )}^{{q}_{r}} {( \frac{{μ}_{s}}{4} - {v}_{s} )}^{1 - {q}_{r}} \qquad ( 55 )$$

$$= {\sum }_{{q}_{r}} {2}^{2 ( 1 - γ ) N} {P ( {q}_{r} \vert {q}_{e} ) [ {( \frac{{μ}_{s}}{4} + {v}_{s} )}^{{q}_{r}} {( \frac{{μ}_{s}}{4} - {v}_{s} )}^{1 - {q}_{r}} ]}^{( 1 - γ ) N} \qquad ( 56 )$$

$$\leq ( ( 1 - γ ) N + 1 ) {min}_{\text{?}} {max}_{{q}_{\text{?}}} ( {2}^{2 ( 1 - γ ) N} {P ( {q}_{r} \vert {q}_{\text{?}} ) [ {( \frac{{μ}_{s}}{4} + {v}_{\text{?}} )}^{{q}_{r}} {( \frac{{μ}_{s}}{4} - {v}_{s} )}^{1 - {q}_{\text{?}}} ]}^{( 1 - γ ) N} ) \qquad ( 57 )$$

$$\text{?} \text{indicates text missing or illegible when filed}$$

for μₛ and vₛ defined in Theorem 1. The last inequality comes from the fact that there are (1−γ) N+1 possible values of qᵣ, and that s is a free parameter that can be optimized over.

Next, the probability term in (57) may be rewritten, using Bayes theorem,

$$P ( {q}_{r} \vert {q}_{e} ) = \frac{P ( {q}_{r} , {q}_{e} )}{P ( {q}_{e} )} \qquad ( 58 )$$

$$= \frac{P ( {q}_{r} , q )}{P ( {q}_{e} )} \qquad ( 59 )$$

$$= U ( {q}_{r} \vert q ) \frac{P ( q )}{P ( {q}_{e} )} \qquad ( 60 )$$

and show that, for some user defined estimation error ϵₑ,

$$P ( {q}_{e} ) \geq \frac{{ϵ}_{e}}{γ N} . \qquad ( 61 )$$

An estimation error occurs when the observed qₑ is not the modal value. Consider some function c(γN) and note that there exist γN+1 possible values for qₑ. In some case, the worst case behavior for the distribution P(qₑ) may occur when γN of the relative frequencies qₑ have equal probability c(γN) and one has probability 1−γNc(γN), and without loss of generality, assume

$$1 - γ Nc ( γ N ) \geq c ( γ N ) . \qquad ( 62 )$$

### Then

$${ϵ}_{e} = γ Nc ( γ N ) \qquad ( 63 )$$

and since

$$P ( {q}_{e} ) \geq c ( γ N ) = \frac{{ϵ}_{e}}{γ N} ,$$

the bound in (61) may be proven.

Now, combining (60) and the bound in (61) gives

$$P ( {q}_{r} \vert {q}_{e} ) \leq \frac{γ N}{{ϵ}_{e}} P ( q ) U ( {q}_{r} \vert q ) , \qquad ( 64 )$$

which allows continuing the proof from (57).

$$( ( 1 - γ ) N + 1 ) {min}_{s} {max}_{{q}_{r}} ( {2}^{2 ( 1 - γ ) N} {P ( {q}_{r} \vert {q}_{e} ) [ {( \frac{{μ}_{s}}{4} + {v}_{s} )}^{{q}_{\text{?}}} {( \frac{{μ}_{s}}{4} - {v}_{s} )}^{1 - {q}_{\text{?}}} ]}^{( 1 - γ ) N} ) \qquad ( 65 )$$

$$\leq ( ( 1 - γ ) N + 1 ) \frac{γ N}{{ϵ}_{est}} {min}_{s} {max}_{{q}_{\text{?}}} ( {2}^{2 ( 1 - γ ) N} P ( q ) {U ( {q}_{r} \vert q ) [ {( \frac{{μ}_{s}}{4} + {v}_{s} )}^{{q}_{\text{?}}} {( \frac{{μ}_{s}}{4} - {v}_{s} )}^{1 - {q}_{\text{?}}} ]}^{( 1 - γ ) N} ) \qquad ( 66 )$$

$$\leq ( ( 1 - γ ) N + 1 ) \frac{γ N}{{ϵ}_{est}} {min}_{s} {max}_{{q}_{r}} ( {2}^{2 ( 1 - γ ) N} {U ( {q}_{r} \vert q ) [ {( \frac{{μ}_{s}}{4} + {v}_{s} )}^{{q}_{\text{?}}} {( \frac{{μ}_{s}}{4} - {v}_{s} )}^{1 - {q}_{\text{?}}} ]}^{( 1 - γ ) N} ) , \qquad ( 67 )$$

$$\text{?} \text{indicates text missing or illegible when filed}$$

where the last inequality uses that P(q)≤1.

The uniform distribution terms can be expressed as

$$U ( {q}_{e} \vert q ) = U ( {q}_{r} \vert q ) = ( \begin{matrix}γ N \\ γ N {q}_{e}\end{matrix} ) ( \begin{matrix}( 1 - γ ) N \\ ( 1 - γ ) N {q}_{r}\end{matrix} ) {( \begin{matrix}N \\ N q\end{matrix} )}^{- 1} \qquad ( 68 )$$

$$= ( \begin{matrix}γ N \\ γ N {q}_{e}\end{matrix} ) ( \begin{matrix}( 1 - γ ) N \\ ( 1 - γ ) N {q}_{r}\end{matrix} ) {( \begin{matrix}N \\ N ( γ {q}_{e} ) + ( 1 - γ ) {q}_{r}\end{matrix} )}^{- 1} \qquad ( 69 )$$

$$\leq poly ( N ) {2}^{[ γ Nh ( {q}_{e} ) + ( 1 - γ ) Nh ( {q}_{r} ) - Nh ( γ {q}_{e} + ( 1 - γ ) {q}_{r} ]} , \qquad ( 70 )$$

using Stirling's approximation. Using (70) to upper bound (67) gives

$$\leq poly ( N ) {min}_{s} {max}_{{q}_{\text{?}}} ( {{2}^{N [ 2 ( 1 - γ ) + γ h ( {q}_{\text{?}} ) + ( 1 - γ ) h ( {q}_{\text{?}} ) - h ( γ {q}_{e} + ( 1 - γ ) {q}_{\text{?}} ]} [ {( \frac{{μ}_{s}}{4} + {v}_{s} )}^{{q}_{\text{?}}} {( \frac{{μ}_{s}}{4} - {v}_{s} )}^{1 - {q}_{\text{?}}} ]}^{( 1 - γ ) N} ) \qquad ( 71 )$$

$$\leq poly ( N ) {min}_{s} {max}_{{q}_{r}} {2}^{N [ 2 ( 1 - γ ) + γ h ( {q}_{e} ) + ( 1 - γ ) h ( {q}_{\text{?}} ) - h ( ( 1 - γ ) {q}_{\text{?}} + γ {q}_{\text{?}} ) + ( 1 - γ ) {log}_{2} [ {( \frac{{μ}_{\text{?}}}{4} + {v}_{\text{?}} )}^{{q}_{\text{?}}} {( \frac{{μ}_{\text{?}}}{4} - {v}_{\text{?}} )}^{1 - {q}_{\text{?}}} ] ]} \qquad ( 72 )$$

$$\leq poly ( N ) {min}_{s} {max}_{{q}_{r}} {2}^{N [ 2 ( 1 - γ ) + γ h ( {q}_{e} ) + ( 1 - γ ) h ( {q}_{\text{?}} ) - h ( ( 1 - γ ) {q}_{\text{?}} + {q}_{e} ) + ( 1 - γ ) [ {q}_{r} {log}_{2} ( \frac{{μ}_{s}}{4} + {v}_{\text{?}} ) + ( 1 - {q}_{\text{?}} ) {log}_{2} ( \frac{{μ}_{s}}{4} - {v}_{s} ) ] ]} . \qquad ( 73 )$$

$$\text{?} \text{indicates text missing or illegible when filed}$$

Defining α₁ and α₂ as

$${α}_{1} = γ h ( {q}_{e} ) + ( 1 - γ ) h ( {q}_{r} ) - h ( ( 1 - γ ) {q}_{r} + γ {q}_{e} ) \qquad ( 74 )$$

$${α}_{1} = {q}_{r} {log}_{2} ( \frac{{μ}_{s}}{4} + {v}_{s} ) + ( 1 - {q}_{r} ) {log}_{2} ( \frac{{μ}_{s}}{4} - {v}_{s} ) \qquad ( 75 )$$

now directly leads to (48) and completes this proof

### Estimation Results—Part 1

In some implementations, the estimation results may provide a proof of principle that the error of the final key produced by the proposed extractor functions can be made small e.g., smaller than 2⁻¹²⁸, smaller than 2\hat{ }⁻²⁵⁶, or smaller than 2⁻⁵¹² (at-least in specific cases). As shown below, when there is a sufficiently high proportion of estimation rounds and the number of experimental rounds gets large, the XOR seedless extractor can output a single final key bit with arbitrarily small error, for any observed violation of the CHSH inequality. Below a comparison is provided between the results for the XOR final key error using the proposed approach and an identical system that is independently distributed (IID), e.g., when these state and measurements implemented at every round are identical and independent.

In order to present the results, in some cases the observed losing frequency qₑ may be related to the observed CHSH value S_{obs}∈(−4, 4) via the relation:

$${s}_{obs} = 4 - 8 qe . \qquad ( 76 )$$

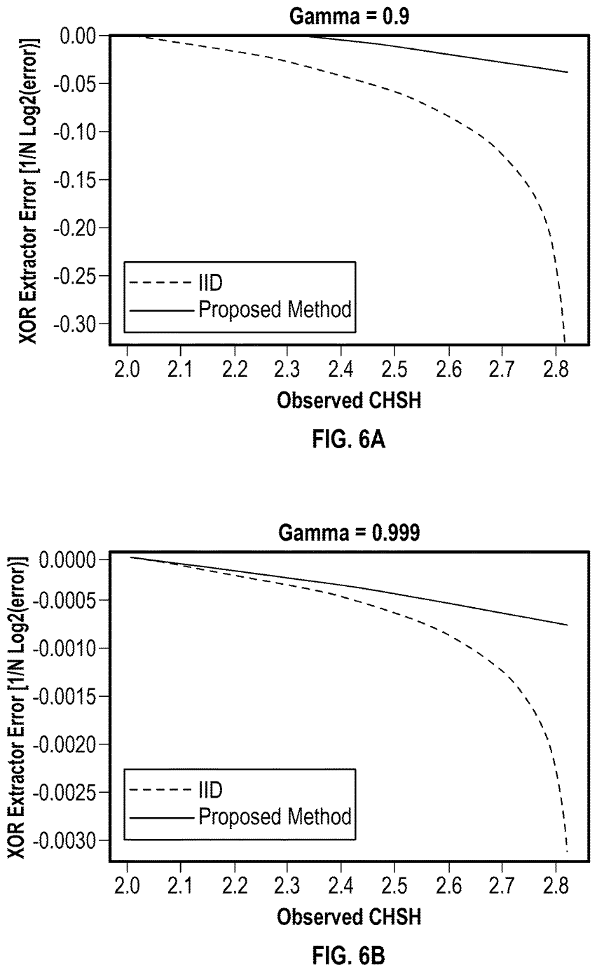

FIGS. 6A-6B are plots showing the extractor error when the XOR seedless extractor is used to output a single bit, as described in (4). The plots show estimated values of the error and I.I.D values of the error (e.g., when the state and measurements implemented at every round are identical and independent), when extracting a single bit using the XOR function described in (4) for different values of the observed CHSH value, when γ=0.9 in (6A), γ=0.999 (6B) and N→∞, using Theorem 6. As the behavior is considered for large N, the region of CHSH violation that quantum correlations can achieve may be plotted (e.g., finite size correction terms may not be considered). The extractor error is given as a single round quantity, i.e. the plotted y values relate to the final key error c through the relation ϵ=2^{N}^{_{y}}. FIG. 6A in particular shows that, given the proportion of estimation rounds is sufficiently high and N is sufficiently large so that the polynomial terms do not impact the results, the final key bit can have an error that is arbitrarily small for any observed CHSH violation (i.e. s_{obs}∈(2, 2\sqrt{2})). This shows that the tools and theorems described herein can be used to implement seedless extraction on currently existing or commercially available quantum hardware. In some cases, it is possible to evaluate the rates for some or all explicit seedless extractors described above.

### Discussion of Relevant Results

The methods and the corresponding mathematical relations described above may provide simple, deterministic functions to perform seed-less randomness extraction (privacy amplification) in a general framework applicable to a wide-variety of DI quantum cryptography protocols, e.g., in the presence of a computationally unbounded quantum adversary. Further the disclosed framework, can provide several explicit constructions of computationally efficient (with O(nᵣ) and O(nᵣ log(nᵣ)) computational cost) seedless extractors based on the repetition and primitive narrow-sense BCH error correcting codes. In some cases, estimation of products of Bell operators may indicate that the disclosed methods can be used to prove that the final key error of the seedless XOR extractor can be made arbitrarily small for any violation of the CHSH inequality. The protocols and methods described above may provide tools and theorems for implementing implement seedless randomness extractors on existing quantum hardware and based on existing quantum computation resources.

The disclosed approach can be based on the fundamental relation between Bell inequality violation, the unpredictability of their local measurement outcomes, and the monogomy of entanglement. One of the main observations is that Bell inequality violation of a raw key may be used as extractor promise, instead of its min-entropy. The inventors have implemented seedless extractors by exploiting the fact that certain functions allow for sufficient cancellation of operators when considering all the inputs that map to the same output, and that these operators can be bound by a family of Bell operator inequalities. These facts may be used to provide a construction for optimal rate seedless extractors and prove a condition for linear (i.e. computationally efficient) seedless extraction functions. A mathematical relationship is provided between error correction and seedless randomness extraction (also known as seedless privacy amplification).

In some of the methods and protocols described above a family of operator inequalities found in Masanes were used, which rely on the fact that the protocol devices do not have internal memory. However, the devices' behavior may still vary with time (e.g., the measurements at every round may not be identical and the measurement state at every round can be arbitrarily correlated across all rounds), as suggested by the dependence on the indexing subscript i. As such, the results presented in this work can improve on existing (classical) deterministic extraction results.

In some implementations, the seedless extractor may comprise estimating product Bell inequalities using the properties of symmetric distributions. In some cases, the disclosed method may of achieve error terms <<1 for seedless extraction of a single bit from any observed CHSH value between (2, 2\sqrt{2}), demonstrating that our technique is fully robust in the asymptotic limit (e.g., as n-approaches infinity and CHSH value (Bell value) may approach 2), we can still extract a single bit with error close to 0. Although our results using symmetric distributions may be interesting independent of this work, in some cases, this approach for estimation may not be optimal. In some embodiments, some of the steps in the disclosed proofs may use uniform random bits as inputs in the estimation rounds.

Seedless Extraction with Randomized Functions

### Proof of Theorem 2

Consider the function k=g(a) such that each a∈{0,1}ⁿ^{ᵣ} maps to a k∈{0, 1}^{m} chosen at random, forming a lookup table (requiring m2ⁿ^{ᵣ} random bits to construct³). Let aᵢ and kᵢ denote each possible input and output, indexed with i=1, . . . 2ⁿ^{ᵣ}. The function g can be written as

$$g ( {a}_{i} ) = {k}_{i} . \qquad ( A1 )$$

Proof. Starting by substituting (5) in state (12) and expanding the product Πᵢ( [symbol] ᵢ+(−1)^{a}^{ᵢ}A₀_{₁}) into 2ⁿ^{ᵣ} terms labelled by the vectors r∈{0, 1}ⁿ,

$${ρ𝒦ℰ = {\sum }_{k , a} \vert k 〉 〈 k \vert}_{𝒦} {δ}_{g ( a )}^{k} tr 𝒜 [ ρ𝒜ℰ {\prod }_{i} \frac{1}{2} ( {𝕀}_{i} + {( - 1 )}^{{a}_{i}} {A}_{{0}_{i}} ) ] \qquad ( A2 )$$

$${= {\sum }_{k , a} \vert k 〉 〈 k \vert}_{𝒦} {δ}_{g ( a )}^{k} tr 𝒜 [ {ρ𝒜ℰ2}^{- {n}_{r}} {\sum }_{r} {\prod }_{i} {( - 1 )}^{{a}_{i} {r}_{i}} {( {A}_{{0}_{i}} )}^{{r}_{i}} ] , \qquad ( A3 )$$

where the identities (Aₐ_{ᵢ})⁰= [symbol] ᵢ and (Aₐ_{ᵢ})=Aₐ_{ᵢ} are used for full-rank operators. Next, Lemma 7 is used to assume that g is such that |g⁻¹(k)|=2ⁿ^{ᵣ}^{-m} for all k and consider the summation that depends on a of (A3). Using Lemma 8 and ƒₖ=\sqrt{2ⁿ^{ᵣ}^{-m+1}} for all k, this summation can be upper bounded by

$${\sum }_{a} {{δ}_{g ( a )}^{k} ( - 1 )}^{a \cdot r} \leq \sqrt{{2}^{{n}_{r} - m + 1}} \qquad ( A4 )$$

Since 2ⁿ^{ᵣ}^{-m+1}≤|g⁻¹(k)|=2ⁿ^{ᵣ}^{-m}, for all r≠0. Given |g⁻¹(k)|=2ⁿ^{ᵣ}^{-m} for all k, the state ρκε can be rewritten as:

$${ρ𝒦ℰ = {\sum }_{k , a} \vert k 〉 〈 k \vert}_{𝒦} ( {2}^{- m} ρℰ + tr 𝒜 [ {ρ𝒜ℰ2}^{- {n}_{r}} {\sum }_{r \neq 0} {( - 1 )}^{a \cdot r} {δ}_{g ( a )}^{k} {\prod }_{i} {A}_{{0}_{i}}^{{r}_{i}} ] ) . \qquad ( A5 )$$

Next, (A5) may be used in the trace norm and evaluate it using the bound in (A4).

$$‖ ρ𝒦ℰ - 𝓊𝒦ρℰ ‖ = {\sum }_{k} ‖ tr 𝒜 [ {ρ𝒜ℰ2}^{- {n}_{r}} {\sum }_{r \neq 0} {\sum }_{a} {{δ}_{g ( a )}^{k} ( - 1 )}^{a \cdot r} {\prod }_{i} {A}_{{0}_{i}}^{{r}_{i}} ] ‖ \qquad ( A6 )$$

$$\leq {\sum }_{k} \sqrt{{2}^{- {n}_{r} - m + 1}} ‖ tr 𝒜 [ ρ𝒜ℰ {\sum }_{r \neq 0} {\prod }_{i} {A}_{{0}_{i}}^{{r}_{i}} ] ‖ \qquad ( A7 )$$

$$= \sqrt{{2}^{- {n}_{r} + m + 1}} ‖ tr 𝒜 [ ρ𝒜ℰ {\sum }_{r \neq 0} {\prod }_{i} {A}_{{0}_{i}}^{{r}_{i}} ] ‖ . \qquad ( A8 )$$

Using the steps as in the proof for Lemma 3 leads to (15), completing the proof ³ It should be noted that, although this construction may use random bits to generate the function, these bits are not the same as a seed in seeded randomness extraction. Here, the random bits may be known to all protocol participants, including the adversary, prior to the commencement of the protocol. In contrast, a seed can may be known to the adversary after the protocol has begun (i.e. the devices can't be built conditioned on the seed) and if the seeded extractor is strong.

Lemma 7. There exists a function of the form (A1) such that

$$\vert {g}^{- 1} ( k ) \vert = {2}^{{n}_{r} - m} ∀ k \qquad ( A9 )$$

where |g¹(k)| denotes the amount of inputs that map to a particular output k.

Proof. For a particular k

$$P ( \vert {g}^{- 1} ( k ) \vert = {2}^{{n}_{r} - m} ) = ( \begin{matrix}{2}^{{n}_{r}} \\ {2}^{{n}_{r} - m}\end{matrix} ) {( {2}^{- m} )}^{{2}^{{n}_{r} - m}} ( 1 - {2}^{- m} ) {2}^{{n}_{r} - ( {2}^{{n}_{r} - m )}} \qquad ( A10 )$$

$$> 0. \qquad ( A11 )$$

Since there are 2^{m} possible values for k, this may be multiplied 2^{m} times, but the strict inequality may still hold.

Lemma 8. There exists a function of the form (A1) and a function ƒ(nᵣ, m) such that

$${\sum }_{a} {{δ}_{g ( a )}^{k} ( - 1 )}^{a \cdot r} \leq {f}_{k} ( {n}_{r} , m ) \qquad ( A12 )$$

For all r≠0, k if (ƒₖ(nᵣ,m))²≥|g⁻¹(k)|.

Proof. Consider the case r≠0, and a∈g⁻¹(k) for some particular k. Then, by the construction of the function in (A1),

$$P ( {( - 1 )}^{a \cdot r} = 1 ) = P ( {( - 1 )}^{a \cdot r} = - 1 ) = \frac{1}{2} \qquad ( A13 )$$

which means that the summation in (A12) is a random walk with |g⁻¹(k)| steps. Therefore, it is a random variable with mean 0 and variance |g⁻¹(k)|. Now, using Chebyshev's inequality, which states for a random variable X with mean and variance σ² and a constant c>0,

$$P ( \vert X - μ \vert \geq c ) \leq \frac{{σ}^{2}}{c} . \qquad ( A14 )$$

Applying this to our setting leads to

$$P ( {\sum }_{a} {{δ}_{g ( a )}^{k} ( - 1 )}^{a \cdot r} \geq {f}_{k} ( {n}_{r} , m ) ) < \frac{\vert {g}^{- 1} ( k ) \vert}{{( {f}_{k} ( {n}_{r} , m ) )}^{2}} \qquad ( A15 )$$

which implies (A12).

### Linear Functions as Seedless Extractors

BCH Generator Polynomial n=15

The coefficients c₀, c₁, . . . c₂ₜ that define the generator matrix of BCH codes are given by the generator polynomial φ(x)=c₀+c₁ₓ+ . . . +c₂ₜx^{2t}. To find φ(x), let [symbol] (2^{2t}) denote the Galois (or finite) field which contains all polynomials of at most degree 2t, with coefficients in [symbol] ₂. Define α as a primitive element (in the sense that it generates the multiplicative group of the field) of [symbol] (2^{2t}) and define the minimal polynomials (in the sense they are irreducible over [symbol] (2^{l}) with respect to α) lᵢ(x) for each xⁱ, i=1, . . . 2t. Then the generator polynomial is φ(x)=1 cm(l₁(x), . . . l₂ₜ(x))=c₀+c₁ₓ+ . . . +c₂ₜx^{2t} with cᵢ∈ [symbol] ₂ for all i=0, . . . 2t.

Consider the primitive narrow sense BCH code over [symbol] (2⁴), where n=15 and use the primitive element α=1+x+x⁴. The set of lᵢ(x) are:

$${l}_{1} ( x ) = {l}_{2} ( x ) = {l}_{4} ( x ) = {l}_{8} ( x ) = 1 + x + {x}^{4} \qquad ( B1 )$$

$${l}_{3} ( x ) = {l}_{6} ( x ) = {l}_{9} ( x ) = {l}_{12} ( x ) = 1 + x + {x}^{2} + {x}^{3} + {x}^{4} \qquad ( B2 )$$

$${l}_{5} ( x ) = {l}_{10} ( x ) = 1 + x + {x}^{2} \qquad ( B3 )$$

$${l}_{7} ( x ) = {l}_{11} ( x ) = {l}_{13} ( x ) = {l}_{14} ( x ) = 1 + {x}^{3} + {x}^{4} , \qquad ( B4 )$$

which allows the explicit constructive of different distance BCH codes. The BCH codes with minimum distance 2, 3 (i.e. t=1) have the generator polynomial φ(x)=1 cm(lᵢ(x), l₂(x))=l₁(x) =1+x+x⁴. For distance 4, 5: φ(x)=1 cm(l₁(x), l₂(x), l₃(x), l₄(x))=1 cm(l₁(x), l₃(x))=1+x⁴+x⁶+x⁷+x⁸. Using the same technique, for distance 6, 7: φ(x)=1+x²+x⁴+x⁵+x⁸+x¹⁰ and

$$d = 8 , 9 , 10 , … 15 ϕ ( x ) = 1 + {\sum }_{i = 1}^{14} {x}^{i} .$$

### Chernoff Bound for Gaussians

Lemma 9. Let X be a Gaussian random variable with mean μ and variance σ², denotes X~ [symbol] (μ, σ²). Then

$$P ( X \geq μ + δ ) \leq exp ( \frac{- {δ}^{2}}{2 {σ}^{2}} ) \qquad ( C1 )$$

for all δ>0.

Proof. The Chernoff bound states for some random variable X with mean μ,

$$P ( X \geq μ + δ ) \leq exp ( - {sup}_{λ} [ λδ - log 𝔼 ( {ϵ}^{λ ( X - μ )} ) ] ) \qquad ( C2 )$$

for λ>0. Using the fact that X is a Gaussian, the expression in the exponential can be rewritten as:

$${sup}_{λ} [ λδ - log 𝔼 ( {e}^{λ ( X - μ )} ) ] = {sup}_{λ} [ λδ - \frac{{λ}^{2} {σ}^{2}}{2} ] \qquad ( C3 )$$

$$= \frac{{δ}^{2}}{2 {σ}^{2}} \cdot \qquad ( C4 )$$

Combining (C4) and (C2) implies (C1).

### Device-Independent Seedless Extractors: Results Part-2

In this section the relationship between Bell-inequality violation and randomness are revisited along with some of the notation definitions. Further, proof of two theorems on seedless extraction are presented.

### Randomness and Violation of Bell Inequalities

With reference to FIG. 4, suppose Alice has a quantum system with Hilbert space [symbol] , which can be measured with two observables labelled by x∈{0, 1} with outcomes a∈{0, 1} represented by the POVM elements A(a|x). Analogously, Bob has a system [symbol] and two observables y∈{0, 1} with outcomes b∈{0, 1} and POVMs B(b|y). The joint state of [symbol] ⊗ [symbol] is denoted by [symbol] . With this notation the CHSH inequality can be written as:

$$CHSH = {\sum }_{x , y , a , b = 0}^{1} tr [ ρ𝒜ℬA ( a \vert x ) B ( b \vert y ) ] {( - 1 )}^{a + b + xy} \leq 2. \qquad ( 77 )$$

When this inequality is violated, then no locally causal model can explain the observed correlations. Note that, in the presented notation, operator A(a|x) is meant to act trivially on [symbol] , so A(a|x)B(b|y) can be rewritten instead of A(a|x)(B(b|y).

The predictability of outcome a when measuring x can be quantified by the bias of the probability distribution of a in the following sense:

$$\vert P ( a = 0 \vert x ) - P ( a = 1 \vert x ) \vert = \vert tr ( ρ𝒜ℬ [ A ( 0 \vert x ) - A ( 1 \vert x ) ] ) \vert . \qquad ( 78 )$$

The following previously proven theorem indicate that the outcome a can be less predictable when the CHSH violation is stronger. In other words, the predictability of outcome a decreases as the CHSH inequality is violated by larger amounts (e.g., a Bell value is larger).

Theorem 7. For any air of Hilbert spaces [symbol] and measurements {A(0|x), A(1|x)} on [symbol] and {B(0|y), B(1|y)} on [symbol] , the shifted CHSH operator can be defined as:

$$S = {μ}_{s} \text{?} - {v}_{s} {\sum }_{x , y , a , b = 0}^{1} A ( a \vert x ) B ( b \vert y ) {( - 1 )}^{a + b + xy} ; \qquad ( 79 )$$

with coefficients

$${μ}_{s} = 2 {( 2 - \frac{{s}^{2}}{4} )}^{- 1 / 2} , {v}_{s} = \frac{s}{4} {( 2 - \frac{{s}^{2}}{4} )}^{- 1 / 2} . \qquad ( 80 )$$

The following two semi-definite inequalities

$$\pm [ A ( 0 \vert 0 ) - A ( 1 \vert 0 ) ] \leq S , \qquad ( 81 )$$

hold for all s∈[2, 2\sqrt{2}].

The shifted CHSH operator (79), contains the CHSH expression (1), with a negative coefficient. Therefore, inequality (81) may imply that the larger the CHSH violation the smaller the predictability:

$$\vert tr ( ρ𝒜ℬ [ A ( 0 \vert 0 ) - A ( 1 \vert 0 ) ] ) \vert \leq tr ( ρ𝒜ℬS ) . \qquad ( 82 )$$

This fact and its generalizations can be the essence of DI quantum cryptography, and it is crucial for the results of this section.

### Universally-Composable Security

The process for generating the raw key a=(a1, . . . , aₙ) consists of nᵣ rounds labelled by i∈{1, . . . , nᵣ}. In round i Alice performs the measurement {Aᵢ(0|0), Aᵢ(1|0)}on the system with Hilbert space Aᵢ, and obtains the outcome aᵢ. Analogously, for each round i Bob has a system with Hilbert space Bᵢ, although our protocol may not require Bob to make measurements for generating the raw key. The adversary (Eve) holds an arbitrary quantum system with Hilbert space ε. As described above the notation

$${𝒜}_{r} = {⊗}_{i = 1}^{{n}_{r}} {𝒜}_{i} and {ℬ}_{r} = {⊗}_{i = 1}^{{n}_{r}} {ℬ}_{i}$$

can be used with the understanding that the action of Aᵢ(a|x) on [symbol] ⊗ [symbol] is trivial on all factors but [symbol] ᵢ. The factorization of the total Hilbert space [symbol] ᵣ⊗ [symbol] ᵣ⊗ε enforces the assumption of no-signaling between Alice, Bob and Eve. Additionally, the fact that every round i is modeled with a different Hilbert space [symbol] ᵢÐ [symbol] ᵢ enforces the assumption that devices have no memory. The global state shared among Alice, Bob and Eve is [symbol] and the reduced state of Alice and Eve is [symbol] . The secret key k=(k₁, . . . , kₘ)∈{0, 1}^{m} is produced by applying the (deterministic) function g: {0,1}ⁿ^{ᵣ}→{0, 1}^{m} to the raw key a→k=g(a). In the following sections the functions g is characterized. Although the secret key k is a classical system, it is convenient to associate it Hilbert space K= [symbol] ²^{^{m}} and to represent its values by an orthonormal basis |k [symbol] ∈K. After Alice measures all her systems Aᵢ and generates the secret key K, the joint state of systems K⊗ε is

$$ρ𝒦ℰ = {\sum }_{k ∈ {\{ 0 , 1 \}}^{m}} {\sum }_{a ∈ {\{ 0 , 1 \}}^{{n}_{r}}} \vert k 〉 〈 k \vert {𝒦δ}_{g ( a )}^{k} tr {𝒜}_{r} [ {ρ𝒜}_{r} ℰ {\prod }_{i = 1}^{{n}_{r}} {A}_{i} ( {a}_{i} \vert 0 ) ] . \qquad ( 83 )$$

The goal of Alice and Bob is to produce a state [symbol] that is indistinguishable from an ideal secret key [symbol] , In some cases, the uniform state (sometimes called maximally mixed) may be defined as:

$$𝓊𝒦 = {2}^{- m} {\sum }_{k ∈ {\{ 0 , 1 \}}^{m}} \vert k 〉 〈 k \vert 𝒦 . \qquad ( 84 )$$

This indistinguishability can be formalized as a bound on the trace norm

$${‖ ρ𝒦ℰ - 𝓊𝒦ρℰ ‖}_{1} \leq ϵ , \qquad ( 85 )$$

which is defined as ∥M∥₁=tr\sqrt{M^{†}M} for any operator M. The bound in (85) implies that any cryptographic task which requires an ideal secret key [symbol] as a resource, is also secure when it is fed with the secret key [symbol] x, up to an error of probability E. Hence, the disclosed seedless extraction protocol can be composed with any other cryptographic protocol: it is universally composable.

### XOR as a Seedless Extractor

The XOR function allows to extract a single bit k∈{0, 1} with an error that can be made exponentially small in nᵣ. The computational cost of XOR is O(nᵣ), which is the smallest possible. This shows that seedless extractors need not be hard to implement.

Theorem 8 (XOR). After measuring the nᵣ-round state is [symbol] , with the observables {A(aᵢ|0): aᵢ=0, 1} for all rounds i=1, . . . , nᵣ and applying the XOR function

$$g ( a ) = {\sum }_{i = 1}^{{n}_{r}} {a}_{i} mod 2 ∈ \{ 0 , 1 \} \qquad ( 86 )$$

to the outcomes k=g(a₁, . . . , aₙ_{ᵣ}), the resulting state ρκε written in (83) satisfies

$${‖ ρ𝒦ℰ - 𝓊𝒦ρℰ ‖}_{1} \leq tr [ {ρ𝒜}_{r} {ℬ}_{r} {\prod }_{i = 1}^{{n}_{r}} {S}_{i} ] , \qquad ( 87 )$$

For all s∈[2, 2, \sqrt{2}].

The above result shows that, the larger the violation of CHSH (Bell value), the smaller the expectation of ΠᵢSᵢ, and the smaller the distance between the real and the ideal secret keys.

Proof. The following operators may be defined:

$${C}_{i} = {A}_{i} ( 0 \vert 0 ) - {A}_{i} ( 1 \vert 0 ) , \qquad ( 88 )$$

and noting that

$${A}_{i} ( {a}_{i} \vert 0 ) = \frac{1}{2} ( \text{?} + {( - 1 )}^{{a}_{i}} {C}_{i} ) . \qquad ( 89 )$$

It can be shown, there is no loss of generality in assuming that the operators Aᵢ(aᵢ|0) are projectors, which implies that Cᵢ is full-rank.

Next, (89) may be substituted into the joint state after Alice generates the secret key (83) and expand the product Πᵢ (1+(−1)^{a}^{ᵢ}Cᵢ) into 2ⁿ^{ᵣ} terms labelled by the vectors r∈{0,1}ⁿ^{ᵣ},

$${ρ}_{𝒦ℰ} = {\sum }_{k , a} \vert k 〉 〈 k {\vert}_{𝒦} {δ}_{g ( a )}^{k} {tr}_{{𝒜}_{r}} [ {ρ}_{{𝒜}_{r} ℰ} {\prod }_{i} \frac{1}{2} ( \text{?} + {( - 1 )}^{{a}_{i}} {C}_{i} ) ] = {\sum }_{k , a} \vert k 〉 〈 k {\vert}_{𝒦} {δ}_{g ( a )}^{k} {tr}_{{𝒜}_{r}} [ {ρ}_{{𝒜}_{r} ℰ} {2}^{- {n}_{r}} {\sum }_{r} {\prod }_{i} {( - 1 )}^{{a}_{i} {r}_{i}} {C}_{i}^{{r}_{i}} ] , \qquad ( 90 )$$

where the power identities

$${C}_{i}^{0} = 1 and {C}_{i}^{1} = {C}_{i}$$

have been used for full-rank operators. Next, the XOR function may be rewritten as a scalar product g(a)=a·1 mod 2 with the vector 1=(1, . . . , 1). This allows us to write the Kronecker delta as

$${δ}_{g ( a )}^{k} = \frac{1}{2} [ 1 + {( - 1 )}^{a \cdot 1 + k} ] , \qquad ( 91 )$$

and perform the summation

$${2}^{- {n}_{r}} {\sum }_{a} {{δ}_{g ( a )}^{k} ( - 1 )}^{a \cdot r} = {2}^{- {n}_{r} - 1} {\sum }_{a} [ {( - 1 )}^{a \cdot r} + {( - 1 )}^{a \cdot ( r - 1 ) + k} ] = {2}^{- 1} [ {δ}_{r}^{0} + {( - 1 )}^{k} {δ}_{r}^{1} ] , \qquad ( 92 )$$

where 0=(0, . . . , 0). Substituting (92) into the state (70) gives

$${ρ}_{𝒦ℰ} = {\sum }_{k} \frac{1}{2} \vert k 〉 〈 k {\vert}_{𝒦} ( {ρ}_{ℰ} + {( - 1 )}^{k} {tr}_{{𝒜}_{r}} [ {ρ}_{{𝒜}_{r} ℰ} {\prod }_{i} {C}_{i} ] ) , \qquad ( 93 )$$

which then can be used in the trace norm yielding

$${‖ {ρ}_{𝒦ℰ} - {u}_{𝒦} {ρ}_{ℰ} ‖}_{1} = {\sum }_{k} \frac{1}{2} {‖ {( - 1 )}^{k} {tr}_{{𝒜}_{r}} ( {ρ}_{{𝒜}_{r} ℰ} {\prod }_{i} {C}_{i} ) ‖}_{1} = {‖ {tr}_{{𝒜}_{r}} ( {p}_{{𝒜}_{r} ℰ} {\prod }_{i} {C}_{i} ) ‖}_{1} \qquad ( 94 )$$

For any Hermitian operator X, its trace norm satisfies ∥X∥₁=max_{H} tr(H X), where H is constrained to be Hermitian and have eigenvalues ±1. Therefore, there is an Hermitian operator H acting on ε, with spectrum ±1, which satisfies

$${‖ {tr}_{{𝒜}_{r}} ( {ρ}_{{𝒜}_{r} ℰ} {\prod }_{i} {C}_{i} ) ‖}_{1} = tr ( {ρ}_{{𝒜}_{r} ℰ} [ ( {\prod }_{i} {C}_{i} ) H ] ) . \qquad ( 95 )$$

The spectral decomposition can be written as H=H₊−H₋ with some projectors H_{±} on ε and obtain:

$${‖ tr ( {ρ}_{{𝒜}_{r} ℰ} {\prod }_{1} {C}_{i} ) ‖}_{i} = tr ( {ρ}_{{𝒜}_{r} ℰ} [ {\prod }_{i} {C}_{i} ] {H}_{+} ) - tr ( {ρ}_{{𝒜}_{r} ℰ} [ {\prod }_{i} {C}_{i} ] {H}_{-} ) . \qquad ( 96 )$$

In some cases, Theorem 7, can be written as ±Cᵢ≤Sᵢ. Note that here, operator Cᵢ may act (e.g., may act trivially) on Bᵢ while Sᵢ may not. Using Lemma 11, Theorem 7 may be generalized to ±ΠᵢCᵢ≤ΠᵢSᵢ, which implies ±[ΠᵢCᵢ]H_{±}≤[ΠᵢSᵢ]H_{±} and

$$\pm tr ( {ρ}_{{𝒜}_{r} ℰ} [ {\prod }_{i} {C}_{i} ] {H}_{\pm } ) \leq tr ( {ρ}_{{𝒜}_{r} {ℬ}_{r} ℰ} [ {\prod }_{i} {S}_{i} ] {H}_{\pm } ) . \qquad ( 97 )$$

Substituting this in (96) and using the fact that H₊+H₋=1, the equality below may be obtained:

$${‖ {tr}_{{𝒜}_{r}} ( {ρ}_{{𝒜}_{r} ℰ} {\prod }_{i} {C}_{i} \} ‖}_{1} \leq tr ( {ρ}_{{𝒜}_{r} {ℬ}_{r}} {\prod }_{i} {S}_{i} ) , \qquad ( 98 )$$

which concludes the proof
Seedless Extractors with Arbitrary Output

In this section seedless extractors are analyzed which may produce a key k of arbitrary length m. Some of the proofs can be based on randomized methods, so, in some cases, explicit constructions may not be obtained, and the resulting extractors may be computationally hard to implement. In some embodiments, certain linear functions can be seedless extractors, and can be implemented in time O(nᵣ log nᵣ). The following lemma is proven under section heading Proofs of Lemmas 10 and 11.

Lemma 10. There are functions g: {0,1}ⁿ^{ᵣ}→{0, 1}^{m} satisfying

$${\sum }_{a} {δ}_{g ( a )}^{k} = {2}^{{n}_{r} - m} , \qquad ( 99 )$$

$$\vert {\sum }_{a} {{δ}_{g ( a )}^{k} ( - 1 )}^{a \cdot r} \vert \leq \sqrt{{2}^{{n}_{r} - m + 1}} , \qquad ( 100 )$$

for all k∈{0, 1}^{m} and all non-zero r∈{0,1}ⁿ^{ᵣ}. Such functions may be referred to as balanced.

Theorem 9. Let g: {0,1}ⁿ^{ᵣ}→{0, 1}^{m} be a balanced function, satisfying the conditions in (23) and (24). After measuring the nᵣ-round state [symbol] with the observables {Aᵢ(aᵢ|0): aᵢ=0, 1} for all i=1, . . . , nᵣ and applying the function k=g(a) to the outcomes a=(a₁, . . . , aₙ_{ᵣ}), the resulting state [symbol] written in (83) satisfies

$${‖ {ρ}_{𝒦ℰ} - {u}_{𝒦} {ρ}_{ℰ} ‖}_{1} \leq \sqrt{{2}^{m - {n}_{r} + 1}} ( tr [ {ρ}_{{𝒜}_{r} {ℬ}_{r}} {\prod }_{i = 1}^{{n}_{r}} ( \text{?} + {S}_{i} ) ] - 1 ) , \qquad ( 101 )$$

for all s∈[2, 2, \sqrt{2}].

The above result shows that, the larger the violation of CHSH, the smaller the expectation of Πᵢ(1+Sᵢ), and the smaller the distance between the real and the ideal secret keys, (101). When this distance is fixed to a specific safety value ∥ρκε−uκ_{ρ}ε∥=ϵ, then the larger the violation of CHSH (Bell value), the larger the length m of the key.

Proof. In some cases, substituting (89) in the joint state after Alice generates the secret key in (83) and expanding the product into Πᵢ(1+(−1)^{a}^{ᵢ}Cᵢ) into 2ⁿ^{ᵣ} terms labelled by the vectors r∈{0,1}ⁿ^{ᵣ},

$${ρ}_{𝒦ℰ} = {\sum }_{k , a} \vert k 〉 〈 k {\vert}_{𝒦} {δ}_{g , ( a )}^{k} {tr}_{{𝒜}_{r}} [ {ρ}_{{𝒜}_{r} ℰ} {\prod }_{i} \frac{1}{2} ( \text{?} + {( - 1 )}^{{a}_{i}} {C}_{i} ) ] = {\sum }_{k , a} \vert k 〉 〈 k {\vert}_{𝒦} {δ}_{g ( a )}^{k} t {r}_{{𝒜}_{r}} [ {ρ}_{{𝒜}_{r} ℰ} {2}^{- {n}_{r}} {\sum }_{r} {\prod }_{i} {( - 1 )}^{{a}_{i} {r}_{i}} {C}_{i}^{{r}_{i}} ] , \qquad ( 102 )$$

Where the power identities

$${C}_{i}^{0} = 1 and {C}_{i}^{1} = {C}_{i}$$

have been used for full-rank operators. Next, the terms r=0 and r≠0 are separated, the promise in (99) is used, to arrive at:

$${ρ}_{𝒦ℰ} = {\sum }_{k} \vert k 〉 〈 k {\vert}_{𝒦} ( {2}^{- m} {ρ}_{ℰ} + {{tr}_{𝒜}}_{r} [ {ρ}_{{𝒜}_{r} ℰ} {2}^{- {n}_{r}} {\sum }_{r \neq 0} {\sum }_{a} {{δ}_{g ( a )}^{k} ( - 1 )}^{a \cdot r} {\prod }_{i} {C}_{i}^{{r}_{i}} ) . \qquad ( 103 )$$

By substituting this in the left-hand side of (101), and applying the triangular inequality and the promise in (100), it can be shown:

$${\vert {ρ}_{𝒦ℰ} - {u}_{𝒦} {ρ}_{ℰ} ‖}_{1} = {2}^{- {n}_{\text{?}}} {\sum }_{k} {‖ {\sum }_{r \neq 0} {\sum }_{a} {{δ}_{g ( a )}^{k} ( - 1 )}^{a \cdot r} {tr}_{{𝒜}_{\text{?}}} [ {ρ}_{{𝒜}_{\text{?}} ℰ} {\prod }_{i} {C}_{i}^{{r}_{i}} ] ‖}_{1} \leq {2}^{- {n}_{\text{?}}} {\sum }_{k} {\sum }_{r \neq 0} \vert {\sum }_{a} {{δ}_{g ( a )}^{k} ( - 1 )}^{a \cdot r} \vert {‖ {tr}_{{𝒜}_{\text{?}}} [ {ρ}_{{𝒜}_{\text{?}} ℰ} {\prod }_{i} {C}_{i}^{{r}_{i}} ] ‖}_{1} \leq {2}^{- {n}_{r}} {\sum }_{k} {\sum }_{r \neq 0} \sqrt{{2}^{{n}_{\text{?}} - m + 1}} {‖ {tr}_{{𝒜}_{\text{?}}} [ {ρ}_{{𝒜}_{\text{?}} ℰ} {\prod }_{i} {C}_{i}^{{r}_{i}} ] ‖}_{1} = \sqrt{{2}^{m - {n}_{\text{?}} + 1}} {\sum }_{r \neq 0} {‖ {tr}_{{𝒜}_{\text{?}}} [ {ρ}_{{𝒜}_{\text{?}} ℰ} {\prod }_{i} {C}_{i}^{{r}_{i}} ] ‖}_{1} . \qquad ( 104 )$$

$$\text{?} \text{indicates text missing or illegible when filed}$$

Following the same steps as in the proof of Theorem 8: there are two complementary projectors H_{±} acting on ε such that:

$${‖ tr ( {ρ}_{{𝒜}_{\text{?}} ℰ} [ {\prod }_{i} {C}_{i}^{{r}_{i}} ‖}_{1} = tr ( {ρ}_{{𝒜}_{r} ℰ} [ {\prod }_{i} {C}_{i}^{{r}_{\text{?}}} ] {H}_{+} ) - tr ( {ρ}_{{𝒜}_{\text{?}} ℰ} [ {\prod }_{i} {C}_{i}^{{r}_{i}} ] {H}_{-} ) . \qquad ( 105 )$$

$$\text{?} \text{indicates text missing or illegible when filed}$$

Using Lemma 11, Theorem 7 can be generalized to:

$$\pm {\prod }_{i} {C}_{i}^{{r}_{i}} \underline{<} {\prod }_{i} {S}_{i}^{{r}_{i}} , \qquad ( 106 )$$

for any vector r, which in turn implies

$$\pm t r ( {ρ}_{{𝒜}_{r} ℰ} [ {\prod }_{i} {C}_{i}^{{r}_{i}} ] {H}_{\pm } ) \leq tr ( {ρ}_{{𝒜}_{r} {ℬ}_{r} ℰ} [ {\prod }_{i} {S}_{i}^{{r}_{i}} ] {H}_{\pm } ) . \qquad ( 107 )$$

Substituting this in (105) and using the fact that H₊+H₋=1, it can be shown:

$${‖ {tr}_{{𝒜}_{r}} ( {ρ}_{{𝒜}_{r} ℰ} {\prod }_{í} {C}_{i}^{{r}_{i}} ) ‖}_{1} \leq tr ( {ρ}_{{𝒜}_{r} {ℬ}_{r}} {\prod }_{i} {S}_{i}^{{r}_{i}} ) . \qquad ( 108 )$$

Substituting the above in (104) may provide:

$${‖ {ρ}_{𝒦ℰ} - {u}_{𝒦} {ρ}_{ℰ} ‖}_{1} \leq \sqrt{{2}^{m - {n}_{\text{?}} + 1}} {\sum }_{r \neq 0} tr ( {ρ}_{{𝒜}_{\text{?}} {ℬ}_{\text{?}}} {\prod }_{i} {S}_{i}^{{r}_{i}} ) = \sqrt{{2}^{m - {n}_{\text{?}} + 1}} [ tr ( {ρ}_{{𝒜}_{r} {ℬ}_{r}} {\prod }_{i} [ \text{?} + {S}_{i} ] ) - 1 ] . \qquad ( 109 )$$

$$\text{?} \text{indicates text missing or illegible when filed}$$

That may conclude the proof

### Estimation Results—Part 2

In this section some of the results obtained above are applied to a spot-checking based DI protocol, to show that seedless extractors allow for extraction in the case of arbitrary low CHSH violation and have unity rate in the limit of maximal CHSH violation.

Theorem 8 and Theorem 9 provide a relationship between the error c, the length of the secret key m, and the Bell-inequality violation quantified by [symbol] Πᵢ Sᵢ [symbol] or [symbol] Πᵢ (1+Sᵢ) [symbol] . This Bell-violation quantifier is different than the one used with standard seeded extractors, that is [symbol] ΣᵢSᵢ [symbol] . For large n, the statistical fluctuations of ΣᵢSᵢ are small, which allows us to relate the average [symbol] ΣᵢSᵢ [symbol] to the particular value ΣᵢSᵢ corresponding to the estimation data (aⱼ, bⱼ, xⱼ, yⱼ). Unfortunately, the quantities Π₁ Sᵢ and Πᵢ (1+Sᵢ) appearing in our bounds have strong fluctuations and cannot be bounded with the usual techniques.

In this section a new proof for bounding [symbol] Hᵢ (1+Sᵢ) [symbol] and [symbol] Πᵢ Sᵢ [symbol] with the estimation data is provided. Spot-checking procedure, which is frequently used in DI protocols, is used here resulting in wide applicability of the results. In this proof, rounds may be randomly selected, with some probability, to be used for estimation or key generation. This random selection may limit the malicious behavior of the device.

### 1) Spot-Checking Protocol for XOR Extraction

In what follows, a description of the estimation protocol is provided and it has been shown that XOR seedless extractor may be able to extract a bit with arbitrary small error.

Set parameters: Fix the parameters n, the total number of rounds, pₑ∈(0, 1), the probability of an estimation round and ϵ>0, the tolerable error.

Data generation: For each round l∈{1, . . . , n} repeat the following steps:
1. Generate the random variable tₗ∈{estimation, rawbit} with probabilities pₑ and pᵣ=1−pₑ respectively.
2. If tₗ=estimation then:
   (a) Generate the random variables xₗ,yₗ∈{0, 1} with uniform distribution P(xₗ,yₗ)=¼,
   (b) Perform the bi-local measurement Aₗ(aₗ|xₗ)Bₗ(bₗ|yₗ) with outcomes aₗ, bₗ∈{0, 1},
   (c) Record the variable zₗ=aₗ+bₗ+xₗyₗ mod 2, which will be used to evaluate the CHSH inequality.
3. If tₗ=rawbit then perform the local measurement Aₗ(aₗ|0) and keep the outcome aₗ as part of the raw key.

Data processing: Denote by nₑ∈{0, n} the number of rounds l with tₗ=estimation, assign an index j∈{1, . . . , nₑ} to each of them, and compile the estimation data z=(zₗ . . . , zₙ_{ₑ}). Denote by nᵣ∈{0, n} the number of rounds l with tₗ=rawbit, assign an index i∈{1, . . . , nᵣ} to each of them, and compile the raw key a=(a₁, . . . , aₙ_{ᵣ}). The numbers nₑ, nᵣ are a function of t=(t₁, . . . , tₙ).
1. Calculate the length of the final key as a function of t, z with the formula;

$$m ( t , z ) = \{ \begin{matrix}1 & {max}_{s , {α}_{0} , {α}_{1} , β} {\sum }_{j = 1}^{{n}_{e}} {a}_{{z}_{j}} + ( β - 1 ) {n}_{r} - 2 {log}_{2} ( 1 / ϵ ) \geq 0 \\ 0 & otherwise\end{matrix} , \qquad ( 110 )$$

Where the maximization over the parameters s∈(2,2\sqrt{2}) and α₀, α₁, β∈| is constrained by

$${p}_{r} {\sqrt{2}}^{β - 1} ( {μ}_{s} - {ν}_{s} 4 ) + {p}_{e} {\sqrt{2}}^{{α}_{0}} = 1 , \qquad ( 111 )$$

$${p}_{r} {\sqrt{2}}^{β - 1} ( {μ}_{s} + {ν}_{s} 4 ) + {p}_{e} {\sqrt{2}}^{{α}_{1}} = 1. \qquad ( 112 )$$

2. Generate the secret key k=g(a)∈{0, 1}^{m(t,z)} by applying to the raw key the XOR function g: {0,1}ⁿ^{ᵣ}→{0, 1}^{m(t,z)} defined in (86).

The expression for the extractor output length (110) and subsequent maximization constraints may look unintuitive, but allow us to prove the following theorem. This theorem shows that the above protocol produces a secure secret key and is proven under section heading Proof of Theorem 10 below.

Theorem 10. The above protocol generates a secret key ρ_{K}ε|_{t,z} satisfying the following security condition

$${\sum }_{t ∈ {\{ 0 , 1 \}}^{n}} {\sum }_{z ∈ {\{ 0 , 1 \}}^{{n}_{\text{?}}}} P ( t , z ) {‖ {ρ}_{𝒦ℰ \vert t , z} - {u}_{𝒦 \vert t , z} {ρ}_{ℰ \vert t , z} ‖}_{1} \leq ϵ . \qquad ( 113 )$$

$$\text{?} \text{indicates text missing or illegible when filed}$$

In order to analyze our extractors in the spot-checking protocol presented above, the relative frequency of the estimation outcomes is defined as:

$${q}_{z} = \frac{\vert \{ {z}_{j} = z : j = 1 , … , {n}_{e} \} \vert}{{n}_{e}} , \qquad ( 114 )$$

for z=0, 1. Note that, for any permutation σ of (z₁, z₂, . . . , zₙ_{ₑ}), m(t, σz)=m(t, z), hence m depends on z via q₀, which allows us to write m(t, q₀). This relative frequency is related to the CHSH defined by (77) in the asymptotic limit via

$$CHSH = 4 ( {q}_{0} - {q}_{1} ) = 8 {q}_{0} - 4. \qquad ( 115 )$$

In order to understand the limits of the protocol, the large-n regime and the case may be considered where the error ϵ∈(0, 1) is an arbitrary constant. In this regime, using the secret key length, (110), and the limits pₑ=lim_{n→∞} nₑ/n and pᵣ=lim_{n→∞}nᵣ/n, the minimum CHSH value for which the extraction length is non-vanishing can be rewritten as:

$$C H S {H}_{inf} = inf ( 8 {q}_{0} - 4 ) , \qquad ( 116 )$$

such that

$${lim}_{n \to ∞} \frac{m ( t , {q}_{0} )}{n} > 0. \qquad ( 117 )$$

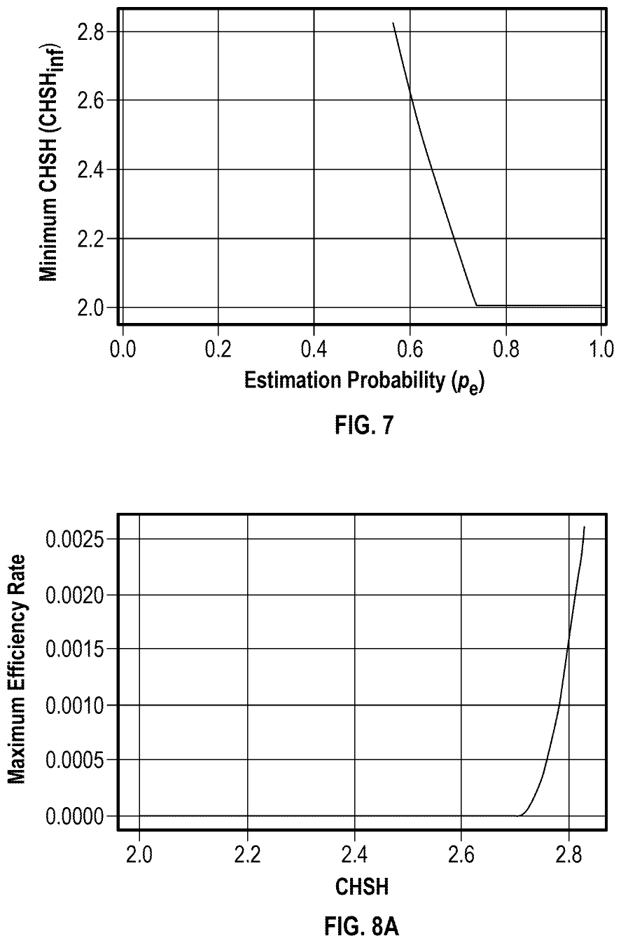

The value of CHSH_{inf} as a function of pₑ is shown in FIG. 7 that is a plot showing the minimum CHSH value in (116) based on which the XOR extractor (presented in Theorem 8) can produce a single bit with arbitrarily small error in the large-n regime. Given a sufficiently large proportion of estimation rounds a single bit can be generated with arbitrarily small error, ϵ, and arbitrary violation of the CHSH inequality in (77) in the large-n regime. Interestingly, as shown by FIG. 7, a necessary requirement for the extraction of a single bit is that pₑ>0.5. In standard protocols, only a logarithmic proportion of estimation rounds is required, evidencing a limitation of our estimation approach.

### 2) Spot-Checking Protocol for Balanced Function Extraction

In what follows, the spot-checking protocol for estimating the error of a balanced function for seedless extraction is presented and the maximum efficiency and extraction rates are calculated. The protocol may follow from the XOR protocol under section heading Spot-checking protocol for XOR extraction, e.g., by replacing the extraction step in the subroutine “DATA PROCESSING” with:
1. Calculate the length of the final key as a function of t, z with the formula

$$m ( t , z ) = ⌊ {max}_{\text{?}} {\sum }_{j = 1}^{\text{?}} {α}_{\text{?}} + {β}_{\text{?}} - 2 {log}_{2} \frac{1}{ϵ} - 1 ⌋ . \qquad ( 118 )$$

$$\text{?} \text{indicates text missing or illegible when filed}$$

where the maximization over the parameters s∈[2, 2, \sqrt{2}] and α₀, a₁, β∈ [symbol] is constrained by

$${p}_{r} {\sqrt{2}}^{β - 1} ( 1 + μ - {ν}_{s} 4 ) + {p}_{e} {\sqrt{2}}^{{α}_{0}} = 1 , \qquad ( 119 )$$

$${p}_{r} {\sqrt{2}}^{β - 1} ( 1 + {μ}_{s} + {ν}_{s} 4 ) + {p}_{e} {\sqrt{2}}^{{α}_{1}} = 1. \qquad ( 120 )$$

2. Generate the secret key k=g(a)∈{0, 1}^{m(t,z)} by applying to the raw key a balanced function g: {0, 1}ⁿ^{ᵣ}→{0, 1}^{m(t,z)}.
   This new protocol satisfies the security condition of Theorem 10, proven below. Using the expression for the secret key length, (118), the efficiency rate R_{eff} and extraction rate Rₑₓₜ can be obtained. The efficiency rate, the number of output bits per round, is given by:

$${ℛ}_{eff} = {lim}_{n \to ∞} \frac{m ( t , z )}{n} = {p}_{e} ( {α}_{0} {q}_{0} + {α}_{1} {q}_{1} ) + β {p}_{r} , \qquad ( 121 )$$

and the extraction rate, the number of output bits per extractor input bit, is given by

$${ℛ}_{ext} = {lim}_{n \to ∞} \frac{m ( t , z )}{{n}_{r}} = \frac{{p}_{e}}{{p}_{r}} ( {α}_{0} {q}_{0} + {α}_{1} {q}_{1} ) + β . \qquad ( 122 )$$

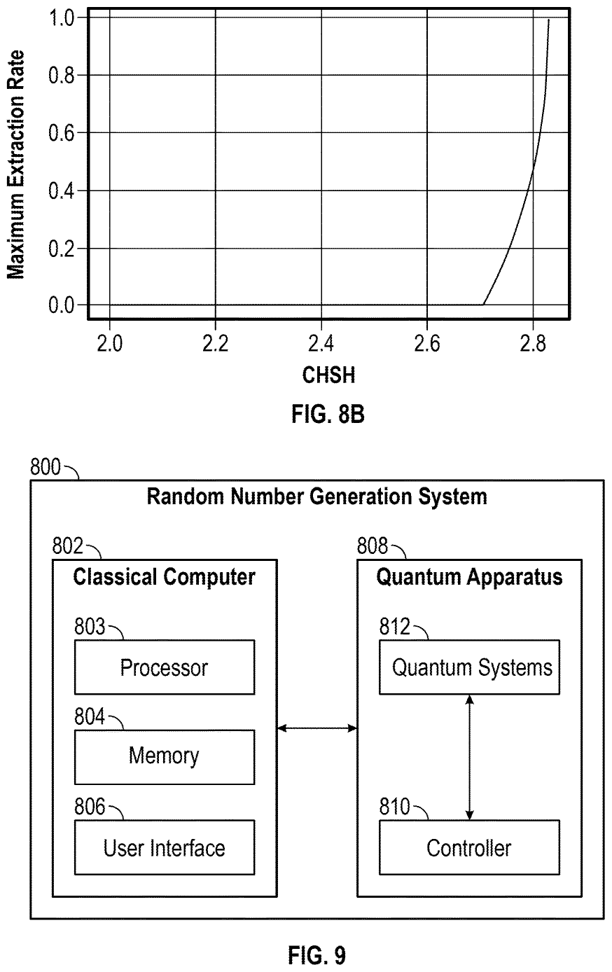

The maximum value of R_{eff} and Rₑₓₜ as a function of CHSH is depicted in FIGS. 8A-8B. The plot in FIG. 8A shows the maximum efficiency rate, R_{eff} defined by (121), for m-bit seedless extractors based on balanced functions, for different values of CHSH=4(q₀−q₁) E (2, 2, \sqrt{2}). The plot in FIG. 8B shows the maximum extraction rate, Rₑₓₜ defined by (122), for different values of CHSH. The maximization is performed over the variables s∈(2, 2, \sqrt{2}), pₑ∈(0, 1) and α₀, α₁, β∈ [symbol] such that constraints (119) and (120) are satisfied. Although the maximum efficiency rates can be low, the maximum extraction rate approaches 1, indicating that the balanced function based seedless extractor performs optimally, at least in the large-n regime and for high CHSH violation (for large Bell values). This also suggests that the estimation procedure may require a significant proportion of the rounds, as in the case with the XOR extractor. Therefore, independently improving techniques for estimation of the Bell value may significantly enhance the practicality of a seedless extractor.

### Proofs of Lemmas 10 and 11

Lemma 10. There are functions g: {0,1}ⁿ^{ᵣ}→{0, 1}^{m} satisfying

$${\sum }_{a} {δ}_{g ( a )}^{k} = {2}^{{n}_{\text{?}} - m} , \qquad ( D1 )$$

$$\vert {\sum }_{a} {{δ}_{g ( a )}^{k} ( - 1 )}^{a \cdot r} \vert \leq \sqrt{{2}^{{n}_{r} - m + 1}} , \qquad ( D2 )$$

$$\text{?} \text{indicates text missing or illegible when filed}$$

for all k∈{0, 1}m and all non-zero r∈{0,1}ⁿ^{ᵣ}.

Proof. Consider a random function G(a)→k:{0,1}ⁿ^{ᵣ}→{0, 1}^{m} where each input a is mapped to an output k selected by a uniform distribution on {0, 1}^{m}. For any k ∈{0, 1}^{m}, the probability of that the random variable

$${\sum }_{a} {δ}_{G ( a )}^{k}$$

satisfies (D1) is equal to the probability of generating the bit string k exactly 2ⁿ^{ᵣ}^{-m} times when generating 2ⁿ^{ᵣ} bit strings of length m at random, given by

$$P ( {\sum }_{a} {δ}_{G ( a )}^{k} = {2}^{{n}_{\text{?}} - m} ) = ( \begin{matrix}{2}^{{n}_{\text{?}}} \\ {2}^{{n}_{\text{?}} - m}\end{matrix} ) {( {2}^{- m )} )}^{{2}^{{n}_{\text{?}} - m}} {( 1 - {2}^{- m} )}^{{2}^{{n}_{\text{?}}} - ( {2}^{{n}_{\text{?}} - m} )} \qquad ( D3 )$$

$$= {ϵ}_{1} > 0 , \qquad ( D4 )$$

$$\text{?} \text{indicates text missing or illegible when filed}$$

which has some non-vanishing probability. For any non-zero r∈{0,1}ⁿ^{ᵣ} and the random function G, the random variable

$${\sum }_{a} {{δ}_{G ( a )}^{k} ( - 1 )}^{a \cdot r} \qquad ( D5 )$$

can be understood as a random walk with 2ⁿ^{ᵣ}^{-m} steps, i.e. a random variable with mean 0 and variance 2ⁿ^{ᵣ}^{-m}. Using Chebyshev's inequality, the probability that the norm of the random variable (D5) is above \sqrt{2ⁿ^{ᵣ}^{-m+1}} can be bounded by

$${ϵ}_{2} = P ( \vert {\sum }_{a} {{δ}_{G ( a )}^{k} ( - 1 )}^{a \cdot r} - 0 \vert \geq \sqrt{{2}^{{n}_{\text{?}} - m + 1}} ) \leq \frac{{2}^{{n}_{\text{?}} - m}}{{( \sqrt{{2}^{{n}_{\text{?}} - m + 1}} )}^{2}} = \frac{1}{2} , \qquad ( D6 )$$

$$\text{?} \text{indicates text missing or illegible when filed}$$

which proves that for any k there exists a function G=g that satisfies the conditions (D1) and (D2), with probability at-least ϵ1(1 −ϵ2)>0.

As G is generated at random, the elements a such that

$${δ}_{G ( a )}^{k} = 1$$

for a specific output k is random and also independent from those a satisfying

$${δ}_{G ( a )}^{{k}^{′}} = 1$$

for any other output k′≠k. Therefore, the probability that the conditions (D1) and (D2) holds for all k ∈{0, 1}^{m} is given by

$${( {ϵ}_{1} ( 1 - {ϵ}_{2} ) )}^{{2}^{m}} > 0. \qquad ( D7 )$$

This implies that, with non-vanishing probability, there exists a function G=g satisfying the conditions (D1) and (D2), for all k∈{0, 1}^{m} and concludes the proof.

Lemma 11. Suppose that for every i∈I there are two Hermitian operators Cᵢ, Sᵢ acting on a Hilbert space Aᵢ such that ±Cᵢ≤Sᵢ, then

$$\pm {⊗}_{i ∈ ℐ} {C}_{i} \leq {⊗}_{i ∈ ℐ} {S}_{i} . \qquad ( D8 )$$

Proof. For any assignment ξᵢ=± for all i∈I we have ⊗₁(Sᵢ+ξᵢCᵢ)≥0. Therefore, when this product is averaged over all configurations {ξᵢ} such that Πᵢξᵢ=|1 we obtain the positive operator:

$$0 \leq {𝔼}_{\{ {ξ}_{i} \}} {⊗}_{i} ( {S}_{i} + {ξ}_{i} {C}_{i} ) = {⊗}_{i} {S}_{i} + {⊗}_{i} {C}_{i} . \qquad ( D9 )$$

Similarly, if we average the product over all configurations {ξᵢ} such that Πᵢξᵢ=−1 then

$$0 \leq {𝔼}_{\{ {ξ}_{i} \}} {⊗}_{i} ( {S}_{i} + {ξ}_{i} {C}_{i} ) = {⊗}_{i} {S}_{i} - {⊗}_{i} {C}_{i} \qquad ( D10 )$$

is positive too.

### Proof of Theorem 10

Theorem 10. The protocols described under heading Estimation Results-Part2 can generate a secret key pκε|_{t,z} satisfying the following security condition:

$${\sum }_{t ∈ {\{ 0 , 1 \}}^{\text{?}}} {\sum }_{z ∈ {\{ 0 , 1 \}}^{{\text{?}}_{}}} P ( t , z ) {‖ {ρ}_{𝒦ℰ \vert t , z} - {u}_{𝒦 \vert t , z} {ρ}_{ℰ \vert t , z} ‖}_{1} \leq ϵ . \qquad ( E1 )$$

$$\text{?} \text{indicates text missing or illegible when filed}$$

Proof. The random variables t∈{estimation, rawbit}ⁿ are independent and identically distributed according to (pₑ, pᵣ). If in round/we have tₗ=estimation then the systems A₁ and Bₗ are included in

$${𝒜}_{e} = {⊗}_{j = 1}^{{n}_{e}} {𝒜}_{j} and {ℬ}_{e} = {⊗}_{i = 1}^{{n}_{e}} {ℬ}_{j} ,$$

and used for estimation. If tₗ=rawbit then the systems [symbol] and [symbol] are included in

$${𝒜}_{r} = {⊗}_{i = 1}^{{n}_{r}} {𝒜}_{i} and$$

$${ℬ}_{r} = {⊗}_{i = 1}^{{n}_{r}} {ℬ}_{i} ,$$

and used for generating the raw key. Without loss of generality, it can be assumed that t is initially generated before any measurement, and right after, we can re-order the rounds and write the global state as [symbol] .

In each estimation round j∈{1, . . . , nₑ} the pair [symbol] ⊗ [symbol] is measured with

$${Q}_{{z}_{j}} = {\sum }_{a , b , x , y} \frac{1}{4} {A}_{j} ( a \vert x ) {B}_{j} ( b \vert y ) {δ}_{a + b + xy mod 2}^{{z}_{j}} , \qquad ( E2 )$$

having outcomes zⱼ=0, 1. This produces the estimation data z=(z₁, . . . , zₙ_{ₑ}) distributed according to

$$P ( z \vert t ) = tr [ {ρ}_{{𝒜}_{\text{?}} {ℬ}_{\text{?}} \vert t} {\prod }_{j = 1}^{{n}_{\text{?}}} {Q}_{{z}_{j}} ] . \qquad ( E3 )$$

$$\text{?} \text{indicates text missing or illegible when filed}$$

The global state conditioned on a particular value of the estimation data z is

$${ρ}_{{𝒜}_{\text{?}} {ℬ}_{\text{?}} ℰ \vert t , z} = \frac{1}{P ( z \vert t )} {tr}_{{𝒜}_{\text{?}} {ℬ}_{\text{?}}} [ {ρ}_{{𝒜}_{\text{?}} {ℬ}_{\text{?}} {𝒜}_{\text{?}} {ℬ}_{\text{?}} ℰ \vert t} ( {\prod }_{j = 1}^{{n}_{\text{?}}} {Q}_{{z}_{j}} ) ] . \qquad ( E4 )$$

$$\text{?} \text{indicates text missing or illegible when filed}$$

We start by proving the case when using the XOR seedless extractor, as described under section heading spot-checking protocol for XOR extraction above. By using Theorem 8 and the function which defines the output length of the XOR extractor in our spot checking protocol, (110), the left-hand side of (E1) can be upper bounded by

$${\sum }_{t} {\sum }_{z} P ( t , z ) {‖ {ρ}_{𝒦ℰ \vert t , z} - {u}_{𝒦 \vert t , z} {ρ}_{ℰ \vert t , z} ‖}_{1} \leq {\sum }_{t} {\sum }_{z} P ( t , z ) m ( t , z ) tr [ {ρ}_{{𝒜}_{r} {ℬ}_{r} \vert t , z} {\prod }_{i = 1}^{{n}_{r}} {S}_{i} ] , \qquad ( E5 )$$

since, in the case m(t, z)=0, the term inside the trace norm is 0 and in the case m(t, z)=1, the error can be bounded by Theorem 8. Now, using the global state conditioned on a particular value of the estimation data z E4) and the facts that

$$P ( t , z ) = P ( t ) P ( z \vert t ) = {p}_{e}^{{n}_{e}} {p}_{r}^{{n}_{r}} P ( z \vert t ) and \qquad ( E6 )$$

$$m ( t , z ) = \{ \begin{matrix}1 & if {{max}_{s ∈ ( 2 , 2 \sqrt{2} )}}_{{α}_{0} , {α}_{1} , β ∈ ℝ} {\sum }_{j = 1}^{{n}_{e}} {α}_{{z}_{j}} + ( β - 1 ) {n}_{r} - 2 {log}_{2} ( 1 / ϵ ) \geq 0 \\ 0 & otherwise\end{matrix} ,$$

is upper bounded by the exponential

$${\sqrt{2}}^{{\sum }_{j = 1}^{{n}_{e}} {α}_{{z}_{j}} + ( β - 1 ) {n}_{r} - 2 {log}_{2} ( 1 / ϵ )} ,$$

we bound Equation (E5)

$$\leq {\sum }_{t} {\sum }_{z} {p}_{e}^{{n}_{\text{?}}} {p}_{r}^{{n}_{\text{?}}} {\sqrt{2}}^{{\sum }_{j = 1}^{{n}_{e}} {α}_{{\text{?}}_{j}} + ( β - 1 ) {n}_{\text{?}}} ϵ tr [ {ρ}_{{𝒜}_{\text{?}} {ℬ}_{\text{?}} {𝒜}_{\text{?}} {ℬ}_{\text{?}} \vert t} {\prod }_{i = 1}^{{n}_{\text{?}}} {S}_{i} {\prod }_{j = 1}^{{n}_{e}} {Q}_{{z}_{j}} ] = ϵ {\sum }_{t} tr [ {ρ}_{{𝒜}_{\text{?}} {ℬ}_{\text{?}} {𝒜}_{\text{?}} {ℬ}_{\text{?}} \vert t} {\prod }_{i = 1}^{{n}_{\text{?}}} ( {p}_{r} {\sqrt{2}}^{β - 1} [ {S}_{i} ] ) {\prod }_{j = 1}^{{n}_{\text{?}}} ( {p}_{e} [ {\sqrt{2}}^{{α}_{0}} {Q}_{{0}_{j}} + {\sqrt{2}}^{{α}_{1}} {Q}_{{1}_{j}} ] ) ] = ϵ tr [ {ρ}_{{𝒜}_{\text{?}} {ℬ}_{\text{?}}} {\prod }_{l = 1}^{n} ( {p}_{r} {\sqrt{2}}^{β - 1} [ {S}_{l} ] + {p}_{e} [ {\sqrt{2}}^{{α}_{0}} {Q}_{{0}_{l}} + {\sqrt{2}}^{{α}_{1}} {Q}_{{1}_{l}} ] ) ] , \qquad ( E7 )$$

$$\text{?} \text{indicates text missing or illegible when filed}$$

where the global Hilbert spaces of Alice and Bob are denoted by [symbol] _{g}= [symbol] ᵣ⊗ [symbol] ₑ and [symbol] _{g}= [symbol] ᵣ⊗ [symbol] ₑ. Finally, using the following identities

$$S = {μ}_{s} \text{?} - {v}_{s} 4 ( {Q}_{0} - {Q}_{1} ) , \qquad ( E8 )$$

$$\text{?} = {Q}_{0} + {Q}_{1} , \qquad ( E9 )$$

each of the factors in (E7) can be written as

$${p}_{r} {\sqrt{2}}^{β - 1} [ S ] + {p}_{e} [ {\sqrt{2}}^{{α}_{0}} {Q}_{0} + {\sqrt{2}}^{{α}_{1}} {Q}_{1} ] = {p}_{r} {\sqrt{2}}^{β - 1} [ ( {μ}_{\text{?}} ) ( {Q}_{0} + {Q}_{1} ) - {ν}_{\text{?}} 4 ( {Q}_{0} - {Q}_{1} ) ] + {p}_{e} [ {\sqrt{2}}^{{α}_{0}} {Q}_{0} + {\sqrt{2}}^{{α}_{1}} {Q}_{1} ] = [ {p}_{r} {\sqrt{2}}^{β - 1} ( {μ}_{\text{?}} - {ν}_{\text{?}} 4 ) + {p}_{e} {\sqrt{2}}^{{α}_{0}} ] {Q}_{0} + [ {p}_{r} {\sqrt{2}}^{β - 1} ( {μ}_{\text{?}} + {ν}_{\text{?}} 4 ) + {p}_{e} {\sqrt{2}}^{{α}_{1}} ] {Q}_{1} = {Q}_{0} + {Q}_{1} = \text{?} , \qquad ( E10 )$$

$$\text{?} \text{indicates text missing or illegible when filed}$$

where the penultimate equality follows form imposing conditions

$${p}_{r} {\sqrt{2}}^{β - 1} ( {μ}_{s} - {ν}_{s} 4 ) + {p}_{e} {\sqrt{2}}^{{α}_{0}} = 1 , \qquad ( E11 )$$

$${p}_{r} {\sqrt{2}}^{β - 1} ( {μ}_{s} + {ν}_{s} 4 ) + {p}_{e} {\sqrt{2}}^{{α}_{1}} = 1 , \qquad ( E12 )$$

expressed in (35) and (36). Substituting (E10) back in (E7) gives us the bound (E1) and completes the proof.

Similarly, same proof is made in the balanced function seedless extraction case, as described under section heading Spot-checking protocol for balanced function extraction. In this case, we introduce an indicator function

$$I ( m ( t , z ) ) = \{ \begin{matrix}1 & if m ( t , z ) > 0 \\ 0 & otherwise\end{matrix} , \qquad ( E13 )$$

to encode the case when no key is produced, and the error is 0. By using Theorem 9 and substituting the global state conditioned on the estimation data (E4), the output length in (118) and the indicator function (E13), we can write the left-hand side of (E1) as follows

$${\sum }_{t} {\sum }_{z} P ( t , z ) {‖ {ρ}_{𝒦 , ℰ \vert t , z} - {u}_{𝒦 \vert t , z} {ρ}_{ℰ \vert t , z} ‖}_{1} \leq {\sum }_{t} {\sum }_{z} P ( t , z ) I ( m ( t , z ) ) {\sqrt{2}}^{m ( t , z ( - {n}_{\text{?}} + 1} ( tr [ {ρ}_{{𝒜}_{\text{?}} {ℬ}_{\text{?}} \vert t , z} {\prod }_{i = 1}^{{n}_{\text{?}}} ( \text{?} + {S}_{i} ) ] - 1 ) \leq {\sum }_{t} {\sum }_{z} P ( t , z ) {\sqrt{2}}^{m ( t , z ) - {n}_{\text{?}} + 1} tr [ {ρ}_{{𝒜}_{\text{?}} {ℬ}_{\text{?}} \vert t , z} {\prod }_{i = 1}^{{n}_{\text{?}}} ( \text{?} + {S}_{i} ) ] = {\sum }_{t} {\sum }_{z} {p}_{e}^{{n}_{e}} {p}_{r}^{{n}_{r}} {\sqrt{2}}^{{\sum }_{j = 1}^{\text{?}} {α}_{\text{?}} + ( β - 1 ) {n}_{\text{?}}} ϵ tr [ {ρ}_{{𝒜}_{r} {ℬ}_{r} {𝒜}_{e} {ℬ}_{e} \vert t} {\prod }_{i = 1}^{{n}_{\text{?}}} ( \text{?} + {S}_{i} ) {\prod }_{j = 1}^{{n}_{e}} {Q}_{{z}_{j}} ] = ϵ {\sum }_{t} tr [ {ρ}_{{𝒜}_{r} {ℬ}_{r} {𝒜}_{e} {ℬ}_{e} \vert t} {\prod }_{i = 1}^{{n}_{r}} ( {p}_{r} {\sqrt{2}}^{β - 1} [ \text{?} + {S}_{i} ] {\prod }_{j = 1}^{{n}_{e}} ( {p}_{e} [ {\sqrt{2}}^{{α}_{0}} {Q}_{{0}_{j}} + {\sqrt{2}}^{{α}_{1}} {Q}_{{1}_{j}} ] ) ] = ϵ tr [ {ρ}_{{𝒜}_{\text{?}} {ℬ}_{\text{?}}} {\prod }_{l = 1}^{n} ( {p}_{r} {\sqrt{2}}^{β - 1} [ \text{?} + {S}_{l} ] + {p}_{e} [ {\sqrt{2}}^{{α}_{0}} {Q}_{{0}_{l}} + {\sqrt{2}}^{{α}_{1}} {Q}_{{1}_{l}} ] ) ] , \qquad ( E14 )$$

$$\text{?} \text{indicates text missing or illegible when filed}$$

where we again denote the global Hilbert spaces of Alice and Bob by [symbol] _{g}= [symbol] ᵣ⊗ [symbol] ₑ and [symbol] _{g}= [symbol] ᵣ⊗ [symbol] ₑ. Using the identities for S and 1 from (E8) and (E9), we can write each of the factors in (D14) as

$${p}_{r} {\sqrt{2}}^{β - 1} [ \text{?} + S ] + {p}_{e} [ {\sqrt{2}}^{{α}_{0}} {Q}_{0} + {\sqrt{2}}^{{α}_{1}} {Q}_{1} ] = {p}_{r} {\sqrt{2}}^{β - 1} [ ( 1 - {μ}_{s} ) ( {Q}_{0} + {Q}_{1} ) + {ν}_{s} 4 ( {Q}_{0} - {Q}_{1} ) ] + {p}_{e} [ {\sqrt{2}}^{{α}_{0}} {Q}_{0} + {\sqrt{2}}^{{α}_{1}} {Q}_{1} ] = [ {p}_{r} {\sqrt{2}}^{β - 1} ( 1 + {μ}_{s} - {ν}_{s} 4 ) + {\sqrt{2}}^{{α}_{0}} ] {Q}_{0} + [ {p}_{r} {\sqrt{2}}^{β - 1} ( 1 + {μ}_{s} + {ν}_{s} 4 ) + {p}_{e} [ {\sqrt{2}}^{{α}_{1}} ] {Q}_{1} = {Q}_{0} + {Q}_{1} = \text{?} , \qquad ( E15 )$$

where the penultimate equality follows from the conditions expressed in (43) and (120). Substituting this back into (E14) gives us the bound (E1) and completes the proof.

The protocols spot-checking protocols may be generalized to a DI protocol for randomness amplification.

In some cases, the systems and methods described above use two-party settings (a device comprising two quantum systems) with binary inputs and outputs, may be generalized to arbitrary scenarios, e.g., by using the NPA hierarchy. In some cases, increasing the number of inputs may result in greater efficiency rates. The efficiency rate can also be improved by using both outputs a, b as the raw key, or by recycling the inputs used for estimation, since these also contain randomness.

In some embodiments, the product of the shifted CHSH operators, used above for determining BV, may be bound based on inequalities different from those presented above.

In various embodiments, the seedless extractions protocols described above based on CHSH inequality (e.g., inequalities (1), (77) above) may be implemented based on other Bell inequalities. In various embodiments, the violation of a Bell inequality (herein referred to as Bell value) may be used to determine an upper bound for an error quantifying a difference between the secret key generated by the seedless randomness extractor and a perfect random distribution (or a distance between the real and the ideal secret keys). For example, the error can be limited by an upper bound dependent on the Bell value (e.g., as shown by inequality (51) or (101) above).

### Example Hardware Implementation

In some implementations, the protocols and algorithms disclosed here may be implemented using a random number generation system 800 shown in FIG. 9. In some embodiments the random number generation system 800 may comprise a classical computing system (classical computer) 802 in communication with a quantum apparatus 808 or quantum hardware. In some cases, the quantum apparatus 808 or the quantum hardware may comprise one or more quantum systems 812. In some cases, the quantum apparatus 808 or the quantum hardware may be configured to generate random quantum events and quantum random bit strings based on the random quantum events. In some cases, the classical computing system 802 and the quantum apparatus 808 may be included or integrated in the same housing. The classical computing system 802 may include a user interface 806, at least one hardware processor 803 and at least one non-transitory memory 804. In some cases, the quantum apparatus 808 may include a controller 810 having a separate hardware processor and non-transitory memory. In some cases, the quantum apparatus 808 may be controlled by the classical computing system 802. In some cases, the classical computing system 802 may execute computer-executable instructions stored in its non-transitory memory 804 to: control the operation of the classical computer 802, the flow of data between the classical computer 802 and the quantum apparatus 808 and to generate a secret key based using a raw key received from the quantum apparatus. In some cases, the classical computer 802 may execute computer readable instructions stored in its non-transitory memory to perform the steps of any of the methods described above with respect to seedless extraction of random bit strings (e.g., nearly perfect random bit strings) from raw random bits generated by the quantum apparatus 808. In some cases, the classical computing system 802 can be included in an encryption system (e.g., a cloud-based encryption system). In some embodiments, the seedless extraction protocols and corresponding deterministic functions described above may be stored as computer readable instructions in the memory 804 and the processor may execute these computer readable instructions to provide a seedless randomness extractor.

### Example Embodiments

Example embodiments described herein have several features, no single one of which is indispensable or solely responsible for their desirable attributes. A variety of example systems and methods are provided below.

Example 1. A system for generating a random bit string, the system comprising: a non-transitory memory storing machine-readable instructions, and an electronic processor configured to execute the machine-readable instructions to: receive from a single source of randomness an input random bit string; determine a Bell value indicative of a magnitude of violation of a Bell inequality by at least a portion of bits in the input random bit string; and generate an output random bit string using the input random bit string based at least in part on the Bell value; wherein the output random bit string is generated by a deterministic output generation process.

Example 2. The system of Example 1, wherein an error quantifying a difference between the output random bit string and a perfect random distribution is limited by an upper bound dependent on the Bell value.

Example 3. The system of Example 2, wherein the upper bound decreases as the Bell value increases.

Example 4. The system of Example 1, the deterministic output generation process comprises a deterministic function.

Example 5. The system of Example 4, the electronic processor executes the machine-readable instructions to generate the random bit string by applying the deterministic function on the input random bit string.

Example 6. The system of Example 1, wherein the electronic processor is configured to execute machine-readable instructions to determine that the Bell value is larger than a threshold value and in response to determining that the Bell value is larger than the threshold value, the electronic processor generates the output random bit string.

Example 7. The system of Example 1, wherein the output random bit string is secure against an adversary having unbounded computational power.

Example 8. The system of Example 7, wherein the adversary is a quantum adversary.

Example 9. The system of Example 7, wherein the adversary is a classical adversary.

Example 10. The system of Example 1, wherein the output random bit string is closer to a perfectly random distribution than the input random bit string.

Example 11. The system of Example 1, wherein the electronic processor is further configured to execute machine-readable instructions to generate the output random bit string based on an output criterion stored in a memory of the system or provided by a user.

Example 12. The system of Example 11, wherein the output criterion comprises a length of the output random bit string.

Example 13. The system of Example 11, wherein the output criterion comprises an error quantifying a difference between the randomness of the output random bit string and a perfectly random distribution.

Example 14. The system of Example 11, wherein the output criterion comprises an efficiency associated with the generation of the output random bit string.

Example 15. The system of Example 14, wherein the efficiency comprises an efficiency rate quantifying a usage of the single source of randomness for generating the output random bit string.

Example 16. The system of Example 14, wherein the efficiency comprises an extraction efficiency quantifying a ratio between length of the output random bit string and a portion of the input random bit string used to generate the output random bit string.

Example 17. The system of Example 1, wherein the Bell value comprises an expectation value of product of a plurality of operators associated with the Bell inequality.

Example 18. The system of Example 1, wherein the Bell inequality comprises the -Horne-Shimony-Holt inequality.

Example 19. The system of Example 4, wherein the deterministic function is a linear function.

Example 20. The system of Example 4, wherein the deterministic function is an XOR function.

Example 21. The system of Example 4, wherein the deterministic function is a generator of an error-correction code.

Example 22. The system of Example 21, wherein the error-correction code is a linear error-correction code.

Example 23. The system of Example 21, wherein the error-correction code comprises the Bose-Chaudhuri-Hocquenghem (BCH) code.

Example 24. The system of Example 21, wherein the error-correction code comprises the repetition code.

Example 25. The system of Example 1, wherein the electronic processor executes the machine-readable instructions to extract the random bit string from the input random bit string without using a seed random bit string.

Example 26. A system for generating a random bit string, the system comprising: a non-transitory memory storing machine-readable instructions, and an electronic processor configured to execute the machine-readable instructions to: receive from a single source of randomness an input bit string; determine a Bell value indicative of a magnitude of violation of a Bell inequality by at least a portion of bits in the input bit string; and generate the random bit string using an output generation process comprising a deterministic function and the input bit string, based at least in part on the Bell value; wherein an error quantifying difference between the random bit string and a perfect random distribution is limited by an upper bound dependent at least partly on the Bell value.

Example 27. The system of Example 26, wherein the upper bound decreases as the Bell value increases.

Example 28. The system of Example 26, wherein the electronic processor executes the machine-readable instructions to generate the random bit string using the portion of the input bit string for which the Bell value is determined.

Example 29. The system of Example 26, wherein the electronic processor is configured to execute machine-readable instructions to determine that the Bell value is larger than a threshold value and in response to determining that the Bell value is larger than the threshold value generates the random bit string.

Example 30. The system of Example 26, wherein the electronic processor executes the machine-readable instructions to generate the random bit string using a first portion of the input bit string different from the at least a portion from which the Bell value is determined.

Example 31. The system of Example 30, wherein the electronic processor executes the machine-readable instructions to randomly select the first portion of the input bit string.

Example 32. The system of Example 30, wherein the electronic processor executes the machine-readable instructions to select test bits from the input bit string and to determine the Bell value using the test bits.

Example 33. The system of Example 32, wherein the electronic processor executes the machine-readable instructions to select test bits based at least in part on a control signal provided to the single source.

Example 34. The system of Example 32, wherein the electronic processor executes the machine-readable instructions to select test bits based at least in part on a source configuration signal received from the single source.

Example 35. The system of Example 34, wherein the source configuration signal indicates a measurement basis used by the single source of randomness to generate the input bit string.

Example 36. The system of Example 26, wherein the Bell value comprises an expectation value of product of a plurality of operators associated with the Bell inequality.

Example 37. The system of Example 36, wherein the Bell inequality comprises a CHSH inequality, and the plurality of operators comprise shifted CHSH operators.

Example 38. The system of Example 26, wherein the deterministic function is an XOR function.

Example 39. The system of Example 26, wherein the deterministic function is a linear function.

Example 40. The system of Example 26, wherein the deterministic function is a generator of an error-correction code.

Example 41. The system of Example 40, wherein the error-correction code is linear.

Example 42. The system of Example 40, wherein the error-correction code comprises the Bose-Chaudhuri-Hocquenghem (BCH) code.

Example 43. The system of Example 40, wherein the error-correction code comprises the repetition code.

Example 44. The system of Example 26, wherein the system comprises a controller configured to control a parameter of the single source of randomness.

Example 45. The system of Example 44, wherein the system controls the parameter of the single source of randomness based on a previous Bell value determined before the Bell value.

Example 46. The system of Example 44, wherein the parameter of the single source of randomness comprises a measurement base.

Example 47. The system of Example 26, wherein the single source of randomness comprises a quantum apparatus.

Example 48. The system of Example 47, the single source of randomness comprises at least two quantum systems.

Example 49. The system of Example 48, wherein the at least two quantum systems are non-signaling or approximately non-signaling.

Example 50. The system of Example 49, wherein the input bit string is derived from measurement of quantum states prepared by the at least two quantum systems.

Example 51. The system of Example 26, the electronic processor executes the machine-readable instructions to generate the random bit string by applying the deterministic function on the input bit string.

Example 52. The system of Example 26, wherein the electronic processor executes the machine-readable instructions to further generate the random bit string based on an output criterion stored in the non-transitory memory or provided by a user.

Example 53. The system of Example 52, wherein the output criterion comprises a length of the random bit string.

Example 54. The system of Example 52, wherein the output criterion comprises the error.

Example 55. The system of Example 52, wherein the output criterion comprises an efficiency associated with the generation of the random bit string.

Example 56. The system of Example 55, wherein the efficiency comprises an efficiency rate quantifying a usage of the single source of randomness for generating the random bit string.

Example 57. The system of Example 55, wherein the efficiency comprises an extraction efficiency quantifying a ratio between length of the random bit string and a portion of the input bit string used to generate the random bit string.

Example 58. The system of Example 26, wherein the electronic processor executes the machine-readable instructions to extract the random bit string from the input bit string without using a seed random bit string received from a source different from the single source of randomness.

Example 59. The system of Example 26, wherein the electronic processor executes the machine-readable instructions to select the deterministic function from a plurality of deterministic functions stored in the non-transitory memory.

Example 60. The system of Example 59, wherein electronic processor selects the deterministic function based at least in part on the Bell value.

Example 61. The system of Example 59, wherein electronic processor selects the deterministic function based at least in part on a user input.

Example 62. The system of Example 61, wherein the user input comprises one or more of: a length of the random bit string, the error, an efficiency associated with the generation of the random bit string.

Example 63. The system of Example 26, wherein min-entropy rate of the random bit string is closer to 1 compared to min-entropy rate of the input bit string.

Example 64. The system of Example 26, wherein a smooth min-entropy rate of the random bit string is equal or greater than a min-entropy rate of the input bit string.

Example 65. The system of Example 26, wherein the random bit string is closer to a perfectly random distribution than the input bit string.

Example 66. The system of Example 26, wherein the random bit string is secure against an adversary having unbounded computational power.

Example 67. The system of Example 66, wherein the adversary is a quantum adversary.

Example 68. The system of Example 66, wherein the adversary is a classical adversary.

Example 69. A method of generating a random bit string, the method comprising: By an electronic processor of a computing system: receiving from a single source of randomness an input bit string; determining a Bell value indicative of a magnitude of violation of a Bell inequality by at least a portion of bits in the input bit string; and generating the random bit string using an output generation process comprising a deterministic function and the input bit string, based at least in part on the Bell value; wherein an error quantifying difference between the random bit string and a perfect random distribution is limited by an upper bound dependent at least partly on the Bell value.

Example 70. The method of Example 69, wherein the upper bound decreases as the Bell value increases.

Example 71. The method of Example 69, wherein generating the random bit string comprises generating the random bit string using the portion of the input bit string for which the Bell value is determined.

Example 72. The method of Example 69, wherein determining the Bell value comprises determining that the Bell value is larger than a threshold value and generating the random bit string in response to determining that the Bell value is larger than the threshold value.

Example 73. The method of Example 69, wherein generating the random bit string comprises generating the random bit string using a portion of the input bit string different from the portion for which the Bell value is determined.

Example 74. The method of Example 69, wherein determining the Bell value comprises randomly selecting the portion of the input bit string for which the Bell value is determined.

Example 75. The method of Example 69, wherein determining the Bell value comprises selecting test bits from the input bit string and determining the Bell value using the test bits.

Example 76. The method of Example 75, wherein selecting the test bits comprises selecting the test bits based at least in part on a control signal provided to the single source.

Example 77. The method of Example 75, wherein selecting the test bits comprises selecting the test bits based at least in part on a source configuration signal received from the single source.

Example 78. The method of Example 77, wherein the source configuration signal indicates a measurement basis used by the single source of randomness to generate the input bit string.

Example 79. The method of Example 69, wherein the Bell value comprises an expectation value of product of a plurality of operators associated with the Bell inequality.

Example 80. The method of Example 79, wherein the Bell inequality comprises a CHSH inequality, and the plurality of operators comprise shifted CHSH operators.

Example 81. The method of Example 69, wherein the deterministic function is an XOR function.

Example 82. The method of Example 69, wherein the deterministic function is a linear function.

Example 83. The method of Example 69, wherein the deterministic function is a generator of an error-correction code.

Example 84. The method of Example 83, wherein the error-correction code is linear.

Example 85. The method of Example 83, wherein the error-correction code comprises the Bose-Chaudhuri-Hocquenghem (BCH) code.

Example 86. The method of Example 83, wherein the error-correction code comprises the repetition code.

Example 87. The method of Example 69, further comprising controlling a parameter of the single source of randomness based on a previous Bell value determined before the Bell value.

Example 88. The method of Example 87, wherein the parameter of the single source of randomness comprises a measurement base.

Example 89. The method of Example 69, wherein the single source of randomness comprises a quantum apparatus.

Example 90. The method of Example 88, the single source of randomness comprises at least two quantum systems.

Example 91. The method of Example 90, wherein the at least two quantum systems are non-signaling or approximately non-signaling.

Example 92. The method of Example 90, wherein the input bit string is derived from measurement of quantum states prepared by the at least two quantum systems.

Example 93. The method of Example 69, wherein generating the random bit string comprises generating the random bit string by applying the deterministic function on the input random bit string.

Example 94. The method of Example 69, wherein generating the random bit string further comprises generating the random bit string based on an output criterion stored in a non-transitory memory or provided by a user.

Example 95. The method of Example 94, wherein the output criterion comprises a length of the random bit string.

Example 96. The method of Example 94, wherein the output criterion comprises an error quantifying a difference between the randomness of the random bit string and a perfectly random distribution.

Example 97. The method of Example 94, wherein the output criterion comprises an efficiency associated with the generation of the random bit string.

Example 98. The method of Example 97, wherein the efficiency comprises an efficiency rate quantifying a usage of the single source of randomness for generating the random bit string.

Example 99. The method of Example 97, wherein the efficiency comprises an extraction efficiency quantifying a ratio between length of the random bit string and a portion of the input bit string used to generate the random bit string.

Example 100. The method of Example 69, wherein generating the random bit string comprises extracting the random bit string from the input bit string without using a seed random bit string.

Example 101. The method of Example 69, wherein generating the random bit string comprises selecting the deterministic function from a plurality of deterministic functions stored in a non-transitory memory.

Example 102. The method of Example 101, wherein selecting the deterministic function comprises selecting the deterministic function based at least in part on the Bell value.

Example 103. The method of Example 101, wherein selecting the deterministic function comprises selecting the deterministic function based at least in part on a user input.

Example 104. The method of Example 103, wherein the user input comprises a length of the random bit string, an error quantifying a difference between the randomness of the random bit string and a perfectly random distribution, an efficiency associated with the generation of the random bit string.

Example 105. The method of Example 69, wherein min-entropy rate of the random bit string is closer to 1 compared to min-entropy rate of the input bit string.

Example 106. The method of Example 69, wherein a smooth min-entropy rate of the random bit string is equal or greater than a min-entropy rate of the input bit string.

Example 107. The method of Example 69, wherein the random bit string is closer to a perfectly random distribution than the input bit string.

Example 108. The method of Example 69, wherein the random bit string is secure against an adversary having unbounded computational power.

Example 109. The method of Example 108, wherein the adversary is a quantum adversary.

Example 110. The method of Example 108, wherein the adversary is a classical adversary.

Example 111. A system for generating a random bit string, the system comprising: a non-transitory memory storing machine-readable instructions, and an electronic processor configured to execute the machine-readable instructions to: receive, from a single source of randomness, a bit stream; select a plurality of test bits from the bit stream; determine a Bell value indicative of a magnitude of violation of a Bell inequality by at least a portion of the bit stream the plurality of test bits; and select a plurality of raw bits from the bit stream; generate the random bit string using an output generation process comprising a deterministic function and the plurality of raw bits, based at least in part on the Bell value.

Example 112. The system of Example 111, wherein an error quantifying a difference between the random bit string and a perfect random distribution is limited by an upper bound dependent on the Bell value.

Example 113. The system of Example 112, wherein the upper bound decreases as the Bell value increases.

Example 114. The system of Example 111, wherein the random bit string is secure against an adversary having unbounded computational power.

Example 115. The system of Example 114, wherein the adversary is a quantum adversary.

Example 116. The system of Example 114, wherein the adversary is a classical adversary.

Example 117. The system of Example 111, wherein the Bell value comprises an expectation value of product of a plurality of operators associated with the Bell inequality.

Example 118. The system of Example 117, wherein the Bell inequality comprises a CHSH inequality, and the plurality of operators comprise shifted CHSH operators.

Example 119. The system of Example 111, wherein the deterministic function is an XOR function, a balanced function, or a generator of an error-correction code.

Example 120. The system of Example 119, wherein the deterministic function is an XOR function.

Example 121. The system of Example 119, wherein the deterministic function is a generator of an error-correction code.

Example 122. The system of Example 121, wherein the error-correction code is a linear error-correction code.

Example 123. The system of Example 121, wherein the error-correction code comprises the Bose-Chaudhuri-Hocquenghem (BCH) code.

Example 124. The system of Example 121, wherein the error-correction code comprises the repetition code.

Example 125. The system of Example 111, wherein the system comprises a controller configured to control a parameter of the single source of randomness.

Example 126. The system of Example 125, wherein the system controls the parameter of the single source of randomness based on a previous Bell value determined before the Bell value.

Example 127. The system of Example 125, wherein the parameter of the single source of randomness comprises a measurement basis.

Example 128. The system of Example 111, wherein the single source of randomness comprises a quantum apparatus.

Example 129. The system of Example 128, the single source of randomness comprises at least two quantum systems.

Example 130. The system of Example 129, wherein the at least two quantum systems are non-signaling or approximately non-signaling.

Example 131. The system of Example 128, wherein the plurality of test bits and the plurality of raw bits are derived from measurement of quantum states prepared by the quantum apparatus.

Example 132. The system of Example 129, wherein the plurality of test bits and the plurality of raw bits comprise coincidence measurements.

Example 133. The system of Example 111, the electronic processor generates the random bit string by applying the deterministic function on the plurality of raw bits.

Example 134. The system of Example 111, wherein the electronic processor executes the machine-readable instructions to further generate the random bit string based on an output criterion stored in the non-transitory memory or provided by a user.

Example 135. The system of Example 134, wherein the output criterion comprises a length of the random bit string.

Example 136. The system of Example 134, wherein the output criterion comprises an error quantifying a difference between the randomness of the random bit string and a perfectly random distribution.

Example 137. The system of Example 134, wherein the output criterion comprises an efficiency associated with the generation of the random bit string.

Example 138. The system of Example 137, wherein the efficiency comprises an efficiency rate quantifying a usage of the single source of randomness for generating the random bit string.

Example 139. The system of Example 137, wherein the efficiency comprises an extraction efficiency quantifying a ratio between number of bits in the random bit string and a number of bits in the plurality of raw bits.

Example 140. The system of Example 111, wherein the electronic processor executes the machine-readable instructions to extract the random bit string from the plurality of raw bits without using a seed random bit string received from a source different from the single source of randomness.

Example 141. The system of Example 111, wherein the electronic processor executes the machine-readable instructions to select the deterministic function from a plurality of deterministic functions stored in the non-transitory memory.

Example 142. The system of Example 141, wherein the electronic processor selects the deterministic function based at least in part on the Bell value.

Example 143. The system of Example 141, wherein the electronic processor selects the deterministic function based at least in part on a user input.

Example 144. The system of Example 143, wherein the user input comprises a length of the random bit string, an error quantifying a difference between the randomness of the random bit string and a perfectly random distribution, an efficiency associated with the generation of the random bit string.

Example 145. The system of Example 111, wherein min-entropy rate of the random bit string is closer to 1 compared to min-entropy rate of the plurality of raw bits.

Example 146. A method of extracting a secret key from a raw bit string, the method comprising: by an electronic processor of a computing system: receiving the raw bit string; receiving a Bell value indicative of a magnitude of violation of a Bell inequality by at least a portion of bits in the raw bit string; and generating the secret key using an output generation process comprising a deterministic function and the raw bit string, based at least in part on the Bell value; and wherein an error quantifying difference between the secret key and a perfect random distribution is limited by an upper bound dependent at least partly on the Bell value.

Example 147. The method of Example 146, wherein the secret key comprises a random bit string.

Example 148. The method of Example 146, wherein the upper bound decreases as the Bell value increases.

Example 149. The method of Example 146, wherein generating the secret key comprises generating the secret key using the portion of the raw bit string for which the Bell value is determined.

Example 150. The method of Example 146, wherein determining the Bell value comprises determining that the Bell value is larger than a threshold value and generating the secret key in response to determining that the Bell value is larger than the threshold value.

Example 151. The method of Example 146, wherein generating the secret key comprises generating the secret key using a portion of the raw bit string different from the portion for which the Bell value is determined.

Example 152. The method of Example 146, wherein determining the Bell value comprises randomly selecting the portion of the raw bit string for which the Bell value is determined.

Example 153. The method of Example 146, wherein determining the Bell value comprises selecting test bits from the raw bit string and determining the Bell value using the test bits.

Example 154. The method of Example 146, wherein the Bell value comprises an expectation value of product of a plurality of operators associated with the Bell inequality.

Example 155. The method of Example 154, wherein the Bell inequality comprises a CHSH inequality, and the plurality of operators comprise shifted CHSH operators.

Example 156. The method of Example 146, wherein the deterministic function is an XOR function.

Example 157. The method of Example 146, wherein the deterministic function is a linear function.

Example 158. The method of Example 146, wherein the deterministic function is a generator of an error-correction code.

Example 159. The method of Example 158, wherein the error-correction code is linear.

Example 160. The method of Example 158, wherein the error-correction code comprises the Bose-Chaudhuri-Hocquenghem (BCH) code.

Example 161. The method of Example 158, wherein the error-correction code comprises the repetition code.

Example 162. The method of Example 146, wherein generating the secret key comprises generating the secret key by applying the deterministic function on the raw bit string.

Example 163. The method of Example 146, wherein generating the secret key further comprises generating the secret key based on an output criterion stored in a non-transitory memory or provided by a user.

Example 164. The method of Example 163, wherein the output criterion comprises a length of the secret key.

Example 165. The method of Example 163, wherein the output criterion comprises an error quantifying a difference between a randomness of the secret key and a perfectly random distribution.

Example 166. The method of Example 163, wherein the output criterion comprises an efficiency associated with the generation of the secret key.

Example 167. The method of Example 163, wherein the efficiency comprises an extraction efficiency quantifying a ratio between length of the secret key and a portion of the raw bit string used to generate the secret key.

Example 168. The method of Example 146, wherein extracting the secret key comprises extracting the secret key from the raw bit string without using a seed random number.

Example 169. The method of Example 146, wherein generating the secret key comprises selecting the deterministic function from a plurality of deterministic functions stored in a non-transitory memory.

Example 170. The method of Example 146, wherein selecting the deterministic function comprises selecting the deterministic function based at least in part on the Bell value.

Example 171. The method of Example 146, wherein selecting the deterministic function comprises selecting the deterministic function based at least in part on a user input.

Example 172. The method of Example 171, wherein the user input comprises a length of the secret key, an error quantifying a difference between randomness of the secret key and a perfectly random distribution, an efficiency associated with the generation of the secret key.

Example 173. The method of Example 146, wherein min-entropy rate of the secret key is closer to 1 compared to min-entropy rate of the raw bit string.

Example 174. The method of Example 146, wherein a smooth min-entropy rate of the secret key is equal or greater than a min-entropy rate of the raw bit string.

Example 175. The method of Example 146, wherein the secret key is closer to a perfectly random distribution than the raw bit string.

Example 176. The method of Example 146, wherein the secret key is secure against an adversary having unbounded computational power.

Example 177. The method of Example 176, wherein the adversary is a quantum adversary.

Example 178. The method of Example 176, wherein the adversary is a classical adversary.

### Terminology

Modifications to embodiments of the disclosure described in the foregoing are possible without departing from the scope of the disclosure as defined by the accompanying claims. Expressions such as “including”, “comprising”, “incorporating”, “have”, “is” used to describe and claim the disclosure are intended to be construed in a non-exclusive manner, namely allowing for items, components or elements not explicitly described also to be present.

Reference to the singular is also to be construed to relate to the plural; as an example, “at least one of” indicates “one of” in an example, and “a plurality of” in another example; moreover, “one or more” is to be construed in a likewise manner.

Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

The phrases “in an embodiment”, “according to an embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The term “computer” or “computing-based device” is used herein to refer to any device with processing capability such that it executes instructions. Those skilled in the art will realize that such processing capabilities are incorporated into many different devices and therefore the terms “computer” and “computing-based device” each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible, non-transitory storage medium, e.g., in the form of a computer program comprising computer program code adapted to perform the operations of one or more of the methods described herein when the program is run on a computer and where the computer program may be embodied on a non-transitory computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above.

Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. No single feature or group of features is necessary or indispensable to every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, blocks, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A; B; C; A and B; A and C; B and C; and A, B, and C. Conjunctive language such as the phrase “at least one of X, Y, and Z,” unless specifically stated otherwise, is otherwise understood with the context as used in general to convey that an item, term, etc. may be at least one of X, Y, or Z. Thus, such conjunctive language is not generally intended to imply that certain embodiments require at least one of X, at least one of Y, and at least one of Z to each be present.

The operations of the methods described herein may be carried out in any suitable order, or simultaneously where appropriate. Additionally, individual blocks may be deleted from, combined with other blocks, or rearranged in any of the methods without departing from the scope of the subject matter described herein. Aspects of any of the examples described above may be combined with aspects of any of the other examples described to form further examples without losing the effect sought.

It will be understood that the above description is given by way of example only and that various modifications may be made by those skilled in the art. The above specification, examples, and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A system for generating an output random bit string, the system comprising:
a non-transitory memory storing machine-readable instructions, and
an electronic processor configured to execute the machine-readable instructions to:
receive from a single source of randomness an input random bit string;
determine a Bell value indicative of a magnitude of violation of a Bell inequality by at least a portion of bits in the input random bit string; and
generate the output random bit string using the input random bit string based at least in part on the Bell value;
wherein the output random bit string is generated by a deterministic output generation process.

2. The system of claim 1, wherein an error quantifying a difference between the output random bit string and a perfect random distribution is limited by an upper bound dependent on the Bell value.

3. The system of claim 1, wherein the Bell value is used as an input to a deterministic extraction process to generate the output random bit string.

4. The system of claim 3, the deterministic output generation process comprises a deterministic function.

5. The system of claim 4, wherein the electronic processor executes the machine-readable instructions to generate the output random bit string by applying the deterministic function on the input random bit string.

6. The system of claim 5, wherein the electronic processor is configured to select the deterministic function from a plurality of deterministic functions based at least in part on the Bell value.

7. The system of claim 4, wherein the deterministic function is selected from a group consisting of a linear function, an XOR function, or a generator of an error-correction code.

8. The system of claim 1, wherein the electronic processor is configured to determine at least one output random bit string parameter based at least in part on the Bell value, the output random bit string parameter comprising a length of the output random bit string, an extraction efficiency, or an error bound, and to generate the output random bit string in accordance with the determined output random bit string parameter.

9. The system of any one of claim 1, wherein the electronic processor is configured to execute machine-readable instructions to determine that the Bell value is larger than a threshold value and in response to determining that the Bell value is larger than the threshold value, the electronic processor generates the output random bit string.

10. The system of any one of claim 1, wherein the Bell value comprises an expectation value of product of a plurality of operators associated with the Bell inequality.

11. The system of any one of claim 1, wherein the Bell inequality comprises the Clauser-Horne-Shimony-Holt inequality.

12. The system of any one of claim 1, wherein the electronic processor executes the machine-readable instructions to extract the output random bit string from the input random bit string without using a seed random bit string.

13. The system of claim 1, wherein the output random bit string is secure against an adversary having unbounded computational power.

14. The system of claim 13, wherein the adversary is a quantum adversary.

15. The system of claim 13, wherein the adversary is a classical adversary.

16. The system of claim 1, wherein the output random bit string is closer to a perfectly random distribution than the input random bit string.

17. The system of claim 1, wherein the electronic processor is further configured to execute machine-readable instructions to generate the output random bit string based on an output criterion stored in a memory of the system or provided by a user.

18. The system of claim 17, wherein the output criterion comprises a length of the output random bit string.

19. The system of claim 17, wherein the output criterion comprises an error quantifying a difference between the randomness of the output random bit string and a perfectly random distribution.

20. The system of claim 17, wherein the output criterion comprises an extraction efficiency quantifying a ratio between length of the output random bit string and a portion of the input random bit string used to generate the output random bit string.
